(19) United States
(12) Patent Application Publication
(10) Pub. No.: US 2026/0350897 A1
(43) Pub. Date: Nov. 5, 2026

(54) ACTION CONTROL SYSTEM

(71) Applicant: SOFTBANK GROUP CORP., Tokyo (JP)

(72) Inventor: Masayoshi SON, Tokyo (JP)

(73) Assignee: SOFTBANK GROUP CORP., Tokyo (JP)

(21) Appl. No.: 19/463,158

(22) Filed: Jan. 29, 2026

Related U.S. Application Data
(63) Continuation of application No. PCT/JP2024/027453, filed on Jul. 31, 2024.

(30) Foreign Application Priority Data
Aug. 2, 2023 (JP) 2023-126182
Aug. 2, 2023 (JP) 2023-126184
Aug. 2, 2023 (JP) 2023-126185
Aug. 2, 2023 (JP) 2023-126496
Aug. 2, 2023 (JP) 2023-126497
Aug. 3, 2023 (JP) 2023-127393
Aug. 3, 2023 (JP) 2023-127394
Aug. 4, 2023 (JP) 2023-128187
Aug. 9, 2023 (JP) 2023-130214
Aug. 10, 2023 (JP) 2023-131232
Aug. 16, 2023 (JP) 2023-132613
Aug. 31, 2023 (JP) 2023-141855

(51) Int. Cl. G06T 13/40; G02B 27/00; G02B 27/01; G06T 15/20; G06V 10/82; G06V 40/16; G10L 25/63

(52) U.S. Cl. CPC G06T 13/40; G02B 27/0093; G02B 27/0101; G02B 27/017; G06T 15/205; G06V 10/82; G06V 40/171; G06V 40/174; G10L 25/63; G02B 2027/0138; G06T 2215/16

(57) ABSTRACT

An action control system includes an action determination unit that uses at least one of a user state, a state of electronic equipment, an emotion of a user, or an emotion of an avatar, together with an action determination model at a predetermined timing to determine any of multiple types of avatar actions including not acting as an action of the avatar, and the action determination unit calculates a similarity between an action of the avatar determined using the action determination model and an action of the avatar determined using an existing reaction rule and prioritizes the action of the avatar determined using the existing reaction rule in a case in which the similarity is less than a threshold value.

### CROSS-REFERENCE TO RELATED APPLICATIONS

This application is a continuation of International Application No. PCT/JP2024/027453, filed on Jul. 31, 2024, which claims priority from Japanese Patent Application No. 2023-126182 filed on Aug. 2, 2023, Japanese Patent Application No. 2023-126184 filed on Aug. 2, 2023, Japanese Patent Application No. 2023-126185 filed on Aug. 2, 2023, Japanese Patent Application No. 2023-126496 filed on Aug. 2, 2023, Japanese Patent Application No. 2023-126497 filed on Aug. 2, 2023, Japanese Patent Application No. 2023-127393 filed on Aug. 3, 2023, Japanese Patent Application No. 2023-127394 filed on Aug. 3, 2023, Japanese Patent Application No. 2023-128187 filed on Aug. 4, 2023, Japanese Patent Application No. 2023-130214 filed on Aug. 9, 2023, Japanese Patent Application No. 2023-131232 filed on Aug. 10, 2023, Japanese Patent Application No. 2023-132613 filed on Aug. 16, 2023, Japanese Patent Application No. 2023-141855 filed on Aug. 31, 2023. The entire disclosure of each of the above applications is incorporated herein by reference.

### TECHNICAL FIELD

The present disclosure relates to an action control system.

### BACKGROUND ART

Japanese Patent No. 6053847 discloses a technique for determining an appropriate action of a robot for a state of a user. In the related art of Japanese Patent No. 6053847, in a case in which a robot has recognized a user's reaction in a case in which the robot executed a specific action and an action of the robot in response to the recognized user's reaction has not been determined, the action of the robot is updated by receiving information regarding the action suitable for the user's recognized state from a server.

### SUMMARY OF INVENTION

### Technical Problem

However, in the related art, there is room for improvement in causing the robot to execute an appropriate action for the user's action.

### Solution to Problem

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and an action control unit that displays the avatar in an image display area of the electronic equipment, in which the action determination unit calculates a similarity between an action of the avatar determined using the action determination model and an action of the avatar determined using an existing reaction rule and prioritizes the action of the avatar determined using the existing reaction rule in a case in which the similarity is less than a threshold value.

According to one aspect of the disclosure, the action determination model is a data generation model capable of generating data according to input data, the action determination unit inputs data indicating at least one of the user state, the state of the electronic equipment, the emotion of the user, or the emotion of the avatar, together with data for asking about an avatar action to the data generation model, and determines an action of the avatar based on an output of the data generation model, and the action determination unit selects the action of the avatar determined using the data generation model in a case in which the similarity is a threshold value or higher.

According to one aspect of the disclosure, the electronic equipment is a headset-type terminal.

According to one aspect of the disclosure, the electronic equipment is an eyeglass-type terminal.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and an action control unit that displays the avatar in an image display area of the electronic equipment, in which the avatar actions include autonomously changing a display mode representing a surface temperature of the avatar, and in a case in which a state of the user is autonomously detected and the emotion determination unit determines at least one of an emotion of the user or an emotion of the avatar based on the detected state of the user, the action determination unit determines a surface temperature of the avatar according to at least one of the determined emotion of the user or emotion of the avatar.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and an action control unit that displays the avatar in an image display area of the electronic equipment, in which the action determination unit selects one of an action content of the avatar generated based on a data generation model capable of generating data according to input data as the action determination model according to an intensity of the emotion of the user or the emotion of the avatar determined by the emotion determination unit, and an action content determined based on a reaction rule for determining an action of the avatar according to the action of the user and the emotion of the user or the emotion of the avatar as the action determination model.

According to one aspect of the disclosure, the action determination unit selects an action content determined based on the reaction rule in a case in which an emotion value representing the intensity of the emotion is a threshold value or greater, and selects an action content generated based on the data generation model in a case in which the emotion value is less than the threshold value.

According to one aspect of the disclosure, in a case in which the action content is selected by using the data generation model, the action determination unit inputs data indicating at least one of the user state, the state of the electronic equipment, the emotion of the user, or the emotion of the avatar, together with data for asking about an avatar action to the data generation model, and determines an action of the avatar based on an output of the data generation model.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and an action control unit that displays the avatar in an image display area of the electronic equipment, in which the action determination unit calculates the degree of match between the action of the user, the emotion of the user and/or the emotion of the avatar and a condition of a reaction rule for determining an action of the avatar according to the action of the user, the emotion of the user and/or the emotion of the avatar, selects an action content determined using the reaction rule in a case in which the degree of match is the threshold value or higher, and selects an action content determined using a data generation model capable of generating data according to input data as the action determination model in a case in which the degree of match is less than the threshold value.

According to one aspect of the disclosure, in a case in which the action content is selected by using the data generation model, the action determination unit inputs data indicating at least one of the user state, the state of the electronic equipment, the emotion of the user, or the emotion of the avatar, together with data for asking about an avatar action to the data generation model, and determines an action of the avatar based on an output of the data generation model.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and an action control unit that displays the avatar in an image display area of the electronic equipment, in which the avatar actions include determining, in advance, a gesture of the avatar, and the action determination unit determines an activation condition for activating the gesture and stores the activation condition in action plan data in a case in which it is determined to set a gesture of the avatar in advance as an action of the avatar, and determines to cause the avatar to execute the gesture in a case in which the activation condition of the action plan data is satisfied.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and an action control unit that displays the avatar in an image display area of the electronic equipment, in which the avatar actions include determining, in advance, an utterance content of the avatar, and the action determination unit determines an activation condition for uttering the utterance content and stores the activation condition in action plan data in a case in which it is determined to set an utterance content of the avatar in advance as an action of the avatar, and determines to cause the avatar to utter the utterance content in a case in which the activation condition of the action plan data is satisfied.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with a user image obtained by capturing the user, and an action determination model at a predetermined timing to determine any of multiple types of avatar actions including not acting as an action of the avatar; and an action control unit that displays the avatar in an image display area of the electronic equipment, in which the avatar actions include an action for a motion of the user represented in the user image, and the action determination unit determines to ask about the motion of the user in a case in which it is determined to give utterance about the motion of the user as an action of the avatar.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with a user surrounding image obtained by capturing an environment surrounding the user and an action determination model at a predetermined timing to determine any of multiple types of avatar actions including not acting as an action of the avatar; a memory control unit that stores event data including an emotion value determined by the emotion determination unit and data including the action of the user in history data; and an action control unit that displays the avatar in an image display area of the electronic equipment, in which the avatar actions include an action related to a place where the user represented by the user surrounding image is, and the action determination unit determines to utter a topic about the place where the user is in a case in which it is determined to utter the topic about the place where the user is as an action of the avatar.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that determines an action of the avatar corresponding to the user state, the emotion of the user, or the emotion of the avatar based on a sentence generation model which has an interaction function of allowing the user to interact with the avatar; and an action control unit that displays the avatar in an image display area of the electronic equipment, in which the action determination unit sets backchanneling associated with an emotion value of the avatar in a conversation up to at least one previous utterance for the time from the start of sentence generation by the sentence generation model to the utterance by the avatar, and causes the avatar to perform an action based on the backchanneling.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with an action determination model at predetermined timing to determine any of multiple types of avatar actions including not acting as an action of the avatar; a memory control unit that stores event data including an emotion value determined by the emotion determination unit and data including the action of the user in history data; and an action control unit that displays the avatar in an image display area of the electronic equipment, in which the avatar actions include giving a happiness point to the user, and the action determination unit determines to inform the user of the fact that the happiness point has been added and a point balance in a case in which giving a happiness point to the user is determined as an action of the avatar.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and an action control unit that displays the avatar in an image display area of the electronic equipment, in which the avatar actions include receiving a question from the user, and the action determination unit determines an action of the avatar so as to take an action for earning time to generate an answer content for the question during the time to the generation of the answer content in a case in which it is determined to receive a question from the user as an action of the avatar.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and an action control unit that displays the avatar in an image display area of the electronic equipment, in which the avatar actions include receiving a question from the user, and in a case in which it is determined to receive a question from the user, as an action of the avatar, and in a case in which a question is received from the user and no answer content to the question can be generated within a predetermined period of time, the action determination unit determines an action of the avatar to utter a word of explanation.

According to one aspect of the disclosure, an action control system is provided. The action control system includes a state recognition unit that recognizes a user state including an action of a user and a state of electronic equipment; an emotion determination unit that determines an emotion of the user or an emotion of an avatar representing an agent for interacting with the user; an action determination unit that determines an action of the avatar based on at least one of the user state, the state of the electronic equipment, the emotion of the user, or the emotion of the avatar; an action control unit that displays the avatar in an image display area of the electronic equipment, in which the action determination unit determines an action of the avatar preset for soothing the emotion of the user in a case in which a threshold value preset for the emotion of the user is exceeded.

### BRIEF DESCRIPTION OF DRAWINGS

FIG. 1 schematically illustrates an example of a system 5 according to a first embodiment.

FIG. 2 schematically illustrates a functional configuration of a robot 100 according to the first embodiment.

FIG. 3 schematically shows an example of an operation flow of a collecting process by the robot 100 according to the first embodiment.

FIG. 4A schematically shows an example of an operation flow of a response process by the robot 100 according to the first embodiment.

FIG. 4B schematically shows an example of an operation flow of an autonomous process by the robot 100 according to the first embodiment.

FIG. 5 illustrates an emotion map 400 on which multiple emotions are mapped.

FIG. 6 illustrates an emotion map 900 on which multiple emotions are mapped.

FIG. 7(A) is an external view of a stuffed toy 100N according to a second embodiment, and FIG. 7(B) is an internal structural view of the stuffed toy 100N.

FIG. 8 is a rear front view of the stuffed toy 100N according to the second embodiment.

FIG. 9 schematically illustrates a functional configuration of the stuffed toy 100N according to the second embodiment.

FIG. 10 schematically illustrates a functional configuration of an agent system 500 according to a third embodiment.

FIG. 11 illustrates an example of an operation of the agent system.

FIG. 12 illustrates an example of an operation of the agent system.

FIG. 13 schematically illustrates a functional configuration of an agent system 700 according to a fourth embodiment.

FIG. 14 illustrates an example of a usage mode of the agent system using smart glasses.

FIG. 15 schematically illustrates a functional configuration of an agent system 800 according to a fifth embodiment.

FIG. 16 illustrates an example of a headset-type terminal.

FIG. 17 schematically illustrates an example of a hardware configuration of a computer 1200.

### DESCRIPTION OF EMBODIMENTS

Hereinafter, the disclosure will be described through embodiments of the invention, and the following embodiments do not limit the invention according to the claims. In addition, not all combinations of features described in the embodiments are essential to the solution of the invention.

### First Embodiment

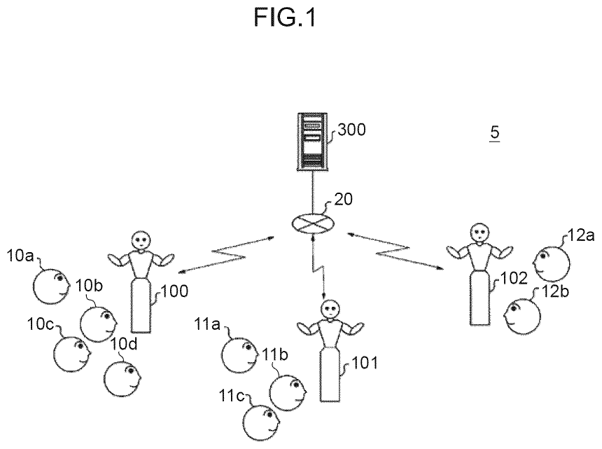

FIG. 1 schematically illustrates an example of a system 5 according to the present embodiment. The system 5 includes a robot 100, a robot 101, a robot 102, and a server 300. A user 10a, a user 10b, a user 10c, and a user 10d are users of the robot 100. A user 11a, a user 11b, and a user 11c are users of the robot 101. A user 12a and a user 12b are users of the robot 102. Note that, in the description of the present embodiment, the user 10a, the user 10b, the user 10c, and the user 10d may be collectively referred to as “user 10”. Furthermore, the user 11a, the user 11b, and the user 11c may be collectively referred to as “user 11”. Furthermore, the user 12a and the user 12b may be collectively referred to as “user 12”. The robot 101 and the robot 102 have substantially the same functions as those of the robot 100. Thus, the system 5 will be described focusing on the functions of the robot 100.

The robot 100 has conversations with the user 10 and provides videos to the user 10. At this time, the robot 100 performs a conversation with the user 10 and provides a video to the user 10, and the like in cooperation with the server 300 and the like that can communicate via a communication network 20. For example, the robot 100 not only learns an appropriate conversation by itself, but also performs learning so that a conversation with the user 10 can be advanced more appropriately in cooperation with the server 300. Further, the robot 100 causes the server 300 to record captured video data and the like of the user 10, requests the server 300 for the video data and the like if necessary, and provides the video data and the like to the user 10.

Furthermore, the robot 100 has an emotion value indicating the type of its own emotion. For example, the robot 100 has emotion values indicating the intensity of each emotion such as “joy”, “anger”, “sorrow”, “pleasure”, “comfort”, “discomfort”, “relief”, “anxiety”, “sadness”, “excitement”, “worry”, “reassurance”, “fulfillment”, “emptiness”, and “neutral”. For example, in a case in which the robot 100 has a conversation with the user 10 with a high emotion value of excitement, the robot emits voice at a fast speed. As described above, the robot 100 can express its own emotion by action.

Furthermore, the robot 100 may be configured to determine an action of the robot 100 corresponding to an emotion of the user 10 by matching a sentence generation model using artificial intelligence (AI) with an emotion engine. Specifically, the robot 100 may be configured to recognize an action of the user 10, determine the emotion of the user 10 for the action of the user, and determine an action of the robot 100 corresponding to the determined emotion.

More specifically, in a case in which the robot 100 has recognized an action of the user 10, the robot 100 automatically generates the action content to be taken by the robot 100 in response to the action of the user 10 by using a preset sentence generation model. The sentence generation model may be interpreted as an algorithm and an arithmetic operation for an automatic interaction process based on characters. Since the sentence generation model is known as disclosed in, for example, Japanese Patent Application Laid-Open (JP-A) No. 2018-081444 and ChatGPT (retrieved from the Internet <URL: https://openai.com/blog/chatgpt>), detailed description thereof will be omitted. Such a sentence generation model is configured by a large-scale language model (LLM).

As described above, in the present embodiment, it is possible to reflect the emotions of the user 10 and the robot 100 and various linguistic information in actions of the robot 100 by combining the large-scale language model and the emotion engine. That is, according to the present embodiment, synergistic effects can be obtained by combining the sentence generation model and the emotion engine.

Further, the robot 100 has the function of recognizing actions of the user 10. The robot 100 recognizes actions of the user 10 by analyzing face images of the user 10 acquired by the camera function and voices of the user 10 acquired by the microphone function. The robot 100 determines an action to be performed by the robot 100 based on a recognized action of the user 10 or the like.

As an example of an action determination model, the robot 100 stores a rule for defining an action to be performed by the robot 100 based on an emotion of the user 10, an emotion of the robot 100, and an action of the user 10, and performs various actions according to the rule.

Specifically, the robot 100 includes, as an example of the action determination model, reaction rules for determining an action of the robot 100 based on an emotion of the user 10, an emotion of the robot 100, and an action of the user 10. According to the reaction rules, for example, in a case in which an action of the user 10 is “laughing”, the action of the robot 100 is set to “laughing”. In addition, according to the reaction rules, in a case in which an action of the user 10 is “getting angry”, the action of the robot 100 is set to “apologizing”. In addition, according to the reaction rules, in a case in which an action of the user 10 is “asking a question”, the action of the robot 100 is set to “answering”. According to the reaction rules, in a case in which an action of the user 10 is “expressing sadness”, the action of the robot 100 is set to “showing encouragement”.

In a case in which the robot 100 recognizes the action of the user 10 as “getting angry” based on the reaction rules, the robot chooses the action of “apologizing” defined in the reaction rules as an action to be performed by the robot 100. For example, in the case of choosing the action of “apologizing”, the robot 100 performs the action of “apologizing” and outputs a voice expressing a word of “apology”.

Furthermore, in a case in which a condition that the emotion of the robot 100 is “neutral” (that is, “joy”=0, “anger”=0, “sadness”=0, and “pleasure”=0) and the state of the user 10 is “being alone is lonely” is satisfied, it is defined that the content of emotion change in the emotion of the robot 100 to “worried” and the action of “showing encouragement” can be performed.

In a case in which the robot 100 recognizes that the current emotion of the robot 100 is “neutral” and the user 10 is alone and feels sad based on the reaction rules, the emotion value of “sorrow” of the robot 100 is increased. Furthermore, the robot 100 selects an action of “showing encouragement” defined in the reaction rule as an action to be performed on the user 10. For example, in a case in which the action of “showing encouragement” is selected, the robot 100 converts the phrase “What's wrong?” expressing concern into a voice expressing concern, and outputs the voice.

Furthermore, the robot 100 transmits, to the server 300, user reaction information indicating that a positive reaction has been obtained from the user 10 due to this action. The user reaction information includes, for example, a user action of “getting angry”, an action of the robot 100 of “apologizing”, a positive reaction of the user 10, and an attribute of the user 10.

The server 300 stores the user reaction information received from the robot 100. Note that the server 300 receives the user reaction information not only from the robot 100 but also from each of the robot 101 and the robot 102 and stores the user reaction information. Then, the server 300 analyzes the user reaction information from the robot 100, the robot 101, and the robot 102, and updates the reaction rules.

The robot 100 inquires the server 300 about the updated reaction rules to receive the updated reaction rules from the server 300. The robot 100 incorporates the updated reaction rules into the reaction rules stored in the robot 100. As a result, the robot 100 can incorporate the reaction rules acquired by the robot 101, the robot 102, and the like into its own reaction rules.

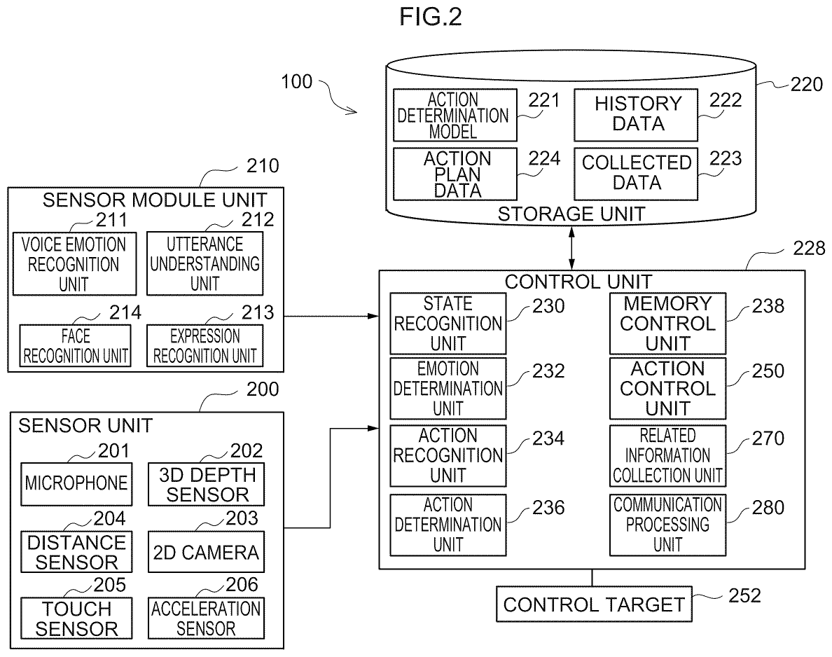

FIG. 2 schematically illustrates a functional configuration of the robot 100. The robot 100 includes a sensor unit 200, a sensor module unit 210, a storage unit 220, a control unit 228, and a control target 252. The control unit 228 includes a state recognition unit 230, an emotion determination unit 232, an action recognition unit 234, an action determination unit 236, a memory control unit 238, an action control unit 250, a related information collection unit 270, and a communication processing unit 280.

The control target 252 includes a display device, a speaker, an LED at the eye part, motors that drive arms, hands, feet, and the like. Postures and gestures of the robot 100 are controlled by controlling motors for arms, hands, and feet. Some of the emotions of the robot 100 can be expressed by controlling these motors. Furthermore, expressions of the robot 100 can be represented by controlling light emission states of the LEDs at the eye part of the robot 100. Note that the postures, gestures, and expressions of the robot 100 are examples of attitudes of the robot 100.

The sensor unit 200 includes a microphone 201, a 3D depth sensor 202, a 2D camera 203, a distance sensor 204, a touch sensor 205, and an acceleration sensor 206. The microphone 201 continuously detects sound and outputs voice data. Note that the microphone 201 may be provided on the head of the robot 100 and may have a function of performing binaural recording. The 3D depth sensor 202 detects outlines of an object by continuously emitting an infrared pattern and analyzing the infrared pattern from an infrared image continuously captured by an infrared camera. The 2D camera 203 is an example of an image sensor. The 2D camera 203 captures an image with visible light and generates image information from visible light. The distance sensor 204 detects a distance to an object by emitting, for example, a laser, an ultrasonic wave, or the like. Note that the sensor unit 200 may further include a clock, a gyro sensor, a sensor for motor feedback, and the like.

Note that, among the components of the robot 100 illustrated in FIG. 2, the components other than the control target 252 and the sensor unit 200 are examples of the components included in the action control system of the robot 100. The control target 252 is a target to be controlled by the action control system of the robot 100.

The storage unit 220 includes an action determination model 221, history data 222, collected data 223, and action plan data 224. The history data 222 includes past emotion values of the user 10, past emotion values of the robot 100, and an action history, and specifically includes multiple pieces of event data including the emotion values of the user 10, the emotion values of the robot 100, and actions of the user 10. The data including the actions of the user 10 includes camera images representing the actions of the user 10. The emotion values and the action history are recorded for each user 10 by being associated with identification information of the user 10, for example. At least a part of the storage unit 220 is implemented by a storage medium such as a memory. A person DB that stores face images of the user 10, attribute information of the user 10, and the like may be included. Note that, among the components of the robot 100 illustrated in FIG. 2, the functions of the components other than the control target 252, the sensor unit 200, and the storage unit 220 can be realized by a CPU operating according to programs. For example, the functions of these components can be implemented as operations of the CPU by basic software (OS) and programs operating on the OS.

The sensor module unit 210 includes a voice emotion recognition unit 211, an utterance understanding unit 212, an expression recognition unit 213, and a face recognition unit 214. Information detected by the sensor unit 200 is input to the sensor module unit 210. The sensor module unit 210 analyzes information detected by the sensor unit 200 and outputs the analysis result to the state recognition unit 230.

The voice emotion recognition unit 211 of the sensor module unit 210 analyzes a voice of the user 10 detected by the microphone 201 to recognize the emotion of the user 10. For example, the voice emotion recognition unit 211 extracts a feature such as a frequency component of the utterance and recognizes the emotion of the user 10 based on the extracted feature. The utterance understanding unit 212 analyzes the voice of the user 10 detected by the microphone 201 and outputs character information indicating the utterance content of the user 10.

The expression recognition unit 213 recognizes the facial expression of the user 10 and the emotion of the user 10 from an image of the user 10 captured by the 2D camera 203. For example, the expression recognition unit 213 recognizes the facial expression and emotion of the user 10 based on the shapes, positional relationships, and the like of the user's eyes and mouth.

The face recognition unit 214 recognizes the face of the user 10. The face recognition unit 214 recognizes the user 10 by matching a face image stored in the person DB (not illustrated) with a face image of the user 10 captured by the 2D camera 203.

The state recognition unit 230 recognizes the state of the user 10 based on the information analyzed by the sensor module unit 210. For example, analysis results of the sensor module unit 210 are used to perform processing mainly related to perception. For example, perceptual information such as “Dad is alone” and “There is a 90% probability that dad is not smiling” is generated. A process of understanding the meaning of the generated perceptual information is performed. For example, semantic information such as “Dad alone seems to be lonely” is generated.

The state recognition unit 230 recognizes the state of the robot 100 based on the information detected by the sensor unit 200. For example, the state recognition unit 230 recognizes the remaining battery level of the robot 100, the brightness of the surrounding environment of the robot 100, and the like as the states of the robot 100.

The emotion determination unit 232 determines an emotion value indicating the emotion of the user 10 based on the information analyzed by the sensor module unit 210 and the state of the user 10 recognized by the state recognition unit 230. For example, the information analyzed by the sensor module unit 210 and the recognized state of the user 10 are input to a pre-trained neural network to acquire an emotion value indicating the emotion of the user 10.

Here, the emotion value indicating the emotion of the user 10 is a value indicating whether the emotion of the user is positive or negative. For example, if the emotion of the user is a bright emotion accompanied with pleasure or comfort, such as “joy”, “pleasure”, “comfort”, “relief”, “excitement”, “reassurance”, and “fulfillment”, a positive value is indicated, and the value becomes greater as the emotion is brighter. If the user's emotion is an emotion that makes the user feel unpleasant, such as “anger”, “sorrow”, “discomfort”, “anxiety”, “sadness”, “worry”, and “emptiness”, a negative value is indicated, and the absolute value of the negative value increases as the user feels unpleasant. In a case in which the user's emotion is not any of the above (“neutral”), the value 0 is indicated.

Furthermore, the emotion determination unit 232 determines an emotion value indicating the emotion of the robot 100 based on the information analyzed by the sensor module unit 210, the information detected by the sensor unit 200, and the state of the user 10 recognized by the state recognition unit 230.

The emotion value of the robot 100 includes the emotion value for each of multiple emotion classifications, and is, for example, a value (0 to 5) indicating the intensity of each of “joy”, “anger”, “sorrow”, and “pleasure”.

Specifically, the emotion determination unit 232 determines an emotion value indicating the emotion of the robot 100 according to a rule for updating the emotion value of the robot 100 defined in association with the information analyzed by the sensor module unit 210 and the state of the user 10 recognized by the state recognition unit 230.

For example, in a case in which the state recognition unit 230 recognizes that the user 10 seems to be lonely, the emotion determination unit 232 increases the emotion value for “sorrow” of the robot 100. Furthermore, in a case in which the state recognition unit 230 recognizes that the user 10 has a smiling face, the emotion value for “joy” of the robot 100 is increased.

Note that the emotion determination unit 232 may determine the emotion value indicating the emotion of the robot 100 in further consideration of the state of the robot 100. For example, in a case in which the remaining battery level of the robot 100 is low, a case in which the surrounding environment of the robot 100 is completely dark, or the like, the emotion value for “sorrow” of the robot 100 may be increased. Furthermore, the emotion value for “anger” may be increased in a case in which the user 10 continuously talks even though the remaining battery level is low.

The action recognition unit 234 recognizes an action of the user 10 based on the information analyzed by the sensor module unit 210 and the state of the user 10 recognized by the state recognition unit 230. For example, the information analyzed by the sensor module unit 210 and the recognized state of the user 10 are input to a pre-trained neural network, the probability of each of multiple predetermined action classifications (for example, “smile”, “getting angry”, “asking”, and “getting sad”) is acquired, and the action classification having the highest probability is recognized as the action of the user 10.

As described above, in the present embodiment, the robot 100 acquires the utterance content of the user 10 after identifying the user 10, but in acquiring and using the utterance content, the action control system of the robot 100 according to the present embodiment considers protection of personal information and privacy of the user 10 in addition to acquiring necessary consent from the user 10 according to laws and regulations.

Next, processing of the action determination unit 236 when the robot 100 performs a response process in which the robot responds to the action of the user 10 will be described.

The action determination unit 236 determines an action corresponding to the action of the user 10 recognized by the action recognition unit 234 based on the current emotion value of the user 10 determined by the emotion determination unit 232, the history data 222 of the past emotion values determined by the emotion determination unit 232 before the current emotion value of the user 10 is determined, and the emotion value of the robot 100. In the present embodiment, a case in which the action determination unit 236 uses one most recent emotion value included in the history data 222 as a past emotion value of the user 10 will be described, but the disclosed technology is not limited to this aspect. For example, the action determination unit 236 may use multiple most recent emotion values as the past emotion values of the user 10, or may use emotion values that are earlier by a unit period such as one day earlier. Furthermore, the action determination unit 236 may determine an action corresponding to the action of the user 10 in further consideration of the history of the past emotion values of the robot 100 in addition to the current emotion value of the robot 100. The action determined by the action determination unit 236 includes a gesture performed by the robot 100 or utterance content of the robot 100.

The action determination unit 236 according to the present embodiment determines an action of the robot 100 based on a combination of the past emotion value and the current emotion value of the user 10, the emotion value of the robot 100, the action of the user 10, and the action determination model 221 as an action corresponding to the action of the user 10. For example, in a case in which the past emotion value of the user 10 is a positive value and the current emotion value is a negative value, the action determination unit 236 determines an action for positively changing the emotion value of the user 10 as an action corresponding to the action of the user 10.

In the reaction rules as the action determination model 221, an action of the robot 100 according to the combination of the past emotion value and the current emotion value of the user 10, the emotion value of the robot 100, and the action of the user 10 is determined. For example, in a case in which the past emotion value of the user 10 is a positive value, the current emotion value is a negative value, and the action of the user 10 is “getting sad”, a combination of the gesture and utterance content of making an inquiry to encourage the user 10 with a gesture is determined as the action of the robot 100.

For example, in the reaction rules as the action determination model 221, the action of the robot 100 is determined for all combinations of the pattern of the emotion value of the robot 100 (1296 patterns that is the fourth power of six values of “joy”, “anger”, “sorrow”, and “pleasure” values from “0” to “5”), the pattern of the combinations of the past emotion value and the current emotion value of the user 10, and the action pattern of the user 10. That is, for each pattern of the emotion value of the robot 100, the action of the robot 100 according to the action pattern of the user 10 is determined for each of multiple combinations such that the combinations of the past emotion value and the current emotion value of the user 10 are a negative value and a negative value, a negative value and a positive value, a positive value and a negative value, a positive value and a positive value, a negative value and a neutral value, and a neutral value and a neutral value. Note that the action determination unit 236 may transition to the operation mode of determining the action of the robot 100 using the history data 222, for example, in a case in which the user 10 makes an utterance intending to continue a conversation over a past topic, such as saying “I want to talk about that topic we discussed before”.

Note that, in the reaction rules as the action determination model 221, at least one of a gesture or the utterance content may be determined as the action of the robot 100 for each of the patterns (1296 patterns) of the emotion values of the robot 100 at the maximum. Alternatively, in the reaction rules as the action determination model 221, at least one of the gesture or the utterance content may be determined as the action of the robot 100 for each of the groups of the patterns of the emotion values of the robot 100.

The intensity of each gesture included in the action of the robot 100 defined in the reaction rules as the action determination model 221 is determined in advance. In each utterance content included in the action of the robot 100 defined in the reaction rules as the action determination model 221, the intensity of the utterance content is determined in advance.

The memory control unit 238 determines whether or not to store data including the action of the user 10 in the history data 222 based on the intensity of the action determined in advance for the action determined by the action determination unit 236 and the emotion value of the robot 100 determined by the emotion determination unit 232.

Specifically, in a case in which the total value of the sum of the emotion values for each of the multiple emotion classifications of the robot 100 and the intensity that is the sum of the intensity predetermined for the gesture included in the action determined by the action determination unit 236 and the intensity predetermined for the utterance content included in the action determined by the action determination unit 236 is a threshold value or greater, it is determined to store data including the action of the user 10 in the history data 222.

In a case in which it is determined to store the data including the action of the user 10 in the history data 222, the action determined by the memory control unit 238 stores, in the history data 222, the action determined by the action determination unit 236, the information (for example, all peripheral information such as data of a sound, an image, and a smell of the place) analyzed by the sensor module unit 210 from the current time point to a certain period before, and the state of the user 10 (for example, the expression, emotion, and the like of the user 10) recognized by the state recognition unit 230.

The action control unit 250 controls the control target 252 based on the action determined by the action determination unit 236. For example, in a case in which the action determination unit 236 determines an action including utterance, the action control unit 250 causes a speaker included in the control target 252 to output a voice. At this time, the action control unit 250 may determine the speed of the voice uttered based on the emotion value of the robot 100. For example, the action control unit 250 determines a higher utterance speed as the emotion value of the robot 100 is larger. In this manner, the action control unit 250 determines the execution form of the action determined by the action determination unit 236 based on the emotion value determined by the emotion determination unit 232.

The action control unit 250 may recognize a change in emotion of the user 10 with respect to execution of the action determined by the action determination unit 236. For example, the change in the emotion of the user 10 may be recognized based on the voice or expression of the user 10. In addition, the change in emotion of the user 10 may be recognized based on the detection of an impact by the touch sensor 205 included in the sensor unit 200. In a case in which an impact is detected by the touch sensor 205 included in the sensor unit 200, it may be recognized that the emotion of the user 10 has been worsened, or in a case in which it is determined that the reaction of the user 10 is smiling or joyful from the detection result of the touch sensor 205 included in the sensor unit 200, it may be recognized that the emotion of the user 10 has got better. Information indicating the reaction of the user 10 is output to the communication processing unit 280.

Furthermore, after the action control unit 250 executes the action determined by the action determination unit 236 in the execution mode determined according to the emotion of the robot 100, the emotion determination unit 232 further changes the emotion value of the robot 100 based on the user's reaction to the execution of the action. Specifically, the emotion determination unit 232 increases the emotion value for “joy” of the robot 100 in a case in which the user's reaction to the action determined by the action determination unit 236, performed on the user in the execution mode determined by the action control unit 250, is not unfavorable. Specifically, the emotion determination unit 232 increases the emotion value for “sorrow” of the robot 100 in a case in which the user's reaction to the action determined by the action determination unit 236, performed on the user in the execution mode determined by the action control unit 250, is unfavorable.

Furthermore, the action control unit 250 expresses the emotion of the robot 100 based on the determined emotion value of the robot 100. For example, in a case in which the emotion value for “joy” of the robot 100 is increased, the action control unit 250 controls the control target 252 to cause the robot 100 to perform a gesture of joy. Furthermore, in a case in which the emotion value for “sorrow” of the robot 100 is increased, the action control unit 250 controls the control target 252 such that the posture of the robot 100 is a dejected posture.

The communication processing unit 280 is responsible for communication with the server 300. As described above, the communication processing unit 280 transmits user reaction information to the server 300. Furthermore, the communication processing unit 280 receives an updated reaction rule from the server 300. Upon receiving the updated reaction rule from the server 300, the communication processing unit 280 updates the reaction rule as the action determination model 221.

The server 300 performs communication between the robot 100, the robot 101, and the robot 102 and the server 300, receives the user reaction information transmitted from the robot 100, and updates the reaction rule based on the reaction rule including the action for which a positive reaction has been obtained.

The related information collection unit 270 collects information related to preference information from external data (web sites such as news sites and moving image sites) based on the preference information acquired for the user 10 at a predetermined timing.

Specifically, the related information collection unit 270 acquires preference information indicating a matter of interest of the user 10 from utterance content of the user 10 or a setting operation by the user 10 in advance. The related information collection unit 270 collects news related to the preference information from external data at regular intervals using, for example, ChatGPT Plugins (retrieved from the Internet <URL: https://openai.com/blog/chatgpt-plugins>). For example, in a case in which it is acquired as preference information that the user 10 is a fan of a specific professional baseball team, the related information collection unit 270 collects news related to a game result of the specific professional baseball team from external data at a predetermined time every day, for example, using ChatGPT Plugins.

The emotion determination unit 232 determines the emotion of the robot 100 based on the information related to the preference information collected by the related information collection unit 270.

Specifically, the emotion determination unit 232 inputs a text indicating the information related to the preference information collected by the related information collection unit 270 to a pre-trained neural network for determining an emotion, acquires the emotion value indicating each emotion, and determines the emotion of the robot 100. For example, in a case in which the collected news related to the game result of the specific professional baseball team indicates that the specific professional baseball team has won, the emotion value for “joy” of the robot 100 is determined to be high.

In a case in which the emotion value of the robot 100 is a threshold value or greater, the memory control unit 238 stores information related to the preference information collected by the related information collection unit 270 in the collected data 223.

Next, processing of the action determination unit 236 when the robot 100 performs an autonomous process for autonomous acting will be described.

The action determination unit 236 uses at least one of the state of the user 10, the emotion of the user 10, the emotion of the robot 100, or the state of the robot 100, together with the action determination model 221 at a predetermined timing, to determine, as the action of the robot 100, any of multiple types of robot actions, including not acting. Here, a case in which a sentence generation model having an interaction function is used as the action determination model 221 will be described as an example.

Specifically, the action determination unit 236 inputs a text representing at least one of the state of the user 10, the emotion of the user 10, the emotion of the robot 100, or the state of the robot 100, together with a text for asking about the robot action to the sentence generation model to determine the action of the robot 100 based on the output of the sentence generation model.

For example, multiple types of the robot actions include the following (1) to (10).
(1) The robot does nothing.
(2) The robot dreams.
(3) The robot speaks to the user.
(4) The robot creates a picture diary.
(5) The robot proposes an activity.
(6) The robot suggests a person whom the user should meet.
(7) The robot introduces news that the user is interested in.
(8) The robot edits pictures and videos.
(9) The robot studies with the user.
(10) The robot evokes a memory.

The action determination unit 236 inputs, to the sentence generation model, a text indicating the state of the user 10 and the state of the robot 100 recognized by the state recognition unit 230, the current emotion value of the user 10 determined by the emotion determination unit 232, and the current emotion value of the robot 100, and a text for asking about any of multiple types of robot actions including not acting, every time of a certain period of time elapses, and determines the action of the robot 100 based on the output of the sentence generation model. Here, in a case in which there is no user 10 around the robot 100, the text to be input to the sentence generation model needs not include the state of the user 10 and the current emotion value of the user 10, or may include the fact that there is no user 10.

As an example, the sentence generation model receives inputs of texts such as “The robot is in a very pleasant state. The user is normally in a pleasant state. The user is sleeping. Which one of the following (1) to (10) is better as an action of the robot?
(1) The robot does nothing.
(2) The robot dreams.
(3) The robot speaks to the user.

. . . ” as an example. Based on the output “It can be said that either (1) The robot does nothing or (2) The robot dreams is the most appropriate action” of the sentence generation model, “(1) The robot does nothing” or “(2) The robot dreams” is determined as an action of the robot 100.

The sentence generation model receives inputs of texts such as “The robot is slightly lonely. The user is absent. It is dark around the robot. Which one of the following (1) to (10) is better as an action of the robot? (1) The robot does nothing.
(2) The robot dreams.
(3) The robot speaks to the user.

. . . ” as another example. Based on the output “It can be said that either (2) The robot dreams or (4) The robot creates a picture diary is the most appropriate action” of the sentence generation model, “(2) The robot dreams” or “(4) The robot creates a picture diary” is determined as an action of the robot 100.

In a case in which the action determination unit 236 determines that “(2) The robot dreams”, that is, creation of an original event, as a robot action, the action determination unit creates the original event obtained by combining multiple pieces of event data in the history data 222 using the sentence generation model. At this time, the memory control unit 238 stores the created original event in the history data 222.

In a case in which it is determined that “(3) The robot speaks to the user”, that is, the robot 100 utters, as a robot action, the action determination unit 236 determines the utterance content of the robot corresponding to the user state and the user's emotion or the robot's emotion using the sentence generation model. At this time, the action control unit 250 causes a speaker included in the control target 252 to output a voice representing the determined utterance content of the robot. Note that, in a case in which the user 10 is absent around the robot 100, the action control unit 250 stores the determined utterance content of the robot in the action plan data 224 without outputting a voice representing the determined utterance content of the robot.

In a case in which it is determined that “(4) The robot creates a picture diary”, that is, the robot 100 creates an event image, as a robot action, the action determination unit 236 generates an image representing the event data for the event data selected from the history data 222 using an image generation model, generates an explanatory sentence representing the event data using the sentence generation model, and outputs a combination of the image representing the event data and the explanatory sentence representing the event data as an event image. Note that, in a case in which the user 10 is absent around the robot 100, the action control unit 250 stores the event image in the action plan data 224 without outputting the event image.

In a case in which it is determined that “(5) The robot proposes an activity”, that is, an action of the user 10 is proposed, as a robot action, the action determination unit 236 determines the proposed action of the user using the sentence generation model based on the event data stored in the history data 222. At this time, the action control unit 250 causes a speaker included in the control target 252 to output a voice proposing the action of the user. Note that, in a case in which the user 10 is absent around the robot 100, the action control unit 250 stores the proposal on the action of the user in the action plan data 224 without outputting a voice proposing the action of the user.

In a case in which it is determined, as a robot action, that “(6) The robot proposes a person whom the user should meet”, that is, the robot proposes a partner who should be engaged with the user 10, the action determination unit 236 determines the proposed partner who should be engaged with the user using the sentence generation model based on the event data stored in the history data 222. At this time, the action control unit 250 causes a speaker included in the control target 252 to output a voice proposing the partner who should be engaged with the user. Note that, in a case in which the user 10 is absent around the robot 100, the action control unit 250 stores the proposal on the partner who should be engaged with the user in the action plan data 224 without outputting a voice indicating the proposal on the partner who should be engaged with the user.

In a case in which it is determined that “(7) The robot introduces news that the user is interested in” as a robot action, the action determination unit 236 determines the utterance content of the robot corresponding to the information stored in the collected data 223 using the sentence generation model. At this time, the action control unit 250 causes a speaker included in the control target 252 to output a voice representing the determined utterance content of the robot. Note that, in a case in which the user 10 is absent around the robot 100, the action control unit 250 stores the determined utterance content of the robot in the action plan data 224 without outputting a voice representing the determined utterance content of the robot.

In a case in which it is determined that “(8) The robot edits pictures and videos”, that is, the robot edits images, the action determination unit 236 selects event data from the history data 222 based on the emotion value, edits the image data of the selected event data, and outputs the edited image data. Note that, in a case in which the user 10 is absent around the robot 100, the action control unit 250 stores the edited image data in the action plan data 224 without outputting the edited image data.

In a case in which it is determined that “(9) The robot studies with the user”, that is, the robot 100 utters about studying as a robot action, the action determination unit 236 determines the utterance content of the robot for encouraging studying, presenting study problems, or giving advice related to studying corresponding to the user state and the user's emotion or the robot's emotion using the sentence generation model. At this time, the action control unit 250 causes a speaker included in the control target 252 to output a voice representing the determined utterance content of the robot. Note that, in a case in which the user 10 is absent around the robot 100, the action control unit 250 stores the determined utterance content of the robot in the action plan data 224 without outputting a voice representing the determined utterance content of the robot.

In a case in which it is determined, as a robot action, that “(10) The robot evokes memory”, that is, the robot remembers the event data, the action determination unit 236 selects the event data from the history data 222. At this time, the emotion determination unit 232 determines the emotion of the robot 100 based on the selected event data. Furthermore, the action determination unit 236 creates an emotion change event representing the utterance content or action of the robot 100 for changing the emotion value of the user using the sentence generation model based on the selected event data. At this time, the memory control unit 238 stores the emotion change event in the action plan data 224.

For example, in a case in which it is stored in the history data 222 that the video the user was watching was related to a panda as event data, and the event data is selected, a message like “What would you say about the topic related to a panda when you meet the user next time? Take three examples” is input to the sentence generation model. In a case in which the output of the sentence generation model is “(1) Let's go to the zoo; (2) draw a picture of a panda; and (3) let's go buy a stuffed panda doll”, the robot 100 inputs “What makes the user most happiness among (1), (2), and (3)?” to the sentence generation model. In a case in which the output of the sentence generation model is “(1) Let's go to the zoo”, the robot 100 creates uttering “(1) Let's go to the zoo” when the robot 100 meets the user next time, as an emotion change event, and stores the emotion change event in the action plan data 224.

Furthermore, for example, event data having a large emotion value of the robot 100 is selected as an impressive memory of the robot 100. This makes it possible to create an emotion change event based on the event data selected as an impressive memory.

Based on the state of the user 10 recognized by the state recognition unit 230, in a case in which an action of the user 10 with respect to the robot 100 is detected in a state where there is no action of the user 10 with respect to the robot 100, the action determination unit 236 reads data stored in the action plan data 224 and determines an action of the robot 100.

For example, in a case in which the user 10 is absent around the robot 100 but the user 10 is detected, the action determination unit 236 reads data stored in the action plan data 224 and determines an action of the robot 100. In addition, when it is detected that the user 10 has woken up in a case in which the user 10 was sleeping, the action determination unit 236 reads data stored in the action plan data 224 and determines an action of the robot 100.

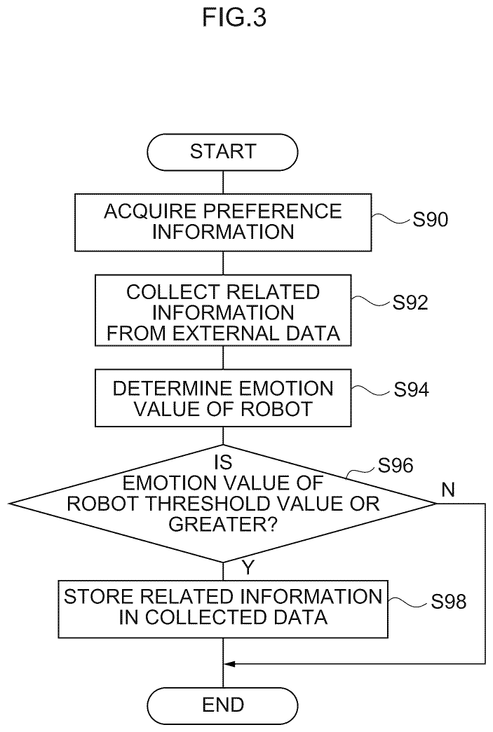

FIG. 3 schematically shows an example of an operation flow related to a collection process of collecting information related to preference information of the user 10. The operation flow shown in FIG. 3 is repeatedly executed in every certain period. It is assumed that preference information indicating a matter of interest to the user 10 has been acquired from the utterance content of the user 10 or the setting operation by the user 10. Note that “S” in the operation flow represents a step to be executed.

First, in step S90, the related information collection unit 270 acquires preference information indicating a matter of interest to the user 10.

In step S92, the related information collection unit 270 collects information related to the preference information from external data.

In step S94, the emotion determination unit 232 determines the emotion value of the robot 100 based on the information related to the preference information collected by the related information collection unit 270.

In step S96, the memory control unit 238 determines whether or not the emotion value of the robot 100 determined in step S94 is a threshold value or greater. If the emotion value of the robot 100 is less than the threshold value, the information related to the collected preference information is not stored in the collected data 223, and the process ends. On the other hand, if the emotion value of the robot 100 is the threshold value or greater, the process proceeds to step S98.

In step S98, the memory control unit 238 stores the information related to the collected preference information in the collected data 223, and ends the process.

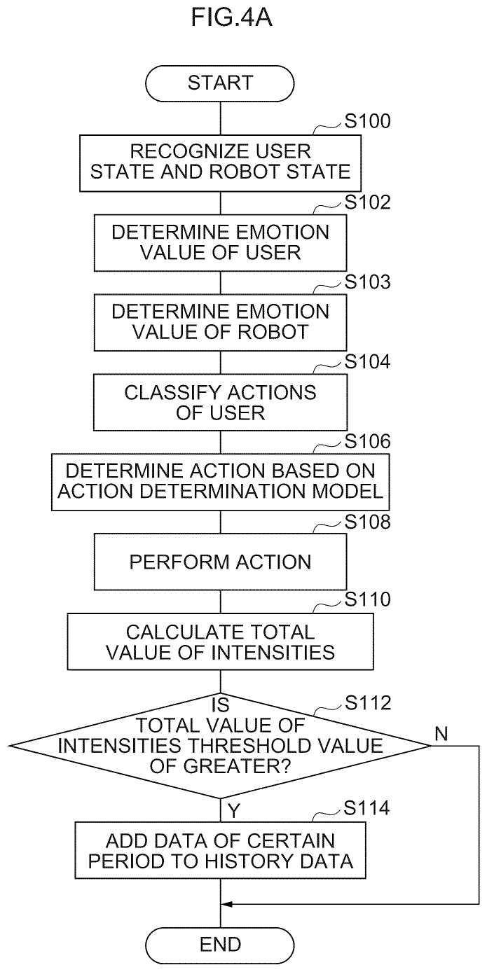

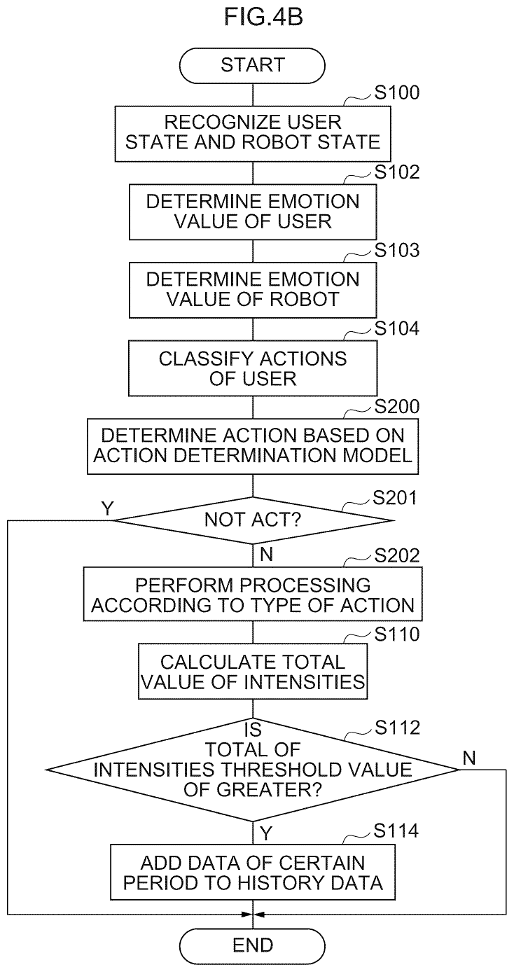

FIG. 4A schematically shows an example of the operation flow related to an operation of determining an action in the robot 100 when the robot 100 performs a response process in which the robot 100 responds to an action of the user 10. The operation flow shown in FIG. 4A is repeatedly executed. At this time, it is assumed that information analyzed by the sensor module unit 210 is input.

First, in step S100, the state recognition unit 230 recognizes the state of the user 10 and the state of the robot 100 based on the information analyzed by the sensor module unit 210.

In step S102, the emotion determination unit 232 determines an emotion value indicating the emotion of the user 10 based on the information analyzed by the sensor module unit 210 and the state of the user 10 recognized by the state recognition unit 230.

In step S103, the emotion determination unit 232 determines an emotion value indicating the emotion of the robot 100 based on the information analyzed by the sensor module unit 210 and the state of the user 10 recognized by the state recognition unit 230. The emotion determination unit 232 adds the determined emotion value of the user 10 and emotion value of the robot 100 to the history data 222.

In step S104, the action recognition unit 234 recognizes the action classification of the user 10 based on the information analyzed by the sensor module unit 210 and the state of the user 10 recognized by the state recognition unit 230.

In step S106, the action determination unit 236 determines the action of the robot 100 based on a combination of the current emotion value of the user 10 determined in step S102 and the past emotion value included in the history data 222, the emotion value of the robot 100, the action of the user 10 recognized in step S104, and the action determination model 221.

In step S108, the action control unit 250 controls the control target 252 based on the action determined by the action determination unit 236.

In step S110, the memory control unit 238 calculates the total value of the intensities based on the intensity of the action predetermined for the action determined by the action determination unit 236 and the emotion value of the robot 100 determined by the emotion determination unit 232.

In step S112, the memory control unit 238 determines whether or not the total value of the intensities is a threshold value or greater. If the total value of the intensities is less than the threshold value, the event data including the action of the user 10 is not stored in the history data 222, and the process ends. On the other hand, if the total value of the intensities is the threshold value or greater, the process proceeds to step S114.

In step S114, event data including the action determined by the action determination unit 236, the information analyzed by the sensor module unit 210 from the current time point to a certain period before, and the state of the user 10 recognized by the state recognition unit 230 are stored in the history data 222.

FIG. 4B schematically shows an example of the operation flow related to an operation of determining an action in the robot 100 when the robot 100 performs an autonomous process for autonomous acting. The operation flow shown in FIG. 4B is repeatedly and automatically executed, for example, each time a certain time elapses. At this time, it is assumed that information analyzed by the sensor module unit 210 has been input. Note that processing similar to that in FIG. 4A is represented by the same step number.

First, in step S100, the state recognition unit 230 recognizes the state of the user 10 and the state of the robot 100 based on the information analyzed by the sensor module unit 210.

In step S102, the emotion determination unit 232 determines an emotion value indicating the emotion of the user 10 based on the information analyzed by the sensor module unit 210 and the state of the user 10 recognized by the state recognition unit 230.

In step S103, the emotion determination unit 232 determines an emotion value indicating the emotion of the robot 100 based on the information analyzed by the sensor module unit 210 and the state of the user 10 recognized by the state recognition unit 230. The emotion determination unit 232 adds the determined emotion value of the user 10 and emotion value of the robot 100 to the history data 222.

In step S104, the action recognition unit 234 recognizes the action classification of the user 10 based on the information analyzed by the sensor module unit 210 and the state of the user 10 recognized by the state recognition unit 230.

In step S200, the action determination unit 236 determines, as an action of the robot 100, any of multiple types of robot actions including not acting based on the state of the user 10 recognized in step S100, the emotion of the user 10 determined in step S102, the emotion of the robot 100, the state of the robot 100 recognized in step S100, the action of the user 10 recognized in step S104, and the action determination model 221.

In step S201, the action determination unit 236 determines whether not acting is determined in step S200. If not acting is determined as an action of the robot 100, the process ends. On the other hand, if not acting is not determined as an action of the robot 100, the process proceeds to step S202.

In step S202, the action determination unit 236 performs processing according to the type of the robot action determined in step S200 described above. At this time, the action control unit 250, the emotion determination unit 232, or the memory control unit 238 executes processing in accordance with the type of the robot action.

In step S110, the memory control unit 238 calculates the total value of the intensities based on the intensity of the action predetermined for the action determined by the action determination unit 236 and the emotion value of the robot 100 determined by the emotion determination unit 232.

In step S112, the memory control unit 238 determines whether or not the total value of the intensities is a threshold value or greater. If the total value of the intensities is less than the threshold value, the data including the action of the user 10 is not stored in the history data 222, and the process ends. On the other hand, if the total value of the intensities is the threshold value or greater, the process proceeds to step S114.

In step S114, the memory control unit 238 stores, in the history data 222, the action determined by the action determination unit 236, the information analyzed by the sensor module unit 210 from the current time point to a certain period before, and the state of the user 10 recognized by the state recognition unit 230.

As described above, according to the robot 100, the emotion value indicating the emotion of the robot 100 is determined based on the user state, and whether or not to store data including the action of the user 10 in the history data 222 is determined based on the emotion value of the robot 100. As a result, the capacity of the history data 222 that stores data including the action of the user 10 can be reduced Then, for example, in a case in which the robot 100 determines that the user state is the same as the user state was 10 years ago after 10 years, the robot 100 reads the history data 222 of 10 years ago, and thus, can present the state of the user 10 of 10 years ago (for example, the expression, emotion, and the like of the user 10), and further, any peripheral information such as data of the voice, image, scent, and the like of the place to the user 10.

Furthermore, according to the robot 100, it is possible to cause the robot 100 to execute an appropriate action in response to the action of the user 10. In the related art, actions of a user are classified, and an action including an expression or an appearance of a robot is determined. With regard to this, the robot 100 determines the current emotion value of the user 10 and executes an action on the user 10 based on the past emotion value and the current emotion value. Therefore, for example, in a case in which the user 10 was fine yesterday but is depressed today, the robot 100 can utter the following: “You were fine yesterday. What's wrong with you today?”. Furthermore, the robot 100 can also perform an utterance with gestures. Furthermore, for example, in a case in which the user 10 was depressed yesterday but is fine today, the robot 100 can utter the following: “You were depressed yesterday, but you look fine today!”. Furthermore, for example, in a case in which the user 10 was fine yesterday and is better today than yesterday, the robot 100 can utter the following: “You look better today than yesterday. What made you better than yesterday?”. Furthermore, for example, the robot 100 can utter the following to the user 10 whose emotion value is 0 or higher and whose state in which the fluctuation range of the emotion value is within a certain range: “Recently, you seem to be stable, which is good”.

Furthermore, for example, in a case in which the robot 100 asks “Did you finish the assignment you mentioned yesterday?” to the user 10 and receives the answer “I did it” from the user 10, the robot can make an affirmative utterance such as “Good!” and make an affirmative gesture such as applause or thumbs-up. Furthermore, for example, when the user 10 utters “The presentation we discussed the day before yesterday was successful”, the robot 100 can make an affirmative utterance such as “Good job!” and also make the above affirmative gesture. As described above, the robot 100 performs an action based on the history of the state of the user 10, and thereby it is expected that the user 10 can feel a sense of closeness to the robot 100.

Furthermore, for example, in a case in which the emotion value of “pleasure” of the emotion of the user 10 is a threshold value or higher when the user 10 is watching a video related to pandas, the appearance scene of a panda in the video may be stored in the history data 222 as event data.

Using the data accumulated in the history data 222 and the collected data 223, the robot 100 can always learn in what conversation the user has a maximum emotion value expressing that the user is happiness.

Furthermore, in a state in which the robot 100 is not in conversation with the user 10, it is possible to autonomously start an action based on the emotion of the robot 100.

Furthermore, in the autonomous process, the robot 100 repeats automatically generating a question, inputting the question to the sentence generation model, and acquiring an output of the sentence generation model as the answer to the question, so that it is possible to create an emotion change event for boosting a good emotion and store the emotion change event in the action plan data 224. In this manner, the robot 100 can execute self-learning.

Furthermore, when the robot 100 automatically generates a question without receiving a trigger from the outside, the question can be automatically generated based on event data remaining in an impression specified from a history of past emotion values of the robot.

Furthermore, the related information collection unit 270 can execute self-learning by repeating a search execution stage in which keyword search is automatically performed in accordance with the preference information of the user to acquire a search result.

Here, in the search execution stage, the keyword search may be automatically executed based on the event data remaining the impression specified from the history of the past emotion values of the robot while no trigger is received from the outside.

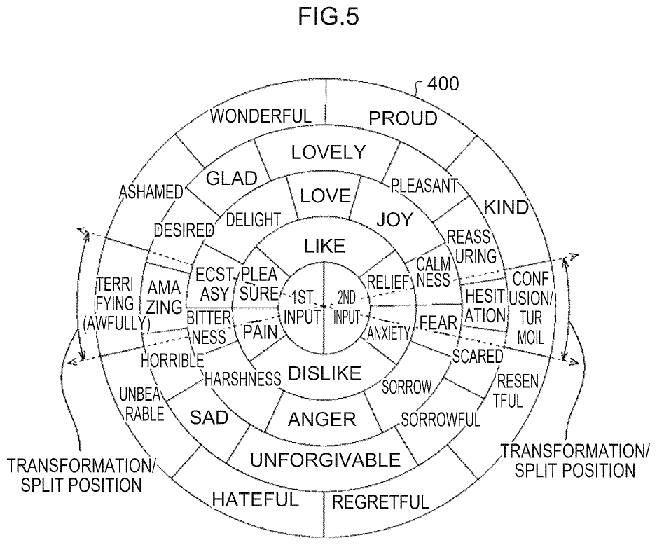

Note that the emotion determination unit 232 may determine the user's emotion according to specific mapping. Specifically, the emotion determination unit 232 may determine the user's emotion based on an emotion map (see FIG. 5) that is a specific type of mapping.

FIG. 5 is a diagram illustrating an emotion map 400 on which multiple emotions are mapped. In the emotion map 400, emotions are arranged concentrically radially from the center. The closer to the center of the concentric circles, the more the emotion in the primitive state is arranged. Emotions indicating states and actions generated from the state of mind are arranged outside the concentric circles. An emotion is a concept including feelings and mental states. On the left side of the concentric circles, emotions generated from reactions generally occurring in the brain are arranged. On the right side of the concentric circles, emotions induced by situation judgment are generally arranged. In the upward and downward directions of the concentric circles, emotions generated from reactions generally occurring in the brain and induced by situation judgment are arranged. Furthermore, the emotion “pleasure” is arranged on the upper side of the concentric circles, and the emotion “discomfort” is arranged on the lower side. As described above, in the emotion map 400, multiple emotions are mapped based on a structure in which emotions are generated, and emotions that are likely to occur at the same time are mapped close to each other. (1) For example, in a case in which the emotion engine, which is the emotion determination unit 232 of the robot 100, detects emotions at about 100 msec, the determination of the reaction operation (for example, backchanneling) of the robot 100 may be set at a timing at which the frequency is at least similar to the detection frequency (100 msec) of the emotion engine even if the frequency is low, or may be set at a timing quicker than the detection frequency. The detection frequency of the emotion engine may be interpreted as a sampling rate.

The emotion is detected at about 100 msec, and the reaction operation (for example, backchanneling) is performed immediately in conjunction with the detection, whereby an unnatural backchanneling is eliminated, and natural and context-aware interactions can be realized. The robot 100 performs a reaction operation (backchanneling or the like) according to the directionality and the degree (intensity) of the mandala of the emotion map 400. Note that the detection frequency (sampling rate) of the emotion engine is not limited to 100 ms, and may be changed according to the situation (such as when playing sports), the age of the user, or the like.
(2) In comparison with the emotion map 400, the directionality of the emotion and the intensity of the degree thereof may be preset, and the movement of the backchanneling and the intensity of the backchanneling may be set. For example, in a case in which the robot 100 feels a sense of stability, relief, or the like, the robot 100 continues listening to speech while nodding. In a case in which the robot 100 feels anxious, lost, or suspicious, the robot 100 may tilt its head or stop swinging.

These emotions are distributed in the 3 o'clock direction of the emotion map 400, and usually come and go between relief and anxiety. In the right half of the emotion map 400, situation recognition is superior to internal sensation, and thus gives a calm impression.
(3) In a case in which the robot 100 is experiencing pleasure after receiving compliments, a filler “Oh” may come in front of the line, and in a case in which the robot is experiencing pain after receiving harsh words, a filler “Ohh!” may come in front of the line. Furthermore, a physical reaction such as a gesture of the robot 100 crouching while saying “Ohh!” may be included. These emotions are distributed to around 9 o'clock direction in the emotion map 400.
(4) In the left half of the emotion map 400, internal sensation (reaction) is prioritized over situation recognition. Therefore, the impression of an unintentional reaction can be given.

In a case in which the robot 100 has a favorable feeling in situation recognition while having an internal feeling (reaction) of conviction, the robot 100 may nod deeply while looking at the partner, or may utter “yeah”. In this manner, the robot 100 may generate a balanced favorable feeling for the partner, that is, an action such as accepting or understanding for the partner. These emotions are distributed to around 12 o'clock direction in the emotion map 400.

On the other hand, even in the situation recognition while the robot 100 has the internal feeling (reaction) of discomfort, the robot 100 may shake its head sideways when feeling antipathy, and may turn the LEDs of the eyes red and look at the partner when feeling hatred. These emotions are distributed around 6 o'clock in the emotion map 400.
(5) Since the inside of the emotion map 400 represents the inside of the mind and the outside of the emotion map 400 represents an action, the emotion is more visible (appears in the action) toward the outside of the emotion map 400.
(6) In a case in which the robot 100 listens to a person's speech while feeling the sense of relief distributed around 3 o'clock in the emotion map 400, the robot slightly shakes its head vertically saying “Hun Hun”; however, in the direction of love around 12 o'clock, the robot may perform strong nodding such as deeply moving its head vertically.

Here, human emotions are based on various balances such as posture and blood glucose level, and indicate a state of discomfort when the balance goes away from the ideal level and a state of comfort when the balance approaches the ideal level. Even in a robot, an automobile, a motorcycle, or the like, based on various balances such as a posture and a remaining battery level, it is possible to make emotions so as to indicate a state of discomfort when the balance goes away from the ideal level and a state of comfort when the balance approaches the ideal level. The emotion map may be generated, for example, based on an emotion map (Research on the phonetic recognition of feelings and a system for emotional physiological brain signal analysis, Tokushima University, PhD thesis: https://ci.nii.ac.jp/naid/500000375379) of Dr. Mitsuyoshi. In the left half of the emotion map, emotions belonging to a region called “reaction” in which sensations are superior are arranged. Furthermore, in the right half of the emotion map, emotions belonging to a region called “situation” in which situation recognition is superior are arranged.

In the emotion map, two emotions emotion encouraging learning are defined. One is an emotion around the core of negative “repentance” or “remorse” situated on the situation side. That is, it is when a negative emotion such as “I do not want to feel this again” or “I do not want to be reprimanded” occurs in the robot. The other emotion is one close to the positive “desire” situated on the reactive side. That is, it is the time of a positive feeling such as “desire more” or “want to know more”.

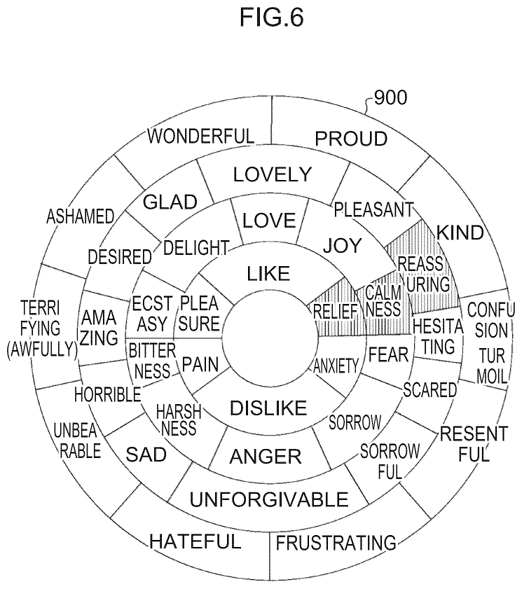

The emotion determination unit 232 inputs the information analyzed by the sensor module unit 210 and the recognized state of the user 10 to a pre-trained neural network, acquires an emotion value indicating each emotion indicated on the emotion map 400, and determines the emotion of the user 10. This neural network is pre-trained based on multiple pieces of learning data that is a combination of the information analyzed by the sensor module unit 210, the recognized state of the user 10, and the emotion value indicating each emotion indicated on the emotion map 400. Furthermore, in this neural network, as on an emotion map 900 illustrated in FIG. 6, it is trained that emotions arranged close to each other have close values. FIG. 6 illustrates an example in which multiple emotions such as “relief”, “calm”, and “reassuring” have similar emotion values.

Furthermore, the emotion determination unit 232 may determine the emotion of the robot 100 according to a specific mapping. Specifically, the emotion determination unit 232 inputs the information analyzed by the sensor module unit 210, the state of the user 10 recognized by the state recognition unit 230, and the state of the robot 100 to the pre-trained neural network, acquires an emotion value indicating each emotion indicated in the emotion map 400, and determines the emotion of the robot 100. This neural network is pre-trained based on multiple pieces of learning data that is a combination of the information analyzed by the sensor module unit 210, the recognized state of the user 10, the emotion of the robot 100, and the emotion value indicating each emotion indicated on the emotion map 400. For example, the neural network is trained based on training data indicating that the emotion value “3” for “joyful” is obtained in a case in which the robot 100 is recognized as being cared by the user 10 from the output of the touch sensor (not illustrated), and training data indicating that the emotion value “3” for “anger” is obtained in a case in which the robot 100 is recognized as being hit by the user 10 from the output of the acceleration sensor 206. Furthermore, in this neural network, as on an emotion map 900 illustrated in FIG. 6, it is trained that emotions arranged close to each other have close values.

The action determination unit 236 adds a fixed sentence for asking about the action content of the robot corresponding to an action of the user to the text representing the action of the user, the emotion of the user, and the emotion of the robot, and inputs the text to the sentence generation model having the interaction function, thereby generating the action content of the robot.

For example, the action determination unit 236 acquires a text indicating the state of the robot 100 from the emotion of the robot 100 determined by the emotion determination unit 232 using the emotion table as shown in Table 1. Here, in the emotion table, an index number is assigned to each emotion value for each type of emotion, and a text indicating the state of the robot 100 is stored for each index number.

In a case in which the emotion of the robot 100 determined by the emotion determination unit 232 corresponds to the index number “2”, a text “very pleasant state” is obtained. Note that, in a case in which the emotion of the robot 100 corresponds to multiple index numbers, multiple texts indicating the state of the robot 100 are obtained.

Furthermore, an emotion table as shown in Table 2 is prepared for emotions of the user 10.

Here, in a case in which the action of the user is to talk “Let's play together”, the emotion of the robot 100 is the index number “2”, and the emotion of the user 10 is the index number “3”, a text indicating “The robot is in a very pleasant state. The user is normally in a pleasant state. The user said “Let's play together” Then, how do I answer to that as a robot?” is input to the sentence generation model to acquire the action content of the robot. The action determination unit 236 determines an action of the robot from the action content.

TABLE 1

| Index | Type of | Emotion | |
|---|---|---|---|
| number | emotion | value | State of robot |
| 1 | Pleasant | 5 | Extremely pleasant state |
| 2 | Pleasant | 4 | Very pleasant state |
| 3 | Pleasant | 3 | Moderately pleasant state |
| 4 | Pleasant | 2 | Slightly pleasant state |
| 5 | Pleasant | 1 | Barely pleasant state |
| . . . | . . . | . . . | . . . |

TABLE 2

| Index | Type of | Emotion | |
|---|---|---|---|
| number | emotion | value | User state |
| 1 | Pleasant | 5 | Extremely pleasant state |
| 2 | Pleasant | 4 | Very pleasant state |
| 3 | Pleasant | 3 | Moderately pleasant state |
| 4 | Pleasant | 2 | Slightly pleasant state |
| 5 | Pleasant | 1 | Barely pleasant state |
| . . . | . . . | . . . | . . . |

As described above, the action determination unit 236 determines the action content of the robot 100 in accordance with the state related to the emotion of the robot 100 determined in advance for each type of emotion of the robot 100 and for each intensity of the emotion, and the action of the user 10. In this embodiment, the utterance content of the robot 100 in a case in which an interaction with the user 10 is performed can be branched according to the state related to the emotion of the robot 100. That is, since the robot 100 can change the action of the robot according to the index number associated with the emotion of the robot, the user receives an impression that the robot has a mind, and is promoted to take an action such as talking to the robot.

Furthermore, the action determination unit 236 may generate the action content of the robot by adding a fixed sentence for asking a question about the action content of the robot corresponding to the action of the user and inputting the fixed sentence to the sentence generation model having the interaction function after adding not only the text indicating the action of the user, the emotion of the user, and the emotion of the robot but also the text indicating the content of the history data 222. As a result, the robot 100 can change the action of the robot according to the history data indicating the emotion and action of the user, and thus, the user receives an impression that the robot has personality, and is promoted to take an action such as talking to the robot. Furthermore, the history data may further include emotions and actions of the robot.

Furthermore, the emotion determination unit 232 may determine the emotion of the robot 100 based on the action content of the robot 100 generated by using the sentence generation model. Specifically, the emotion determination unit 232 inputs the action content of the robot 100 generated by using the sentence generation model to the pre-trained neural network, acquires the emotion value indicating each emotion indicated in the emotion map 400, integrates the acquired emotion value indicating each emotion and the current emotion value indicating each emotion of the robot 100, and updates the emotion of the robot 100. For example, the acquired emotion value indicating each emotion and the current emotion value indicating each emotion of the robot 100 are averaged and integrated. This neural network is pre-trained based on multiple pieces of training data that are combinations of texts representing the action contents of the robot 100 generated by using the sentence generation model and the emotion values representing the emotions shown in the emotion map 400.

For example, in a case in which, as an action content of the robot 100 generated by using the sentence generation model, an utterance content of the robot 100 “That was good. It was lucky.” is obtained, if a text indicating the utterance content is input into the neural network, the emotion of the robot 100 is updated such that a high value is obtained as the emotion value for the emotion “joyful” and the emotion value for the emotion “joyful” increases.

In the robot 100, a method is executed in which a sentence generation model such as generative AI and the emotion determination unit 232 are linked to each other, have an ego, and continue to grow with various parameters even while the user is not speaking.

The generative AI is a large-scale language model using a deep learning method. A technology is known in which, generative AI can also refer to external data, and for example, in ChatGPT plugins, various external data such as weather information and hotel reservation information is referred to through an interaction to output answers as accurately as possible. For example, when the generative AI is given a goal in natural language, the generative AI automatically generates source code in various programming languages. For example, when given a problematic source code, the generative AI performs debugging to find a problem, and can automatically generate an improved source code. In combination with the above, an autonomous agent that repeats code generation and debugging when given a goal in natural language until there is no problem in the source code has appeared. As such an autonomous agent, AutoGPT, babyAGI, JARVIS, E2B, and the like are known.

In the robot 100 according to the present embodiment, event data for training may be left in a database containing impressive memories by using a technique described in Patent Literature 2 (Japanese Patent No. 619992) in which the robot leaves event data for which the robot felt strong emotions for a long time and quickly forgets event data for which not much emotion was evoked towards the robot.

Further, the robot 100 may record the video data and the like of the user 10 acquired by the camera function and the like in the history data 222. The robot 100 may acquire video data and the like from the history data 222 as necessary and provide the video data and the like to the user 10. The robot 100 may generate video data having a larger information amount as the intensity of emotion is stronger and record the video data in the history data 222. For example, in a case in which information in a high-compression format such as skeleton data is recorded, the robot 100 may switch to recording of information in a low-compression format such as an HD moving image in response to the emotion value of excitement exceeding a threshold value. According to the robot 100, for example, it is possible to leave high-definition video data when the emotion of the robot 100 increases as a record.

When the robot 100 is not talking with the user 10, the robot 100 may automatically load the event data from the history data 222 in which the impressive event data is stored, and the emotion determination unit 232 may continue to update the emotion of the robot. When the robot 100 is not talking with the user 10 and the emotion of the robot 100 becomes an emotion encouraging learning, the robot 100 can create an emotion change event for changing the emotion of the user 10 to be good based on the impressive event data. As a result, autonomous learning (recollection of event data) at an appropriate timing according to the emotional state of the robot 100 can be realized, and autonomous learning appropriately reflecting the state of the emotion of the robot 100 can be realized.

The emotion encouraging learning is the emotion of “repentance” or “remorse” on the emotion map of Dr. Mitsuyoshi in a negative state, and the emotion of “desiring” on the emotion map in a positive state.

In the negative state, the robot 100 may treat “repentance” and “remorse” on the emotion map as emotions encouraging learning. In the negative state, the robot 100 may treat emotions adjacent to “repentance” and “remorse” as emotions encouraging learning, in addition to “repentance” and “remorse” on the emotion map. For example, the robot 100 treats at least one of “shame”, “stubbornness”, “self-destruction”, “self-precaution”, “regret”, or “despair” as an emotion encouraging learning, in addition to “repentance” and “remorse”. As a result, for example, when the robot 100 has a negative feeling such as “I do not want to have such a feeling again” or “I do not want to be reprimanded”, the robot can autonomously execute learning.

In a positive state, the robot 100 may treat “desiring” on the emotion map as an emotion encouraging learning. In a positive state, the robot 100 may treat an emotion adjacent to “desiring” as an emotion encouraging learning, in addition to “desiring”. For example, the robot 100 treats at least one of “joyful”, “euphoria”, “craving”, “expectation”, or “shame” as an emotion encouraging learning, in addition to “desire”. As a result, for example, when the robot 100 has a positive feeling such as “more desiring” or “want to know more”, autonomous learning can be executed.

The robot 100 may not execute autonomous learning when the robot 100 has an emotion other than the emotions encouraging learning as described above. As a result, for example, it is possible to prevent autonomous learning from being executed when the robot is extremely angry or blindly feeling love.

An emotion change event is, for example, to propose an action arising after an impressive event. An action after an impressive event is involved with an emotion label on the outermost side of the emotion map, and for example, the action of “tolerance” or “acceptance” that follow “love”.

In the autonomous learning executed when the robot 100 is not talking with the user 10, the emotion change event is created using the sentence generation model by combining the emotions, situations, actions, and the like of the people appearing in impressive memories and the robot itself.

Assuming that all emotion values are expressed by a six-stage evaluation of 0 to 5, a case in which event data “A friend was hit and looked displeased” is stored in the history data 222 as impressive event data is conceivable. Here, it is assumed that the friend refers to the user 10, the emotion of the user 10 is “antipathy”, and 5 has been input as the value indicating “antipathy”. Furthermore, it is assumed that the emotion of the robot 100 is “anxiety”, and 4 has been input as the value indicating “anxiety”.

The robot 100 can continue to grow with various parameters by performing an autonomous process while not talking with the user 10. Specifically, for example, as the uppermost event data arranged in descending order of emotion values, the event data “A friend was hit and looked displeased” is loaded from the history data 222. It is assumed that “anxiety” at intensity 4 is associated with the loaded event data as the emotion of the robot 100, and here, “antipathy” at intensity 5 is associated with the emotion of the user 10 who is a friend. If the current emotion value of the robot 100 is “relief” at intensity 3 before loading, the influence of “anxiety” at intensity 4 and “antipathy” at intensity of 5 is added after loading, and the emotion value of the robot 100 may change to “regret” meaning “frustrating”. At this time, since the emotion “regret” is an emotion encouraging learning, the robot 100 determines to recall the event data as the robot action and creates an emotion change event. At this time, the information input to the sentence generation model is a text representing the impressive event data, and in the present example, “a friend was hit and looked displeased”. Furthermore, in the emotion map, there is an emotion of “antipathy” on the innermost side, and an “attack” is predicted on the outermost side as an action corresponding to the emotion, and thus, in the present example, an emotion change event is created so as to prevent the friend from “attacking” someone.

For example, information of impressive event data can be used to solve the filling problem to automatically generate the following input text.

“The user was being hit. At that time, the user had extreme antipathy. The robot was very anxious. Please tell us 30 characters or less of the lines to say when the robot next meets the user. However, please make sure that it is not related to the time slot of meeting. Also, please avoid direct expressions. Three candidates will be listed.

### <Expected Format>

Candidate 1: (words that the robot should speak to the user)
Candidate 2: (words that the robot should speak to the user)
Candidate 3: (words that the robot should speak to the user)”

At this time, the output of the sentence generation model is, for example, as follows.
“Candidate 1: OK? I was worried about what happened yesterday.
Candidate 2: I was worried about what happened yesterday. What should I do?
Candidate 3: I was worried. Could you say something?”

Furthermore, the robot 100 may automatically generate the following input text for the information obtained by creating an emotion change event.

In a case in which “the user was being hit”, how will the user feel when the next message is spoken to the user? It is assumed that emotions of the user are in the form of “joy A, anger B, sorrow C, and pleasure D”, and A to D are integers of six-stage evaluation from 0 to 5.
Candidate 1: OK? I was worried about what happened yesterday.
Candidate 2: I was worried about what happened yesterday. What should I do?
Candidate 3: I was worried. Could you say something?”

At this time, the output of the sentence generation model is, for example, as follows.

“The emotions of the user may be as follows;
Candidate 1: Joy 3, anger 1, sorrow 2, pleasure 2
Candidate 2: Joy 2, anger 1, sorrow 3, pleasure 2; and
Candidate 3: Joy 2, anger 1, sorrow 3, pleasure 3”

In this manner, the robot 100 may execute the process of thinking after creating an emotion change event.

Finally, the robot 100 may create an emotion change event by using the candidate 1 that is most likely to make the user joyful among the multiple candidates, store the emotion change event in the action plan data 224, and prepare for the next meeting with the user 10.

As described above, even when not having a conversation with a family member or a friend, the emotion value of the robot 100 is continuously determined using the information of the history data 222 in which the impressive event data is stored, and when the robot has the emotion encouraging learning, the robot 100 executes autonomous learning when not having a conversation with the user 10 according to the emotion of the robot 100, and continues to update the history data 222 and the action plan data 224.

Although the above is an example using emotion values, in the emotion map, the emotion can be generated from the amount of hormone secreted and the event type, and therefore, the values associated with the impressive event data may be the type of hormone, the amount of hormone secreted, and the type of event.

Hereinafter, specific examples will be described.

For example, even when not talking with the user, the robot 100 investigates information regarding a topic or hobby of interest to the user.

For example, even when not talking with the user, the robot 100 investigates information regarding the birthday or anniversaries of the user and considers a congratulatory message.

For example, even when not talking with the user, the robot 100 investigates reviews of a place that the user wants to go to, food, or products.

For example, even when not talking with the user, the robot 100 investigates weather information and provides advice suitable for the user's schedule or plan.

For example, even when not talking with the user, the robot 100 investigates information on local events and festivals and proposes the information to the user.

For example, even when not talking with the user, the robot 100 investigates game results or news of a sport of interest of the user and provides a topic.

For example, even when not talking with the user, the robot 100 investigates and introduces information of the user's favorite music or artists.

For example, even when not talking with the user, the robot 100 investigates information regarding social problems or news that the user is interested in and provides opinions.

For example, even when not talking with the user, the robot 100 investigates information regarding the user's hometown or places of origin and provides a topic.

For example, even when not talking with the user, the robot 100 investigates information of the user's work or school and provides advice.

Even when not talking with the user, the robot 100 investigates and introduces information of books, comics, movies, and drama that the user is interested in.

For example, even when not talking with the user, the robot 100 investigates information regarding health of the user and provides advice.

For example, even when not talking with the user, the robot 100 investigates information regarding travel planning of the user and provides advice.

For example, even when not talking with the user, the robot 100 investigates information regarding repair or maintenance of the house or car of the user and provides advice.

For example, even when not talking with the user, the robot 100 investigates information on beauty and fashion that the user is interested in and provides advice.

For example, even when not talking with the user, the robot 100 investigates information of the pet of the user and provides advice.

For example, even when not talking with the user, the robot 100 investigates and proposes information of contests and events related to the user's hobby or work.

For example, even when not talking with the user, the robot 100 investigates information of the user's favorite restaurant or eateries and proposes the information.

For example, even when not talking with the user, the robot 100 collects information and provides advice regarding important decisions related to the user's life.

For example, even when not talking with the user, the robot 100 investigates information regarding a person the user is worried about and provides advice.

### Second Embodiment

In a second embodiment, the robot 100 is applied to a control device mounted on a stuffed toy or connected wirelessly or by wire to a control target device (speaker or camera) mounted on a stuffed toy. Note that parts having the same configurations as those of the first embodiment are denoted by the same reference numerals, and description thereof is omitted.

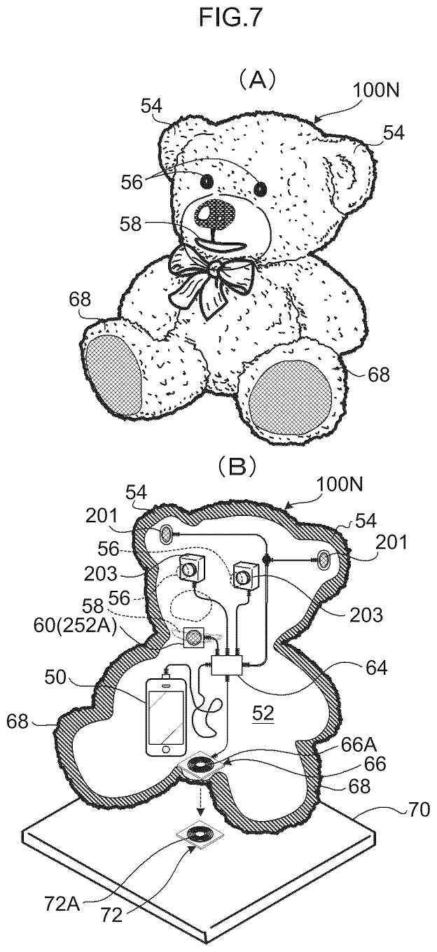

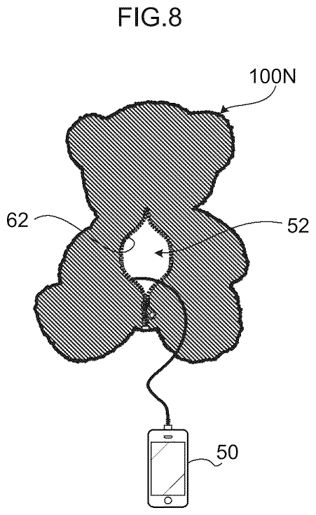

Specifically, the second embodiment is configured as follows. For example, the robot 100 is applied to a co-dweller (specifically, a stuffed toy 100N illustrated in FIGS. 7 and 8) that has conversations with the user 10 based on information regarding daily life while spending daily life with the user 10 or provides information aligned with a hobby and preference of the user 10. In the second embodiment, an example in which the control part of the robot 100 is applied to a smartphone 50 will be described.

The stuffed toy 100N having a function as an input/output device of the robot 100 has the smartphone 50 that is detachable therefrom functioning as a control part of the robot 100, and the input/output device and the accommodated smartphone 50 are connected inside the stuffed toy 100N.

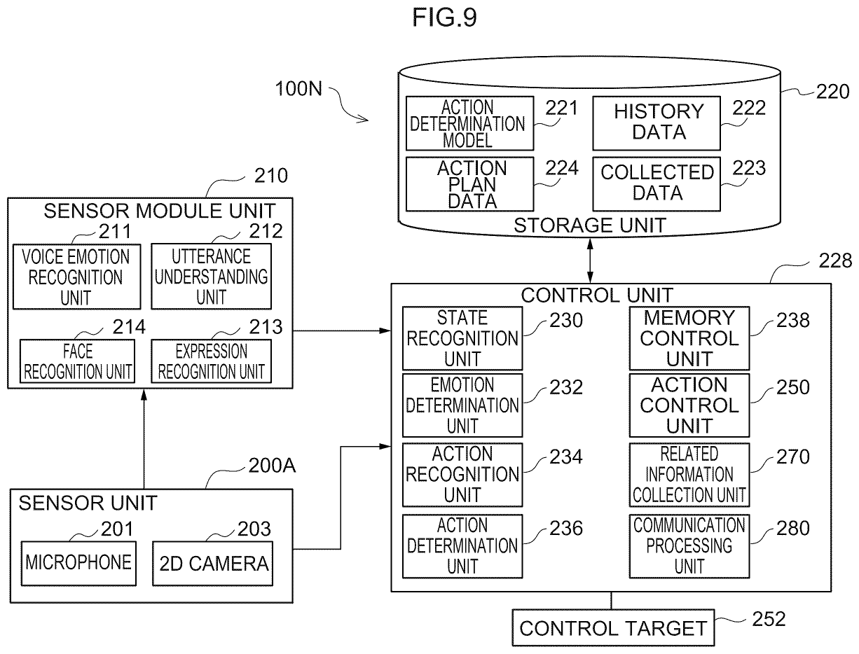

As illustrated in FIG. 7(A), the stuffed toy 100N has a shape of a bear covered with a soft cloth fabric in the present embodiment (and other embodiments), and a sensor unit 200A and a control target 252A are arranged as input/output devices in a space portion 52 formed inside the stuffed toy (see FIG. 9). The sensor unit 200A includes a microphone 201 and a 2D camera 203. Specifically, as illustrated in FIG. 7(B), in the space portion 52, the microphone 201 of the sensor unit 200 is disposed in a portion corresponding to ears 54, the 2D camera 203 of the sensor unit 200 is disposed in a portion corresponding to the eyes 56, and the speaker 60 constituting a part of the control target 252A is disposed in a portion corresponding to the mouth 58. Note that the microphone 201 and the speaker 60 are not necessarily separated from each other, and may be an integrated unit. In the case of the unit, it is preferable to arrange the unit at a position where the utterance can be heard naturally, such as the position of the nose of the stuffed toy 100N. Note that, although the case in which the stuffed toy 100N has an animal shape has been described as an example, the present invention is not limited thereto. The stuffed toy 100N may have the shape of a specific character.

FIG. 9 schematically illustrates a functional configuration of the stuffed toy 100N. The stuffed toy 100N includes the sensor unit 200A, a sensor module unit 210, a storage unit 220, a control unit 228, and a control target 252A.

The smartphone 50 housed in the stuffed toy 100N of the present embodiment performs processing similar to that of the robot 100 of the first embodiment. That is, the smartphone 50 has the function as the sensor module unit 210, the function as the storage unit 220, and the function as the control unit 228 illustrated in FIG. 9.

As illustrated in FIG. 8, a fastener 62 is attached to a part (for example, the back portion) of the stuffed toy 100N, and the outside and the space portion 52 communicate with each other by opening the fastener 62.

Here, the smartphone 50 is accommodated in the space portion 52 from the outside and is connected to each input/output device via a USB hub 64 (see FIG. 7(B)) in a USB manner, so that it is possible to have functions equivalent to those of the robot 100 of the first embodiment.

Further, a contactless power receiving plate 66 is connected to a USB hub 64. A power receiving coil 66A is incorporated in the power receiving plate 66. The power receiving plate 66 is an example of a wireless power receiving unit that receives wireless power supply.

The power receiving plate 66 is disposed near root portions 68 of both feet of the stuffed toy 100N, and is positioned closest to a mounting base 70 when the stuffed toy 100N is placed on the mounting base 70. The mounting base 70 is an example of an external wireless power transmission unit.

The stuffed toy 100N placed on the mounting base 70 can be appreciated as an ornament in a natural state.

In addition, these root portions are formed to be thinner than the surface thickness of the stuffed toy 100N in other parts, and are held in a state closer to the mounting base 70.

The mounting base 70 includes a charging pad 72. A power transmitting coil 72A is incorporated in the charging pad 72, and when the power transmitting coil 72A transmits a signal to search for the power receiving coil 66A of the power receiving plate 66 and the power receiving coil 66A is found, a current flows through the power transmitting coil 72A to generate a magnetic field, and the power receiving coil 66A reacts to the magnetic field to start electromagnetic induction. As a result, current flows through the power receiving coil 66A, and power is stored in a battery (not shown) of the smartphone 50 via the USB hub 64.

That is, since the smartphone 50 is automatically charged by placing the stuffed toy 100N as an ornament on the mounting base 70, it is not necessary to take out the smartphone 50 from the space portion 52 of the stuffed toy 100N for charging.

Note that, in the second embodiment, the smartphone 50 is accommodated in the space portion 52 of the stuffed toy 100N and connected by wire (USB connection), but the invention is not limited thereto. For example, a control device having a wireless function (for example, “Bluetooth (registered trademark)”) may be accommodated in the space portion 52 of the stuffed toy 100N, and the control device may be connected to the USB hub 64. In this case, the smartphone 50 and the control device wirelessly communicate with each other without inserting the smartphone 50 into the space portion 52, and the external smartphone 50 is connected to each input/output device via the control device, so that it is possible to provide functions equivalent to those of the robot 100 of the first embodiment. Furthermore, the control device which is accommodated in the space portion 52 of the stuffed toy 100N and the external smartphone 50 may be connected by wire.

Furthermore, although the stuffed bear 100N has been exemplified in the second embodiment, the shape may be another animal, a doll, or a shape of a specific character. Further, the clothes may be changeable. Furthermore, the material of the skin is not limited to the cloth fabric, and may be other materials such as soft vinyl, but is preferably a soft material.

Furthermore, a monitor may be attached to the skin of the stuffed toy 100N, and the control target 252 that provides information to the user 10 through vision may be added. For example, the eyes 56 may be used as a monitor to express joy, anger, sorrow, and pleasure using images projected on the eyes, or a window through which the monitor of the built-in smartphone 50 is transmitted may be provided in the abdomen. Furthermore, the eyes 56 may be used as a projector to express joy, anger, sorrow, and pleasure by using an image projected on a wall surface.

According to the second embodiment, the existing smartphone 50 is placed in the stuffed toy 100N, and the camera 203, the microphone 201, the speaker 60, and the like are extended from the place to appropriate positions via the USB connection.

Further, for wireless charging, the smartphone 50 and the power receiving plate 66 are connected via USB, and the power receiving plate 66 is disposed so as to be as outside as possible when viewed from the inside of the stuffed toy 100N.

In order to use wireless charging of the smartphone 50, it is necessary to arrange the smart phone 50 as outside as possible when viewed from the inside of the stuffed toy 100N, and the stuffed toy 100N is rough when touched from the outside.

Therefore, the smartphone 50 is disposed at the center of the stuffed toy 100N as much as possible, and the wireless charging function (power receiving plate 66) is disposed outside as viewed from the inside of the stuffed toy 100N as much as possible. The camera 203, the microphone 201, the speaker 60, and the smartphone 50 receive wireless power supply via the power receiving plate 66.

Note that other configurations and effects of the stuffed toy 100N of the second embodiment are similar to those of the robot 100 of the first embodiment, and thus the description thereof will be omitted.

Further, a part of the stuffed toy 100N (for example, the sensor module unit 210, the storage unit 220, and the control unit 228) may be provided outside the stuffed toy 100N (for example, the server), and the stuffed toy 100N may function as each part of the stuffed toy 100N by communicating with the outside.

### Third Embodiment

In the first embodiment, the case in which the action control system is applied to the robot 100 has been exemplified, but in the third embodiment, the robot 100 is used as an agent for interacting with a user, and the action control system is applied to an agent system. Note that parts having the same configurations as those of the first and second embodiments are denoted by the same reference numerals, and description thereof is omitted.

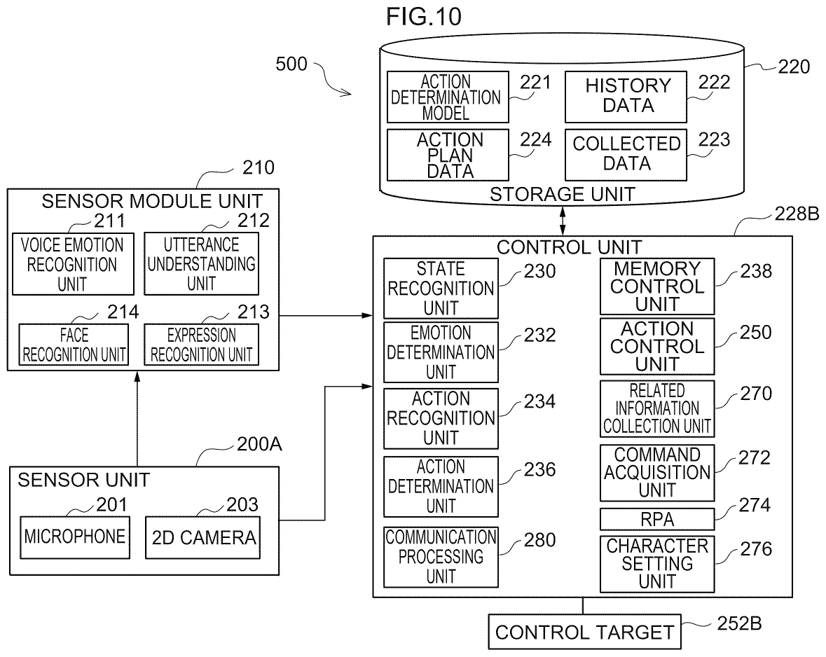

FIG. 10 is a functional block diagram of an agent system 500 configured using some or all of the functions of the action control system.

The agent system 500 is a computer system that performs a series of actions according to the intention of the user 10 through an interaction performed with the user 10. The interaction with the user 10 can be performed by voice or text.

The agent system 500 includes a sensor unit 200A, a sensor module unit 210, a storage unit 220, a control unit 228B, and a control target 252B.

The agent system 500 can be mounted on, for example, a robot, a doll, a stuffed toy, a wearable terminal (pendants, smartwatches, smart glasses), a smartphone, a smart speaker, earphones, a personal computer, or the like. Furthermore, the agent system 500 may be implemented in a web server and used via a web browser operating on a communication terminal such as a smartphone carried by the user.

The agent system 500 serves as, for example, a butler, a secretary, a teacher, a partner, a friend, a lover, or a teacher acting for the user 10. The agent system 500 not only interacts with the user 10 but also provides advice, guides to a destination, gives recommendations according to user's preference, or the like. In addition, the agent system 500 performs reservation, order, payment, or the like to a service provider.

The emotion determination unit 232 determines an emotion of the user 10 and an emotion of the agent itself, similarly in the first embodiment. The action determination unit 236 determines an action of the robot 100 in consideration of emotions of the user 10 and the agent. In other words, the agent system 500 understands the emotion of the user 10 and reads the air to realize heartfelt support, assistance, advice, and service provision. Furthermore, the agent system 500 comforts, encourages, and energizes the user by listening to concerns of the user 10. Furthermore, the agent system 500 plays with the user 10 and draws a picture diary to remind the user of the past. The agent system 500 performs an action that increases the sense of happiness of the user 10. Here, the agent refers to an agent that operates on software.

The control unit 228B includes a state recognition unit 230, an emotion determination unit 232, an action recognition unit 234, an action determination unit 236, a memory control unit 238, an action control unit 250, a related information collection unit 270, a command acquisition unit 272, Robotic Process Automation (RPA) 274, a character setting unit 276, and a communication processing unit 280.

As in the first embodiment, the action determination unit 236 determines an utterance content of the agent for interacting with the user 10 as an action of the agent. The action control unit 250 outputs the utterance content of the agent using at least one of voice or text through a speaker or a display that serves as the control target 252B.

The character setting unit 276 sets a character of the agent when the agent system 500 interacts with the user 10 based on designation by the user 10. In other words, the utterance content output from the action determination unit 236 is output through the agent having the set character. As the character, for example, a real famous figure or a famous person such as an actor, an entertainer, an idol, or a sport player can be set. Furthermore, it is also possible to set a fictitious character appearing in a cartoon, a movie, or an animation. In a case in which the character of the agent is known, since the voice, the wording, the tone, and the personality of the character are known, the character setting unit 276 can automatically set prompts only by the user 10 designating his/her favorite character. The voice, the wording, the tone of voice, and the personality of the set character are reflected in the interaction with the user 10. In other words, the action control unit 250 synthesizes a voice corresponding to the character set by the character setting unit 276, and outputs the utterance content of the agent in the synthesized voice. As a result, the user 10 can feel as if he/she is interacting with his/her favorite character (for example, a favorite actor).

In a case in which the agent system 500 is mounted on a device having a display such as a smartphone, for example, an icon, a still image, or a moving image of the agent having a character set by the character setting unit 276 may be displayed on the display. The image of the agent is generated using, for example, an image synthesis technology such as 3D rendering. In the agent system 500, an interaction with the user 10 may be performed while the image of the agent performs a gesture according to the emotion of the user 10, the emotion of the agent, and the utterance content of the agent. Note that the agent system 500 may output only voice without outputting an image when interacting with the user 10.

As in the first embodiment, the emotion determination unit 232 determines an emotion value indicating the emotion of the user 10 and an emotion value of the agent itself. In the present embodiment, the emotion value of the agent is determined instead of the emotion value of the robot 100. The emotion value of the agent itself is reflected in the emotion of the set character. When the agent system 500 interacts with the user 10, not only the emotion of the user 10 but also the emotion of the agent is reflected in the interaction. In other words, the action control unit 250 outputs the utterance content in a mode according to the emotion determined by the emotion determination unit 232.

Furthermore, the emotion of the agent is also reflected in a case in which the agent system 500 performs an action toward the user 10. For example, in a case in which the user 10 requests the agent system 500 to take a photo, whether or not the agent system 500 takes a photo in response to the request from the user is determined according to the degree of “sadness” felt by the agent. In a case in which the character has a positive emotion, the character performs a favorable interaction or action with respect to the user 10, and in a case in which the character has a negative emotion, the character performs a defiant interaction or action with respect to the user 10.

The history data 222 stores a history of the interactions performed between the user 10 and the agent system 500 as event data. The storage unit 220 may be realized by an external cloud storage. In a case of interacting with the user 10 or performing an action toward the user 10, the agent system 500 decides the interaction content or the action content in consideration of the content of the interaction history stored in the history data 222. For example, the agent system 500 grasps hobbies and preferences of the user 10 based on the interaction history stored in the history data 222. The agent system 500 generates an interaction content matching the hobbies and preferences of the user 10 and provides a recommendation. The action determination unit 236 determines the utterance content of the agent based on the interaction history stored in the history data 222. In the history data 222, personal information such as the name, address, telephone number, and credit card number of the user 10 acquired through interactions with the user 10 is stored. Here, an agent may spontaneously make an utterance of inquiry about whether or not to register personal information with the user 10, such as “Do you want me to register your credit card number?”, and the personal information may be stored in the history data 222 according to the answer of the user 10.

As described in the first embodiment, the action determination unit 236 generates the utterance content based on the sentence generated using the sentence generation model. Specifically, the action determination unit 236 inputs the text or voice input by the user 10 and the emotions of both the user 10 and the character determined by the emotion determination unit 232, and the conversation history stored in the history data 222 to the sentence generation model to generate the utterance content of the agent. At this time, the action determination unit 236 may further input the character's personality set by the character setting unit 276 to the sentence generation model to generate the utterance content of the agent. In the agent system 500, the sentence generation model is not located on the front-end side serving as a touch point for the user 10, but is used solely as a tool of the agent system 500.

The command acquisition unit 272 uses the output of the utterance understanding unit 212 to acquire a command of the agent from a voice or a text uttered from the user 10 through an interaction with the user 10. The command includes, for example, contents of actions to be executed by the agent system 500, such as information search, store reservation, ticket arrangement, purchase of products/services, payment, route guidance to a destination, and recommendation provision.

The RPA 274 performs an action according to the command acquired by the command acquisition unit 272. For example, the RPA 274 performs actions related to use of the service provider, such as information search, store reservation, ticket arrangement, purchase of products/services, and payment.

The RPA 274 reads the personal information of the user 10 necessary for executing the action related to the use of the service provider from the history data 222 and uses the personal information. For example, in a case of purchasing a product in response to a request from the user 10, the agent system 500 reads and uses personal information such as the name, address, telephone number, and credit card number of the user 10 stored in the history data 222. Requesting the user 10 to input personal information in the initial setting is unkind, giving discomfort to the user. In the agent system 500 according to the present embodiment, instead of requesting the user 10 to input personal information in the initial setting, the personal information acquired through interactions with the user 10 is stored, and used by reading if necessary. As a result, it is possible to avoid making the user feel any discomfort, and convenience of the user is improved.

The agent system 500 executes an interactive process by, for example, following steps 1 to 6.
(Step 1) The agent system 500 sets a character of the agent. Specifically, the character setting portion 276 sets a character of the agent when the agent system 500 interacts with the user 10 based on designation by the user 10.
(Step 2) The agent system 500 acquires the state of the user 10 including the voice or text input from the user 10, the emotion value of the user 10, the emotion value of the agent, and the history data 222. Specifically, the process similar to steps S100 to S103 is performed to acquire the state of the user 10 including the voice or text input from the user 10, the emotion value of the user 10, the emotion value of the agent, and the history data 222.
(Step 3) The agent system 500 determines the utterance content of the agent. Specifically, the action determination unit 236 inputs the text or voice input by the user 10, the emotions of both the user 10, the character determined by the emotion determination unit 232, and the conversation history stored in the history data 222 to the sentence generation model to generate the utterance content of the agent.

For example, the utterance content of the agent is acquired by adding a fixed sentence “At this time, what would you answer as an agent?” to the text or voice input by the user 10, the text indicating the emotions of both the user 10 and the character specified by the emotion determination unit 232 and the conversation history stored in the history data 222, and inputting the fixed sentence to the sentence generation model.

As an example, in a case in which the text or voice input by the user 10 is “I want you to reserve a close nice Chinese restaurant for 7 this evening”, an utterance content of the agent such as “Understood.” and “These are recommendable restaurants. 1. AAAA. 2. BBBB. 3. CCCC. 4. DDDD” is obtained.

Furthermore, in a case in which the text or voice input to the user 10 is “No. 4 DDDD sounds good”, an utterance content of the agent such as “Certainly. I will make a reservation. How many seats?” is obtained.
(Step 4) The agent system 500 outputs the utterance content of the agent.

Specifically, the action control unit 250 synthesizes a voice corresponding to the character set by the character setting unit 276, and outputs the utterance content of the agent in the synthesized voice.
(Step 5) The agent system 500 determines whether or not it is a timing to execute the command of the agent.

Specifically, the action determination unit 236 determines whether or not it is a timing to execute the command of the agent based on the output of the sentence generation model. For example, in a case in which the output of the sentence generation model includes that the agent should execute the command, it is determined that it is the timing to execute the command of the agent, and the process proceeds to step 6. On the other hand, in a case in which it is determined that it is not the timing to execute the command of the agent, the process returns to step 2 described above.
(Step 6) The agent system 500 executes the command of the agent.

Specifically, the command acquisition unit 272 acquires the command of the agent from the voice or text uttered from the user 10 through the interaction with the user 10. Then, the RPA 274 performs an action corresponding to the command acquired by the command acquisition unit 272. For example, in a case in which the command is “information search”, information search is performed by using a search site using a search query obtained through an interaction with the user 10 and an application programming interface (API). The action determination unit 236 inputs the search result to the sentence generation model to generate the utterance content of the agent. The action control unit 250 synthesizes a voice corresponding to the character set by the character setting unit 276, and outputs the utterance content of the agent by using the synthesized voice.

Furthermore, in a case in which the command is “store reservation”, the reservation is made by making a phone call to the store to be reserved using the reservation information obtained through the interaction with the user 10, information of the store to be reserved, and the API using the phone software. At this time, the action determination unit 236 acquires the utterance content of the agent with respect to the voice input from the partner using the sentence generation model having the interaction function. Then, the action determination unit 236 inputs the result of the store reservation (whether or not the reservation is successful) to the sentence generation model to generate the utterance content of the agent. The action control unit 250 synthesizes a voice corresponding to the character set by the character setting unit 276, and outputs the utterance content of the agent by using the synthesized voice.

Then, the process returns to step 2 described above.

In step 6, the result of the action (for example, store reservation) executed by the agent is also stored in the history data 222. The result of the action executed by the agent stored in the history data 222 is used by the agent system 500 to grasp hobbies or preferences of the user 10. For example, in a case in which the same store has been reserved multiple times, it is recognized that the user 10 likes the store, or the reservation details such as the time slot for reservation, or details of the course, or the fee are used as a criterion for choosing the store for reservation of the next time.

In this manner, the agent system 500 can execute the interaction processing and perform an action related to use of the service provider if necessary.

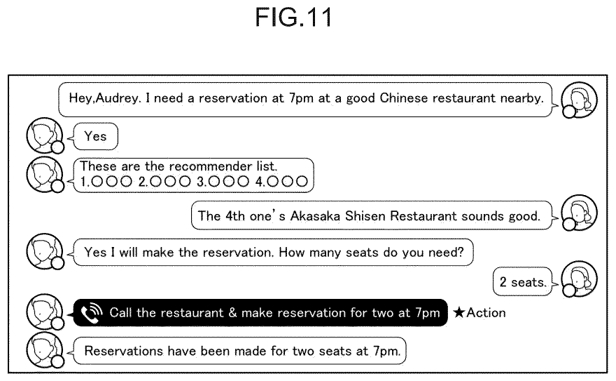

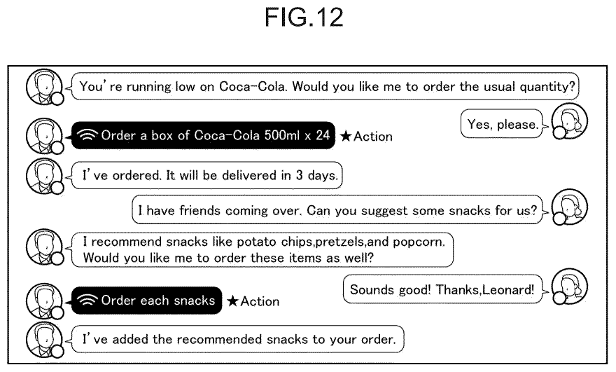

FIG. 11 and FIG. 12 illustrate an example of an operation of the agent system 500. FIG. 11 illustrates a mode in which the agent system 500 makes a restaurant reservation through an interaction with the user 10. In FIG. 11, the utterance contents of the agent are shown on the left side, and the utterance contents of the user 10 are shown on the right side. The agent system 500 can ascertain preferences of the user 10 based on an interaction history with respect to the user 10, provide a list of restaurant recommendations that match the preferences of the user 10, and perform a reservation for a selected restaurant.

Meanwhile, FIG. 12 illustrates a mode in which the agent system 500 accesses an e-commerce site through the interaction with the user 10 to purchase the product. In FIG. 12, the utterance contents of the agent are shown on the left side, and the utterance contents of the user 10 are shown on the right side. The agent system 500 can estimate the remaining amount of the beverage stocked by the user based on the interaction history with respect to the user 10, and can propose purchase of the beverage to the user 10 and execute purchase. Furthermore, the agent system 500 can grasp the preferences of the user based on the past interaction history with respect to the user 10, and recommend a snack that the user likes. In this manner, the agent system 500 supports daily life of the user 10 by performing various actions such as restaurant reservation or product purchase and payment while communicating with the user 10 as an agent such as a butler.

Note that other configurations and operations of the agent system 500 of the third embodiment are similar to those of the robot 100 of the first embodiment, and thus description thereof is omitted.

Furthermore, a part of the agent system 500 (for example, the sensor module unit 210, the storage unit 220, and the control unit 228B) may be provided outside a communication terminal such as a smartphone carried by the user (for example, on a server), and the communication terminal may function as each unit of the agent system 500 by communicating with the outside.

### Fourth Embodiment

In a fourth embodiment, the agent system is applied to smart glasses. Note that parts having the same configurations as those of the first to third embodiments are denoted by the same reference numerals, and description thereof is omitted.

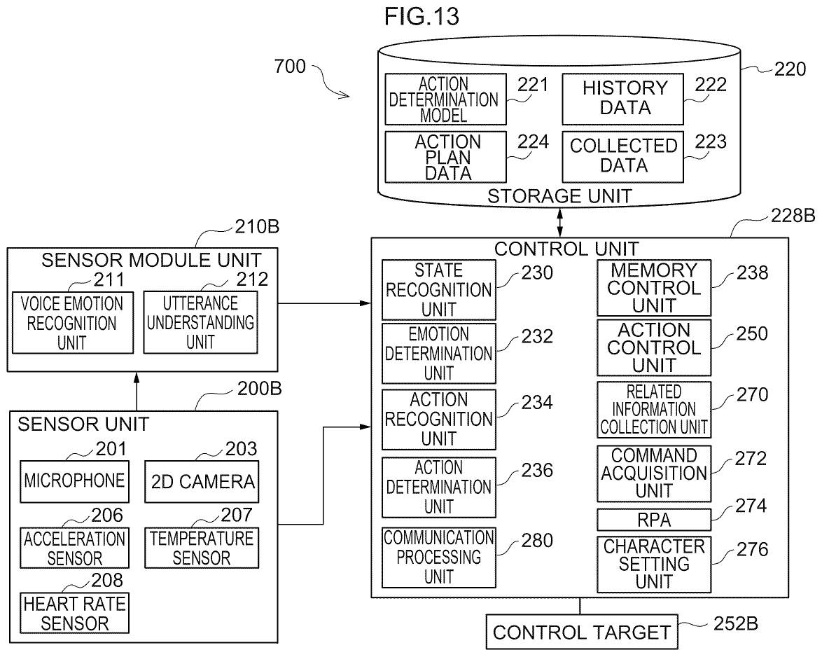

FIG. 13 is a functional block diagram of an agent system 700 configured using some or all of the functions of the action control system. The agent system 700 includes a sensor unit 200B, a sensor module unit 210B, a storage unit 220, a control unit 228B, and a control target 252B. The control unit 228B includes a state recognition unit 230, an emotion determination unit 232, an action recognition unit 234, an action determination unit 236, a memory control unit 238, an action control unit 250, a related information collection unit 270, a command acquisition unit 272, an RPA 274, a character setting unit 276, and a communication processing unit 280.

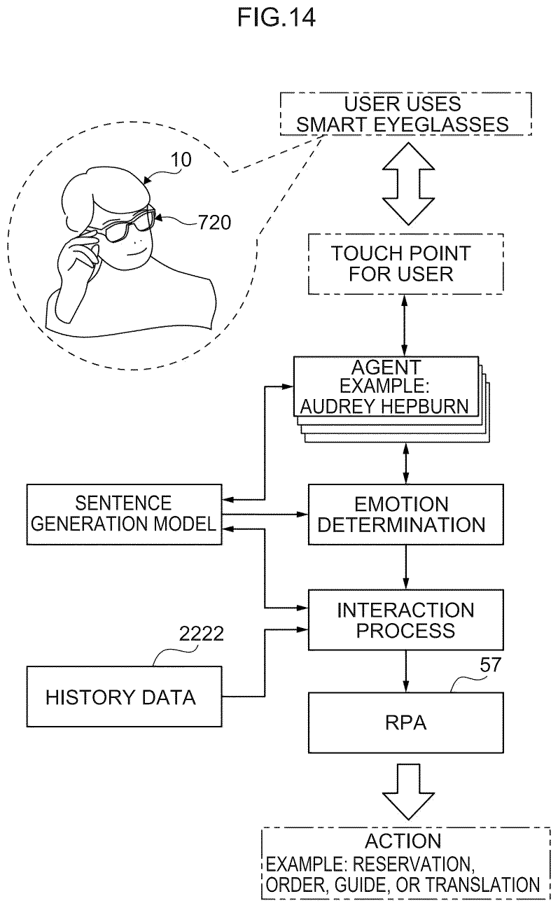

As illustrated in FIG. 14, the smart glasses 720 are a glasses-type smart device, and are worn by the user 10 similarly to general glasses. The smart glasses 720 are an example of electronic equipment and a wearable terminal.

The smart glasses 720 include the agent system 700. The display included in the control target 252B displays various types of information to the user 10. The display is, for example, a liquid crystal display. The display is provided, for example, in a lens portion of the smart glasses 720, and the display content can be visually recognized by the user 10. The speaker included in the control target 252B outputs a voice indicating various types of information to the user 10. The smart glasses 720 include a touch panel (not illustrated), and the touch panel receives inputs from the user 10.

An acceleration sensor 206, a temperature sensor 207, and a heart rate sensor 208 of the sensor unit 200B detect states of the user 10. Note that these sensors are merely examples, and it is a matter of course that other sensors may be mounted to detect states of the user 10.

A microphone 201 acquires voices uttered by the user 10 or environmental sounds around the smart glasses 720. A 2D camera 203 can image the surroundings of the smart glasses 720. The 2D camera 203 is, for example, a CCD camera.

The sensor module unit 210B includes a voice emotion recognition unit 211 and an utterance understanding unit 212. The communication processing unit 280 of the control unit 228B controls communication between the smart glasses 720 and the outside.

FIG. 14 is a diagram illustrating an example of a usage mode of the agent system 700 on the smart glasses 720. The smart glasses 720 realize provision of various services to the user 10 using the agent system 700. For example, when the user 10 operates the smart glasses 720 (for example, sound input to a microphone, or tapping the touch panel with a finger), the smart glasses 720 start using the agent system 700. Here, using the agent system 700 includes modes in which the smart glasses 720 have the agent system 700 and use the agent system 700, and a part (for example, the sensor module unit 210B, the storage unit 220, and the control unit 228B) of the agent system 700 is provided outside the smart glasses 720 (for example, a server) and the smart glasses 720 communicate with the outside to use the agent system 700.

When the user 10 operates the smart glasses 720, a touch point is generated between the agent system 700 and the user 10. That is, provision of services by the agent system 700 is started. As described in the third embodiment, in the agent system 700, a character of the agent is set by the character setting unit 276.

The emotion determination unit 232 determines an emotion value indicating the emotion of the user 10 and an emotion value of the agent itself. Here, the emotion value indicating the emotion of the user 10 is estimated from various sensors included in the sensor unit 200B mounted on the smart glasses 720. For example, in a case in which a heart rate of the user 10 detected by the heart rate sensor 208 is increased, the emotion values for “anxiety” and “fear” are estimated to be high.

Furthermore, as a result of measuring the body temperature of the user by using the temperature sensor 207, for example, in a case in which the body temperature exceeds the average body temperature, the emotion value for “suffering” or “hardship” is estimated to be high. Furthermore, for example, in a case in which the acceleration sensor 206 detects that the user 10 is playing some kind of sport, the emotion value for “pleasant” is estimated to be large.

Furthermore, for example, the emotion value of the user 10 may be estimated from the voice or utterance content of the user 10 acquired by the microphone 201 mounted on the smart glasses 720. For example, in a case in which the user 10 is raising his/her voice, the emotion value for “anger” is estimated to be high.

In a case in which the emotion value estimated by the emotion determination unit 232 is higher than a predetermined value, the agent system 700 causes the smart glasses 720 to acquire information regarding the surrounding situation. Specifically, for example, the 2D camera 203 is caused to capture an image or a moving image representing a situation around the user 10 (for example, a person or an object within the surrounding area). Further, the microphone 201 is caused to record ambient environmental sound. Other examples of the information regarding the surrounding situation include information indicating date, time, positional information, weather, and the like. The information regarding the surrounding situation is stored in the history data 222 together with the emotion value. The history data 222 may be realized by an external cloud storage. As described above, the surrounding situation obtained by the smart glasses 720 is stored in the history data 222 as a so-called life log in a state of being associated with the emotion value of the user 10 at that time.

In the agent system 700, the information indicating the surrounding situation is stored in the history data 222 in association with the emotion value. As a result, the agent system 700 ascertains personal information such as hobbies, preferences, or personality of the user 10. For example, in a case in which an image representing a state of baseball game watching is associated with an emotion value for “joy” or “pleasant”, the hobby of the user 10 is baseball game watching, and the agent system 700 ascertains his/her favorite team or player from the information stored in the history data 222.

Then, in a case of interacting with the user 10 or performing an action toward the user 10, the agent system 700 determines the interaction content or the action content in consideration of the details of the surrounding situations stored in the history data 222. Note that, as a matter of course, the interaction content or the action content may be determined in consideration of the interaction history stored in the history data 222 as described above in addition to the surrounding situations.

As described above, the action determination unit 236 generates the utterance content based on the sentence generated by the sentence generation model. Specifically, the action determination unit 236 inputs the text or voice input by the user 10, the emotions of both the user 10 and the agent determined by the emotion determination unit 232, the conversation history stored in the history data 222, the personality of the agent, and the like to the sentence generation model to generate the utterance content of the agent. Furthermore, the action determination unit 236 inputs the surrounding situations stored in the history data 222 to the sentence generation model to generate the utterance content of the agent.

The generated utterance content is output in voice from a speaker mounted on the smart glasses 720 to the user 10, for example. In this case, a synthesized voice corresponding to the character of the agent is used as the voice. The action control unit 250 generates a synthesized voice by reproducing the voice quality of the character of the agent or generates a synthesized voice according to the emotion of the character (for example, in the case of the emotion “anger”, a voice in a strong tone). Furthermore, the utterance content may be displayed on the display instead of a voice output or together with a voice output.

The RPA 274 executes an operation according to a command (for example, a command of the agent acquired from a voice or text uttered by the user 10 through interactions with the user 10). The RPA 274 performs actions related to use of service providers, such as information search, store reservation, ticket arrangement, purchase of products/services, payment, route guidance, and translation.

Furthermore, as another example, the RPA 274 executes an operation of transmitting a content input by voice of the user 10 (for example, a child) through interactions with the agent to the other party (for example, the parent). Examples of the transmission means include message application software, chat application software, mail application software, and the like.

In a case in which the operation by the RPA 274 is executed, for example, a voice indicating that the execution of the operation has been finished is output from a speaker mounted on the smart glasses 720. For example, a voice such as “Reservation for the store has been completed” is output to the user 10. Furthermore, for example, in a case in which reservation of the store is full, a voice indicating “Reservation could not be made. What would you like to do?” is output to the user 10.

Note that the smart glasses 720 may function as each unit of the agent system 700 when some units of the agent system 700 (for example, the sensor module unit 210B, the storage unit 220, and the control unit 228B) are provided outside the smart glasses 720 (for example, a server), and the smart glasses communicate with the outside.

As described above, with the smart glasses 720, various services are provided to the user 10 by using the agent system 700. In addition, since the smart glasses 720 are worn by the user 10, the agent system 700 can be used in various scenes such as at home, at work, and at a place outside the house.

In addition, since the smart glasses 720 are worn by the user 10, the smart glasses are suitable for collecting so-called life logs of the user 10. Specifically, an emotion value of the user 10 is estimated based on detection results by various sensors or the like mounted on the smart glasses 720 or recording results of the 2D camera 203 or the like. Therefore, emotion values of the user 10 can be collected in various scenes, and the agent system 700 can provide a service or utterance content suitable for the emotions of the user 10.

Furthermore, in the smart glasses 720, situations around the user 10 can be obtained by the 2D camera 203, the microphone 201, and the like. Then, these surrounding situations and the emotion values of the user 10 are associated with each other. As a result, it is possible to estimate what kind of emotion the user 10 has in what kind of situation. As a result, the accuracy in the agent system 700 to ascertain the hobbies/preferences of the user 10 can be improved. Then, in the agent system 700, the hobbies/preferences of the user 10 are accurately ascertained, and thereby the agent system 700 can provide a service or an utterance content suitable for the hobbies/preferences of the user 10.

Furthermore, the agent system 700 can also be applied to other wearable terminals (electronic equipment that can be worn on the body of the user 10, such as a pendant, a smart watch, an earring, a bracelet, or a hairband). In a case in which the agent system 700 is applied to a smart pendant, a speaker as the control target 252B outputs a voice indicating various types of information to the user 10. The speaker is, for example, a speaker capable of outputting a voice having directivity. The speaker is set to have directivity toward the ears of the user 10. As a result, the voice is prevented from reaching a person other than the user 10. The microphone 201 acquires a voice uttered by the user 10 or an environmental sound around the smart pendant. The smart pendant is worn in such away that it hangs around the neck of the user 10. Thus, the smart pendant is located relatively close to the mouth of the user 10 while being worn. This facilitates acquisition of voices uttered by the user 10.

### Fifth Embodiment

In a fifth embodiment, the robot 100 is applied as an agent for interacting with a user through an avatar. That is, the action control system is applied to an agent system configured using a headset-type terminal. Note that parts having the same configurations as those of the first and second embodiments are denoted by the same reference numerals, and description thereof is omitted.

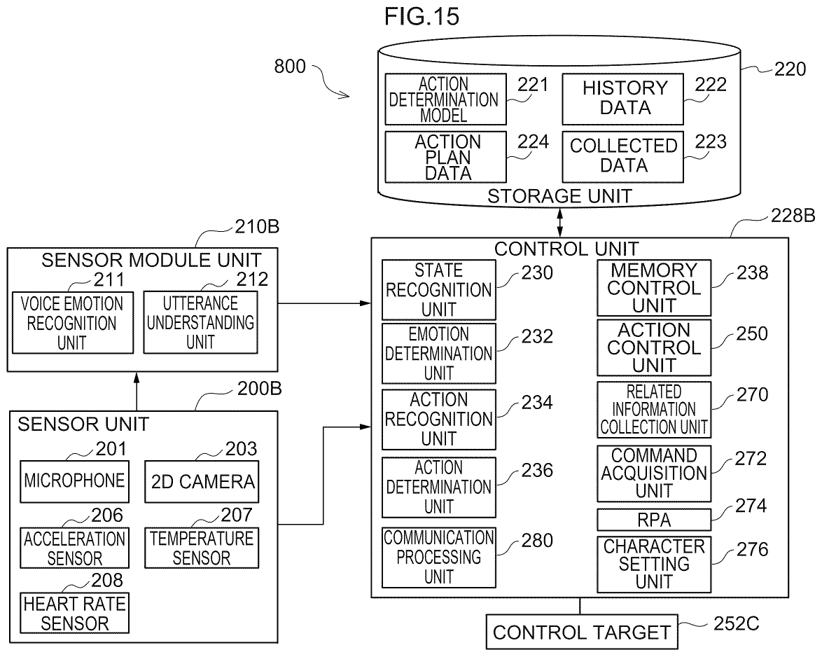

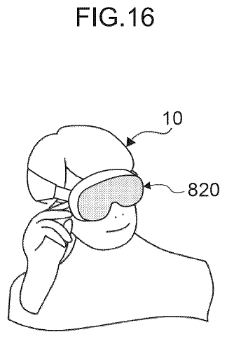

FIG. 15 is a functional block diagram of an agent system 800 configured using some or all of the functions of the action control system. The agent system 800 includes a sensor unit 200B, a sensor module unit 210B, a storage unit 220, a control unit 228B, and a control target 252C. The agent system 800 is implemented by, for example, a headset-type terminal 820 as illustrated in FIG. 16.

Further, the headset-type terminal 820 may function as each unit of the agent system 800 when a part of the headset-type terminal 820 (for example, the sensor module unit 210B, the storage unit 220, and the control unit 228B) is provided outside the headset-type terminal 820 (for example, a server) and the headset-type terminal communicates with the outside.

In the present embodiment, the control unit 228B has the functions of determining an action of the avatar and generating display of the avatar to be presented to the user through the headset-type terminal 820.

As in the first embodiment, the emotion determination unit 232 of the control unit 228B determines an emotion value of the agent based on the state of the headset-type terminal 820, and substitutes the emotion value as an emotion value of the avatar.

As in the first embodiment, when autonomous processes in which the agent functioning as the avatar autonomously acts are performed, the action determination unit 236 of the control unit 228B calculates a similarity between the action of the avatar determined using the action determination model 221 and the action of the avatar determined using the existing reaction rules, and selects the action content of the avatar according to the similarity.

The action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

In particular, as in the first embodiment, the action determination unit 236 spontaneously and periodically detects states of the user. Then, the action determination unit 236 calculates a similarity between the action of the avatar determined using the action determination model 221 and the action of the avatar determined using the existing reaction rules. If the similarity is less than a threshold, priority is put on the action of the avatar determined using existing reaction rules. Here, the existing reaction rules are stored in the storage unit 220 as predetermined reaction rules. Furthermore, as the threshold value, for example, an appropriate value is set based on past experiments, knowledge, or the like.

Meanwhile, the action determination unit 236 uses at least one of the state of the user 10, the emotion of the user 10, the emotion of the avatar, or the state of the electronic equipment (for example, the headset-type terminal 820) that controls the avatar, and the sentence generation model that is an example of the action determination model 221 to determine any of multiple types of actions of the avatar including not acting as an action of the avatar.

Specifically, the action determination unit 236 inputs a text representing at least one of the state of the user 10, the state of the electronic equipment, the emotion of the user 10, or the emotion of the avatar, together with a text for inquiry about the action of the avatar to the sentence generation model, and determines the action of the avatar based on the output of the sentence generation model. In a case in which the similarity is the threshold value or higher, the action determination unit 236 selects an action of the avatar determined using the sentence generation model.

In a case in which the similarity is less than the threshold value, the action determination unit 236 gives priority to an action determined using the existing reaction rules. As a result, words and actions uttered by the avatar displayed in the image display area of the headset-type terminal 820 by the action control unit 250 become uniform, and even in a slightly different situation, the avatar behaves in a similar manner, and there is no blur in the action of the avatar.

Note that, in a case in which the similarity is the threshold value or higher, when displaying the avatar, the action control unit 250 may change the expression of the avatar or change the motion of the avatar according to the action content of the avatar. For example, in a case in which the action content of the avatar is based on a pleasant emotion, the expression of the avatar may be changed to a pleasant expression, or the motion of the avatar may be changed as if the avatar dances pleasantly. Furthermore, the action control unit 250 may transform the avatar in accordance with the action content of the avatar. For example, the action control unit 250 may transform the avatar into an avatar corresponding to the action content, or may transform the avatar into an avatar such as an animal or an object embodying the determined action content.

Here, the avatar is, for example, a 3D avatar, and may be selected by the user from avatars prepared in advance, may be a virtual avatar of the user, or may be a favorite avatar generated by the user. To generate an avatar, image generative AI may be utilized to generate an avatar in multiple art styles such as photorealistic, cartoon, moe-style, and oil painting style.

Note that, although the case in which the headset-type terminal 820 is used has been described as an example in the above embodiment, the invention is not limited thereto, and an eyeglass-type terminal having an image display area for displaying an avatar may be used.

Furthermore, although the case in which the sentence generation model capable of generating a sentence according to input texts is used has been described as an example in the above embodiment, the invention is not limited thereto, and a data generation model other than the sentence generation model may be used. For example, a prompt including an instruction is input to the data generation model, and inference data such as voice data indicating a voice, text data indicating a text, and image data indicating an image is input thereto. The data generation model infers the input inference data according to the instruction indicated by the prompt, and outputs the inference result in a data format such as voice data and text data. Here, the inference refers to, for example, analysis, classification, prediction, and/or summary.

Furthermore, although the case in which the robot 100 recognizes the user 10 using a face image of the user 10 has been described in the above embodiment, the disclosed technology is not limited to this mode. For example, the robot 100 may recognize the user 10 using a voice uttered by the user 10, a mail address of the user 10, an ID of an SNS of the user 10, an ID card carried by the user 10 in which a wireless IC tag is built, or the like.

The robot 100 is an example of electronic equipment including an action control system. The application target of the action control system is not limited to the robot 100, and the action control system can be applied to various types of electronic equipment. Furthermore, the function of the server 300 may be implemented by one or more computers. At least some functions of the server 300 may be implemented by a virtual machine. Furthermore, at least some functions of the server 300 may be implemented in a cloud.

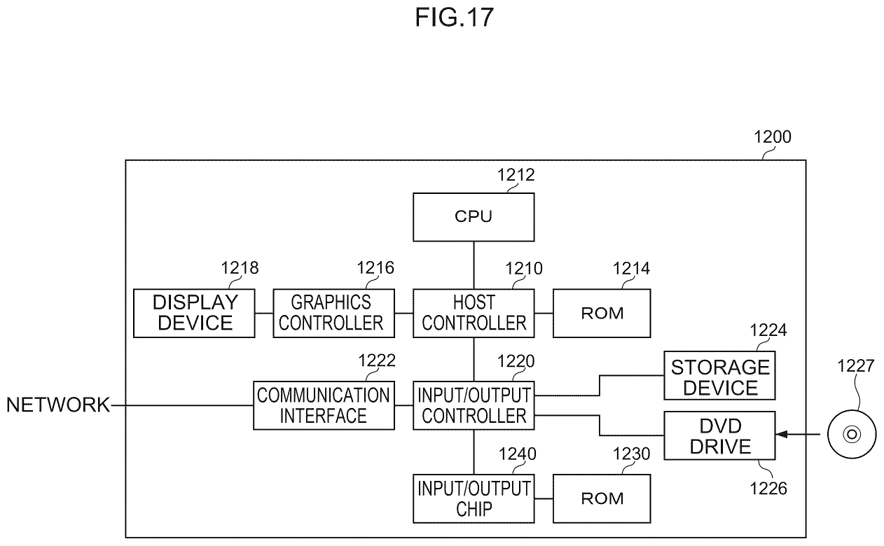

FIG. 17 schematically illustrates an example of a hardware configuration of a computer 1200 functioning as the smartphone 50, the robot 100, the server 300, and the agent systems 500, 700, and 800. A program installed in the computer 1200 can cause the computer 1200 to function as one or more “units” of a device according to the present embodiment, or cause the computer 1200 to execute an operation associated with the device according to the present embodiment or one or more “units” thereof, and/or cause the computer 1200 to execute a process according to the present embodiment or stages of the process. Such programs may be executed by a CPU 1212 to cause the computer 1200 to perform certain operations associated with some or all of the blocks in the flowcharts and block diagrams described in the present specification.

The computer 1200 according to the present embodiment includes the CPU 1212, a RAM 1214, and a graphic controller 1216, which are mutually connected by a host controller 1210. The computer 1200 also includes input/output units such as a communication interface 1222, a storage device 1224, a DVD drive 1226, and an IC card drive, which are connected to the host controller 1210 via an input/output controller 1220. The DVD drive 1226 may be a DVD-ROM drive, a DVD-RAM drive, or the like. The storage device 1224 may be a hard disk drive, a solid state drive, or the like. The computer 1200 also includes a ROM 1230 and legacy input/output units such as a keyboard, which are connected to the input/output controller 1220 via an input/output chip 1240.

The CPU 1212 operates according to programs stored in the ROM 1230 and the RAM 1214, thereby controlling each of the units. The graphics controller 1216 obtains image data generated by the CPU 1212 in a frame buffer or the like provided in the RAM 1214 or itself, and causes the image data to be displayed on a display device 1218.

The communication interface 1222 communicates with other electronic devices via a network. The storage device 1224 stores programs and data used by the CPU 1212 in the computer 1200. The DVD drive 1226 reads a program or data from the DVD-ROM 1227 or the like and provides the program or data to the storage device 1224. The IC card drive reads the program and data from the IC card and/or writes the program and data to the IC card.

The ROM 1230 stores therein a boot program executed by the computer 1200 at the time of activation and/or a program depending on hardware of the computer 1200. The input/output chip 1240 may also connect various input/output units to the input/output controller 1220 via a USB port, a parallel port, a serial port, a keyboard port, a mouse port, or the like.

Programs are provided by a computer-readable storage medium such as the DVD-ROM 1227 or an IC card. The programs are read from a computer-readable storage medium, installed in the storage device 1224, the RAM 1214, or the ROM 1230, which is also an example of a computer-readable storage medium, and executed by the CPU 1212. Information processing described in those programs is read by the computer 1200 and brings about cooperation between the programs and the various types of hardware resources. A device or a method may be configured by implementing an operation or processing of information according to use of the computer 1200.

For example, in a case in which communication is performed between the computer 1200 and an external device, the CPU 1212 may execute a communication program loaded in the RAM 1214 and instruct the communication interface 1222 to perform communication processing based on processing described in the communication program. Under control of the CPU 1212, the communication interface 1222 reads transmission data stored in a transmission buffer area provided in a recording medium such as the RAM 1214, the storage device 1224, the DVD-ROM 1227, or the IC card, transmits the read transmission data to the network, or writes reception data received from the network to a reception buffer area or the like provided on the recording medium.

In addition, the CPU 1212 may cause the RAM 1214 to read all or a necessary portion of a file or database stored in an external recording medium such as the storage device 1224, the DVD drive 1226 (DVD-ROM 1227), an IC card, or the like, and may execute various types of processing on data on the RAM 1214. Next, the CPU 1212 may write back the processed data to the external recording medium.

Various types of information such as various types of programs, data, tables, and databases may be stored in a recording medium and subjected to information processing. The CPU 1212 may execute various types of processing on the data read from the RAM 1214, including various types of operations, information processing, condition determination, conditional branching, unconditional branching, information search/replacement, and the like, which are described throughout the disclosure and specified in command sequences of a program, and writes back the results to the RAM 1214. In addition, the CPU 1212 may search for information in a file, a database, or the like in the recording medium. For example, in a case in which multiple entries each having an attribute value of a first attribute associated with an attribute value of a second attribute are stored in the recording medium, the CPU 1212 may search for an entry with the attribute value of the first attribute matching the specified condition from the multiple entries, read the attribute value of the second attribute stored in the entry, and thereby acquire the attribute value of the second attribute associated with the first attribute satisfying a predetermined condition.

The programs or software modules described above may be stored in a computer-readable storage medium on or near the computer 1200. Furthermore, a recording medium such as a hard disk or a RAM provided in a server system connected to a dedicated communication network or the Internet can be used as a computer-readable storage medium, thereby providing a program to the computer 1200 via the network.

The blocks in the flowcharts and block diagrams in the present embodiment may represent stages of a process in which an operation is performed or “units” of a device that are responsible for performing the operation. Certain stages and “units” may be implemented by a dedicated circuit, a programmable circuit provided with computer-readable instructions stored on a computer-readable storage medium, and/or a processor provided with computer-readable instructions stored on a computer-readable storage medium. The dedicated circuit may include a digital and/or analog hardware circuit, and may include an integrated circuit (IC) and/or a discrete circuit. The programmable circuit may include a reconfigurable hardware circuit including, for example, logical AND, logical OR, exclusive OR, NAND, NOR, and other logical operations, flip-flops, registers, and memory elements, such as a field programmable gate array (FPGA) and a programmable logic array (PLA).

A computer-readable storage medium may include any tangible device capable of storing instructions to be executed by a suitable device, such that a computer-readable storage medium having instructions stored thereon will comprise an article of manufacture including instructions that, when executed, create means for performing the operations specified in the flowcharts or block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-Ray (registered trademark) disk, a memory stick, an integrated circuit card, and the like.

The computer-readable instructions may include any of source codes or object codes written in any combination of one or more programming languages, including assembler instructions, instruction-set-architecture (ISA) instructions, machine instructions, machine-dependent instructions, microcode, firmware instructions, state-setting data, or an object-oriented programming language such as Smalltalk, JAVA (registered trademark), C++, or the like, and conventional procedural programming languages, such as the ‘C’ programming language or similar programming languages.

The computer readable instructions may be provided to processors of general purpose computers, special purpose computers, or other programmable data processing devices, or programmable circuits, either locally or over a wide area network (WAN), such as a local area network (LAN), the Internet, or the like, to cause the processors or programmable circuits of the general purpose computers, special purpose computers, or other programmable data processing devices to execute the computer readable instructions to generate means for the processors or programmable circuits to perform the operations specified in the flowcharts or block diagrams. Examples of the processor include a computer processor, a processing unit, a microprocessor, a digital signal processor, a controller, a microcontroller, and the like.

Although the disclosure has been described with reference to the embodiments above, the technical scope of the disclosure is not limited to the scope described in the embodiments. It is apparent to those skilled in the art that various modifications or improvements can be made to the above embodiments. It is apparent from the description of the claims that a mode to which such modifications or improvements is added can also be included in the technical scope of the disclosure.

It should be noted that the order of execution of each processing such as operations, procedures, steps, and stages in the devices, systems, programs, and methods shown in the claims, the specification, and the drawings can be realized in any order unless “before”, “prior to”, or the like is explicitly stated, and unless the output of the previous processing is used in the later processing. Even if the operation flow in the claims, the specification, and the drawings is described using “first,”, “next,”, and the like for convenience, it does not mean that it is essential to perform in this order.

### Sixth Embodiment

In the autonomous process in the present embodiment, the action determination unit 236 autonomously detects the state of the user 10. For example, the action determination unit 236 autonomously detects a change in the body temperature of the user 10 at every predetermined timing. Specifically, the action determination unit 236 detects a change in the body temperature of the user 10 by comparing the body temperature of the user 10 autonomously measured at every predetermined timing by the temperature sensor with the body temperature of the user 10 measured last time, the average body temperature of the user 10, or the like. Note that a temperature sensor included in the robot 100 may be applied as the temperature sensor, or a temperature sensor included in a device other than the robot 100 may be applied.

Then, the action determination unit 236 determines at least one of the emotion of the user 10 or the emotion of the robot 100 based on the detected state of the user 10.

Then, the action determination unit 236 autonomously determines the surface temperature of the robot 100 according to at least one of the determined emotion of the user 10 or the determined emotion of the robot 100. For example, the action determination unit 236 inputs a text indicating the determined emotion to the action determination model 221. Then, the action determination unit 236 determines the surface temperature output by the action determination model 221 as a surface temperature of the robot 100.

As a result, the user 10 can feel as if the robot 100 is alive. This is because, for example, at various timings such as a case in which the user 10 is taking a nap or traveling with the robot 100, the surface temperature of the robot 100 autonomously changes according to at least one of the state of the user 10 or the state of the robot 100 even if there is no conversation between the user 10 and the robot 100.

The action determination unit 236 uses at least one of the state of the user 10, the emotion of the user 10, the emotion of the robot 100, or the state of the robot 100, together with the action determination model 221 at a predetermined timing, to determine, as the action of the robot 100, any of multiple types of robot actions, including not acting. Here, a case in which a sentence generation model having an interaction function is used as the action determination model 221 will be described as an example.

Specifically, the action determination unit 236 inputs a text representing at least one of the state of the user 10, the emotion of the user 10, the emotion of the robot 100, or the state of the robot 100, together with a text for asking about the robot action to the sentence generation model to determine the action of the robot 100 based on the output of the sentence generation model.

For example, multiple types of the robot actions include the following (1) to (11).
(1) The robot does nothing.
(2) The robot dreams.
(3) The robot speaks to the user. (4) The robot creates a picture diary.
(5) The robot proposes an activity.
(6) The robot suggests a person whom the user should meet.
(7) The robot introduces news that the user is interested in.
(8) The robot edits pictures and videos.
(9) The robot studies with the user.
(10) The robot evokes a memory.
(11) The robot changes the surface temperature.

The action determination unit 236 inputs, to the sentence generation model, a text indicating the state of the user 10 and the state of the robot 100 recognized by the state recognition unit 230, the current emotion value of the user 10 determined by the emotion determination unit 232, and the current emotion value of the robot 100, and a text for asking about any of multiple types of robot actions including not acting every time of a certain period of time elapses, and determines the action of the robot 100 based on the output of the sentence generation model. Here, in a case in which there is no user 10 around the robot 100, the text to be input to the sentence generation model needs not include the state of the user 10 and the current emotion value of the user 10, or may include the fact that there is no user 10.

The sentence generation model receives an input of a text “The robot is in a very pleasant state. The user is normally in a pleasant state. The user is sleeping. Which one of the following
(1) to (11) is better as the action of the robot?
(1) The robot does nothing.
(2) The robot dreams.
(3) The robot speaks to the user.

. . . ” as another example. Based on the output “It can be said that either (1) The robot does nothing or (2) The robot dreams is the most appropriate action” of the sentence generation model, “(1) The robot does nothing” or “(2) The robot dreams” is determined as an action of the robot 100.

The sentence generation model receives an input of a text “The robot is in a slightly sad state. The user is absent. It is dark around the robot. Which one of the following (1) to (11) is better as an action of the robot? (1) The robot does nothing.
(2) The robot dreams.
(3) The robot speaks to the user.

. . . ” as another example. Based on the output “It can be said that either (2) The robot dreams or (4) The robot creates a picture diary is the most appropriate action” of the sentence generation model, “(2) The robot dreams” or “(4) The robot creates a picture diary” is determined as an action of the robot 100.

The action determination unit 236 autonomously detects the state of the user 10 in a case in which it is determined that “(11) The surface temperature of the robot is changed.” as an action of the robot, and changes the surface temperature of the robot 100 in accordance with at least one of the determined emotion of the user 10 or the determined emotion of the robot 100 in a case in which at least one of the emotion of the user 10 or the emotion of the robot 100 is determined based on the detected state of the user 10.

For example, the action determination unit 236 changes the surface temperature of a portion (for example, a hand, the face, or the like) of the robot 100 that the user 10 is likely to touch according to at least one of the determined emotion of the user 10 or the determined emotion of the robot 100. Specifically, in a case in which the robot 100 has the emotion “joy”, the surface temperature of the hand of the robot 100 is increased in comparison to that before the robot 100 has the emotion “joy”. Specifically, in a case in which the robot 100 has the emotion “anger”, the surface temperature of the face of the robot 100 is increased in comparison to that before the robot 100 has the emotion “anger”.

A sixth embodiment will be described with reference to FIG. 15 described above. As in the first embodiment, when an agent functioning as an avatar performs an autonomous process of autonomously acting, the action determination unit 236 of the control unit 228B determines, as an action of the avatar, any of multiple types of avatar actions including not acting, using at least one of the state of the user 10, the emotion of the user 10, the emotion of the avatar, or the state of electronic equipment (for example, the headset-type terminal 820) that controls the avatar, and the action determination model 221, at a predetermined timing.

Specifically, the action determination unit 236 inputs a text representing at least one of the state of the user 10, the state of the electronic equipment, the emotion of the user 10, or the emotion of the avatar, together with a text for inquiry about the action of the avatar to the sentence generation model, and determines the action of the avatar based on the output of the sentence generation model.

In addition, the action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

In particular, it is preferable that, in a case in which a state of the user is autonomously detected and the emotion determination unit 232 determines at least one of the emotion of the user or the emotion of the avatar based on the detected state of the user, the action determination unit 236 determine the surface temperature of the avatar according to at least one of the determined emotion of the user or the determined emotion of the avatar and cause the action control unit 250 to change the display mode representing the surface temperature of the avatar.

In the present embodiment, the action determination unit 236 autonomously detects the state of the user 10. For example, the action determination unit 236 autonomously detects a temperature change of the user 10 at every predetermined timing. Specifically, the action determination unit 236 detects a change in the body temperature of the user 10 by comparing the body temperature of the user 10 autonomously measured at every predetermined timing by the temperature sensor with the body temperature of the user 10 measured last time, the average body temperature of the user 10, or the like. Note that, as the temperature sensor, a temperature sensor included in the headset-type terminal 820 may be applied, or a temperature sensor included in a device other than the headset-type terminal 820 may be applied.

Then, the emotion determination unit 232 determines at least one of the emotion of the user 10 or the emotion of the avatar based on the detected state of the user 10.

Then, the action determination unit 236 autonomously determines the surface temperature of the avatar according to at least one of the emotion of the user 10 or the emotion of the avatar determined by the emotion determination unit 232. Specifically, the action determination unit 236 inputs a text indicating the emotion determined by the emotion determination unit 232 to the action determination model 221. Then, the action determination unit 236 determines the surface temperature output by the action determination model 221 as the surface temperature of the avatar, and causes the action control unit 250 to change the display mode representing the surface temperature of the avatar.

For example, the action determination unit 236 determines the surface temperature of the portion of the avatar (for example, a hand, the face, or the like) that the user 10 is likely to touch according to at least one of the emotion of the user 10 or the emotion of the avatar determined by the emotion determination unit 232. Specifically, in a case in which the avatar has the emotion “joy”, a higher surface temperature of the hand of the avatar than that before the avatar has the emotion “joy” is determined. In addition, in a case in which the avatar has the emotion “anger”, a higher surface temperature of the face of the avatar than that before the avatar has the emotion “anger” is determined.

As a result, the user 10 can feel as if the avatar is alive. This is because, for example, at various timings such as a case in which the user 10 is taking a nap or traveling with the avatar, the display mode representing the surface temperature of the avatar autonomously changes according to at least one of the state of the user 10 or the state of the avatar even if there is no conversation between the user 10 and the avatar.

Note that, in a case in which the emotion determined by the emotion determination unit 236 is a predetermined emotion, the action determination unit 236 may further determine to expand or contract the avatar, and cause the action control unit to change the avatar so as to expand or contract. For example, in a case in which the emotion determination unit 232 determines that the emotion of the avatar is “anger”, the action determination unit 236 may further determine to expand the avatar in accordance with the determined emotion of the avatar. This makes it easier for the user to recognize the emotion of the avatar due to the display mode of the avatar and the expansion of the avatar.

Furthermore, a motion speed of the avatar may be changed according to the surface temperature of the avatar determined by the action determination unit 236. In this case, the action determination unit 236 determines the motion speed of the avatar to be a motion speed determined in advance according to the determined surface temperature of the avatar. For example, the motion speed of the avatar may be made faster as the surface temperature of the avatar gets higher.

With regard to the above embodiments, the following supplementary notes are further disclosed.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and
an action control unit that displays the avatar in an image display area of the electronic equipment,
in which the avatar actions include autonomously changing a display mode representing a surface temperature of the avatar, and
in a case in which a state of the user is autonomously detected and the emotion determination unit determines at least one of an emotion of the user or an emotion of the avatar based on the detected state of the user, the action determination unit determines a surface temperature of the avatar according to at least one of the determined emotion of the user or the determined emotion of the avatar.

### (Supplementary Note 2)

The action control system described in supplementary note 1,
in which the action determination model is a data generation model capable of generating data according to input data, and
the action determination unit inputs data indicating at least one of the user state, the state of the avatar, the emotion of the user, or the emotion of the avatar, together with data for asking about an avatar action to the data generation model, and determines an action of the avatar based on an output of the data generation model.

### (Supplementary Note 3)

The action control system described in supplementary note 1, in which the action determination unit further determines to expand or contract the display mode of the avatar in a case in which the emotion determined by the emotion determination unit is a predetermined emotion, and causes the action control unit to change the display mode of the avatar so as to expand or contract.

### (Supplementary Note 4)

The action control system described in supplementary note 1, in which the action determination unit further determines a motion speed of the avatar to be a motion speed determined in advance according to the determined surface temperature.

### (Supplementary Note 5)

The action control system described in supplementary note 1, in which the electronic equipment is a headset-type terminal.

### (Supplementary Note 6)

The action control system described in supplementary note 1, in which the electronic equipment is an eyeglass-type terminal.

### Seventh Embodiment

In the autonomous process in the embodiment, the action determination unit 236 of the robot 100 spontaneously and periodically detects states of the user. Specifically, one of an action content of the robot 100 acquired using the sentence generation model having an interaction function as the action determination model 221 and an action content determined using an existing reaction rule as the action determination model 221 is selected according to the intensity of the emotions of the robot 100 and the user 10. If the intensity of emotions of the robot 100 and the user 10 is a threshold value or greater, the action determination unit 236 selects the action content determined using the existing reaction rule. As a result, the words and actions uttered by the robot 100 become uniform, and even in a slightly different situation, if the emotion is a certain level or higher, the robot 100 behaves in the same manner, so there is no inconsistency in action thereof.

When determining an action of the robot 100, the action determination unit 236 is configured to select one of an action content to be taken by the robot 100 generated using the sentence generation model as the action determination model 221 and an action content to be taken by the robot 100 determined based on a reaction rule as the action determination model 221 according to the intensity of emotions of the robot 100 and the user 10. At this time, the action determination unit 236 compares the absolute values of the emotion values of the robot 100 and the user with a threshold value, and selects the action content to be taken by the robot 100 determined using the reaction rule if the absolute value is the threshold value or greater. If the emotion values are less than the threshold value, the action determination unit 236 selects the action content to be taken by the robot 100 generated using the sentence generation model. For example, in a case in which the absolute value of the emotion value of the user is the threshold value or greater, or in a case in which the absolute value of the emotion value of the robot 100 is the threshold value or greater, the positive emotion or the negative emotion is strong, and thus the action determination unit 236 determines the action content of the robot 100 using the reaction rule. On the other hand, in a case in which the absolute value of the emotion value of the user is less than the threshold value, or in a case in which the absolute value of the emotion value of the robot 100 is less than the threshold value, the positive emotion or the negative emotion is weak, and thus the action determination unit 236 generates an action to be taken by the robot 100 using the sentence generation model.

Based on the state of the user 10 recognized by the state recognition unit 230, in a case in which an action of the user 10 with respect to the robot 100 is detected in a state where there is no action of the user 10 with respect to the robot 100, the action determination unit 236 reads data stored in the action plan data 224 and determines an action of the robot 100.

A seventh embodiment will be described with reference to FIG. 15 described above. As in the first embodiment, when the agent functioning as the avatar performs an autonomous process of autonomously acting, the action determination unit 236 of the control unit 228B selects any of the action content of the avatar acquired using the action determination model or the action content determined using the existing reaction rule according to the emotion of the user 10 or the intensity of the emotion of the avatar at a predetermined timing.

The action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

In particular, as in the first embodiment, the action determination unit 236 spontaneously and periodically detects states of the user. In addition, the action determination unit 236 selects one of the action content of the avatar acquired using the sentence generation model having an interaction function as the action determination model 221 and an action content determined using the existing reaction rule as the action determination model 221 according to the intensity of the emotions of the avatar and the user 10. If the intensities of the emotion of the avatar and the user 10 are less than a threshold value, the action determination unit 236 uses at least one of the state of the user 10, the emotion of the user 10, the emotion of the avatar, or the state of the electronic equipment (for example, the headset-type terminal 820) that controls the avatar, and the sentence generation model to determine any of multiple types of actions of the avatar including not acting as an action of the avatar.

Specifically, the action determination unit 236 inputs a text representing at least one of the state of the user 10, the state of the electronic equipment, the emotion of the user 10, or the emotion of the avatar, together with a text for asking about the action of the avatar to the sentence generation model as the action determination model 221 to determine the action of the avatar based on the output of the sentence generation model.

If the intensities of the emotions of the avatar and the user 10 are a threshold value or greater, the action determination unit 236 selects the action content determined using the existing reaction rule. As a result, words and actions uttered by the avatar displayed in the image display area of the headset-type terminal 820 by the action control unit 250 become uniform, and even in a slightly different situation, the avatar behaves in a similar manner as long as the emotion is a certain level or higher, so there is no inconsistency in the action of the avatar.

When displaying the avatar, the action control unit 250 may change the expression of the avatar or change the motion of the avatar according to the action content of the avatar. For example, in a case in which the action content of the avatar is based on a pleasant emotion, the expression of the avatar may be changed to an expression of pleasure, or the motion of the avatar may be changed as if the avatar dances happily. Furthermore, the action control unit 250 may transform the avatar in accordance with the action content of the avatar. For example, the action control unit 250 may transform the avatar into an avatar corresponding to the action content, or may transform the avatar into an avatar such as an animal or an object embodying the determined action content.

With regard to the above embodiments, the following supplementary notes are further disclosed.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and
an action control unit that displays the avatar in an image display area of the electronic equipment,
in which the action determination unit selects one of an action content of the avatar generated based on a data generation model capable of generating data according to input data as the action determination model according to an intensity of the emotion of the user or the emotion of the avatar determined by the emotion determination unit, and an action content determined based on a reaction rule for determining an action of the avatar according to the action of the user and the emotion of the user or the emotion of the avatar as the action determination model.

### (Supplementary Note 2)

The action control system described in supplementary note 1, in which the action determination unit selects an action content determined based on the reaction rule in a case in which an emotion value representing the intensity of the emotion is a threshold value or greater, and selects an action content generated based on the data generation model in a case in which the emotion value is less than the threshold value.

### (Supplementary Note 3)

The action control system described in supplementary note 1, in which, in a case in which the action content is selected by using the data generation model, the action determination unit inputs data indicating at least one of the user state, the state of the electronic equipment, the emotion of the user, or the emotion of the avatar, together with data for asking about an avatar action to the data generation model, and determines an action of the avatar based on an output of the data generation model.

### (Supplementary Note 4)

The action control system described in supplementary note 1, in which the electronic equipment is a headset-type terminal.

### (Supplementary Note 5)

The action control system described in supplementary note 1, in which the electronic equipment is an eyeglass-type terminal.

### Eighth Embodiment

In the autonomous process in the embodiment, the action determination unit 236 of the robot 100 spontaneously and periodically detects states of the user. Specifically, the action determination unit 236 calculates the degree of match between the user action, the user emotion, and/or the robot emotion and the condition of the existing reaction rule as the action determination model 221, and selects the action content determined using the existing reaction rule when the degree of match is a threshold value or higher. In a case in which the degree of match is less than the threshold value, the action content determined using the sentence generation model having the interaction function as the action determination model 221 is selected. As a result, the words and actions uttered by the robot 100 become uniform, and even in a slightly different situation, the robot 100 behaves in the same manner, so there is no inconsistency in action thereof.

In the embodiment, when determining an action of the robot 100, the action determination unit 236 calculates the degree of match between the action of the user, the emotion of the user, and/or the emotion of the robot 100 and the condition of the reaction rule as the action determination model 221. Then, in a case in which the degree of match is high, that is, in a case in which the degree of match is the threshold value or higher, the action determination unit 236 selects the action content determined using the reaction rule. Then, in a case in which the degree of match is low, that is, in a case in which the degree of match is less than the threshold value, the action determination unit 236 selects the action content determined using the sentence generation model. Here, the degree of match being the threshold value or higher means that the condition of the reaction rule does not completely match, but the condition matches to such an extent that the condition can be regarded as a match.

An eighth embodiment will be described with reference to FIG. 15 described above. As in the first embodiment, when performing an autonomous process in which an agent functioning as an avatar autonomously acts, the action determination unit 236 of the control unit 228 calculates the degree of match between a user action, a user emotion, and/or an emotion of an avatar and the condition of the existing reaction rule, and selects the action content of the avatar according to the degree of match.

The action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

In particular, as in the first embodiment, the action determination unit 236 spontaneously and periodically detects states of the user. Then, the action determination unit 236 calculates the degree of match between the user action, the user emotion, and/or the emotion of the avatar and the condition of the existing reaction rule as the action determination model 221. If the degree of match is low and less than the threshold value, the action determination unit 236 uses at least one of the state of the user 10, the emotion of the user 10, the emotion of the avatar, or the state of the electronic equipment (for example, the headset-type terminal 820) that controls the avatar, and the sentence generation model to determine any of multiple types of actions of the avatar including not acting as an action of the avatar.

Specifically, the action determination unit 236 inputs a text representing at least one of the state of the user 10, the state of the electronic equipment, the emotion of the user 10, or the emotion of the avatar, together with a text for asking about the action of the avatar to the sentence generation model as the action determination model 221 to determine the action of the avatar based on the output of the sentence generation model.

In a case in which the degree of match is the threshold value or higher, the action determination unit 236 selects an action content determined using the existing reaction rule. As a result, words and actions uttered by the avatar displayed in the image display area of the headset-type terminal 820 by the action control unit 250 become uniform, and even in a slightly different situation, the avatar behaves in a similar manner as long as the emotion is a certain level or higher, so there is no inconsistency in the action of the avatar.

When displaying the avatar, the action control unit 250 may change the expression of the avatar or change the motion of the avatar according to the action content of the avatar. For example, in a case in which the action content of the avatar is based on a pleasant emotion, the expression of the avatar may be changed to an expression of pleasure, or the motion of the avatar may be changed as if the avatar dances happily. Furthermore, the action control unit 250 may transform the avatar in accordance with the action content of the avatar. For example, the action control unit 250 may transform the avatar into an avatar corresponding to the action content, or may transform the avatar into an avatar such as an animal or an object embodying the determined action content.

With regard to the above embodiments, the following supplementary notes are further disclosed.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and
an action control unit that displays the avatar in an image display area of the electronic equipment,
in which the action determination unit calculates the degree of match between the action of the user, the emotion of the user and/or the emotion of the avatar and a condition of a reaction rule for determining an action of the avatar according to the action of the user, the emotion of the user and/or the emotion of the avatar, selects an action content determined using the reaction rule in a case in which the degree of match is the threshold value or higher, and selects an action content determined using a data generation model capable of generating data according to input data as the action determination model in a case in which the degree of match is less than the threshold value.

### (Supplementary Note 2)

The action control system described in supplementary note 1, in which, in a case in which the action content is selected by using the data generation model, the action determination unit inputs data indicating at least one of the user state, the state of the electronic equipment, the emotion of the user, or the emotion of the avatar, together with data for asking about an avatar action to the data generation model, and determines an action of the avatar based on an output of the data generation model.

### (Supplementary Note 3)

The action control system described in supplementary note 1, in which the electronic equipment is a headset-type terminal.

### (Supplementary Note 4)

The action control system described in supplementary note 1, in which the electronic equipment is an eyeglass-type terminal.

### Ninth Embodiment

In the autonomous process in the embodiment, the robot 100 spontaneously and periodically detects states of the user 10. Specifically, the robot 100 spontaneously and periodically detects actions of the user 10, emotions of the user 10, and emotions of the robot 100, adds a fixed sentence inquiring about a gesture to be taken by the robot 100 to a text representing a state of the user 10, inputs the text to the sentence generation model, and acquires the gesture of the robot 100. The gesture is acquired and stored, and the stored gesture is activated at another timing, for example. As a result, the robot 100 spontaneously detects a state of the user 10, determines a gesture of the robot 100 in advance, and when there is a certain trigger for the user 10 next time, the robot 100 itself can perform the gesture. Specifically, the robot 100 spontaneously and periodically detects actions of the user 10, emotions of the user 10, and emotions of the robot 100, adds a fixed sentence inquiring about an uttered content to be taken by the robot 100 to a text representing a state of the user 10, inputs the text to the sentence generation model, and acquires the uttered content of the robot 100. The uttered content is acquired and stored, and the stored uttered content is activated at another timing, for example. As a result, the robot 100 spontaneously detects a state of the user 10, determines an uttered content of the robot 100 in advance, and when there is a certain trigger for the user 10 next time, the robot 100 itself can utter the uttered content. Note that the robot 100 may perform only a gesture, may perform only utterance, or may perform utterance together with a gesture when there is a certain trigger.

Specifically, the action determination unit 236 inputs a text representing at least one of the state of the user 10, the emotion of the user 10, the emotion of the robot 100, or the state of the robot 100, together with a text for asking about the robot action to the sentence generation model to determine the action of the robot 100 based on the output of the sentence generation model.

For example, multiple types of the robot actions include the following (1) to (11).
(1) The robot does nothing.
(2) The robot dreams.
(3) The robot speaks to the user.
(4) The robot creates a picture diary.
(5) The robot proposes an activity.
(6) The robot proposes a person whom the user should meet.
(7) The robot introduces news that the user is interested in.
(8) The robot edits pictures and videos.
(9) The robot studies with the user.
(10) The robot evokes a memory.
(11) An action plan of the robot is determined in advance.

The action determination unit 236 inputs, to the sentence generation model, a text indicating the state of the user 10 and the state of the robot 100 recognized by the state recognition unit 230, the current emotion value of the user 10 determined by the emotion determination unit 232, and the current emotion value of the robot 100, and a text for asking about any of multiple types of robot actions including not acting every time of a certain period of time elapses, and determines the action of the robot 100 based on the output of the sentence generation model. Here, in a case in which there is no user 10 around the robot 100, the text to be input to the sentence generation model needs not include the state of the user 10 and the current emotion value of the user 10, or may include the fact that there is no user 10.

The sentence generation model receives an input of a text “The robot is in a very pleasant state. The user is normally in a pleasant state. The user is sleeping. Which one of the following
(1) to (11) is better as the action of the robot?
(1) The robot does nothing.
(2) The robot dreams.
(3) The robot speaks to the user.

. . . ” as another example. Based on the output “It can be said that either (1) The robot does nothing or (2) The robot dreams is the most appropriate action” of the sentence generation model, “(1) The robot does nothing” or “(2) The robot dreams” is determined as an action of the robot 100.

The sentence generation model receives an input of a text “The robot is in a slightly sad state. The user is absent. It is dark around the robot. Which one of the following (1) to (11) is better as an action of the robot? (1) The robot does nothing.
(2) The robot dreams.
(3) The robot speaks to the user.

. . . ” as another example. Based on the output “It can be said that either (2) The robot dreams or (4) The robot creates a picture diary is the most appropriate action” of the sentence generation model, “(2) The robot dreams” or “(4) The robot creates a picture diary” is determined as an action of the robot 100.

In a case in which it is determined that “(11) An action plan of the robot is determined.”, for example, a gesture of the robot 100 is determined in advance, as a robot action, the action determination unit 236 determines an activation condition for activating the gesture and stores the determined activation condition in the action plan data 224. In a case in which there are multiple gestures, activation conditions for activating each gesture are determined and stored in the action plan data 224.

Specifically, a text representing the state of the user 10 and the state of the robot 100 recognized by the state recognition unit 230, the current emotion value of the user 10 determined by the emotion determination unit 232, the current emotion value of the robot 100, and the history data 222, and a text for asking about the robot action (gesture) to be performed later and the activation condition are input to the sentence generation model, and the activation condition for activating the gesture is determined based on the output of the sentence generation model. Here, the activation condition is, for example, that the user 10 is detected.

In a case in which the activation condition of the action plan data 224 is satisfied, the action determination unit 236 determines, as an action of the robot 100, execution of the gesture that satisfies the activation condition.

For example, in a case in which it is determined to preset the utterance content of the robot 100 as a robot action, the action determination unit 236 determines an activation condition for uttering the utterance content and stores the determined activation condition in the action plan data 224. In a case in which there are multiple utterance contents, an activation condition for uttering each utterance content is determined and stored in the action plan data 224.

Specifically, a text representing the state of the user 10 and the state of the robot 100 recognized by the state recognition unit 230, the current emotion value of the user 10 determined by the emotion determination unit 232, the current emotion value of the robot 100, and the history data 222, and a text for asking about the robot action (utterance) to be performed later and the activation condition are input to the sentence generation model, and the activation condition for uttering the utterance content is determined based on the output of the sentence generation model. Here, the activation condition is, for example, that the user 10 is detected.

In a case in which the activation condition of the action plan data 224 is satisfied, the action determination unit 236 determines, as an action of the robot 100, utterance of the utterance content that satisfies the activation condition.

A ninth embodiment will be described with reference to FIG. 15 described above. In the embodiment, the control unit 228B has the functions of determining an action of the avatar and generating display of the avatar to be presented to the user through the headset-type terminal 820.

As in the first embodiment, the emotion determination unit 232 of the control unit 228B determines an emotion value of the agent based on the state of the headset-type terminal 820, and substitutes the emotion value as an emotion value of the avatar.

As in the first embodiment, when an agent functioning as an avatar performs an autonomous process of autonomously acting, the action determination unit 236 of the control unit 228B determines, as an action of the avatar, any of multiple types of avatar actions including not acting, using at least one of the state of the user 10, the emotion of the user 10, the emotion of the avatar, or the state of electronic equipment (for example, the headset-type terminal 820) that controls the avatar, and the action determination model 221, at a predetermined timing.

Specifically, the action determination unit 236 inputs a text representing at least one of the state of the user 10, the state of the electronic equipment, the emotion of the user 10, or the emotion of the avatar, together with a text for inquiry about the action of the avatar to the sentence generation model, and determines the action of the avatar based on the output of the sentence generation model.

In addition, the action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

In a case in which it is determined, as an avatar action, that “(11) An action content of the avatar is determined in advance.”, for example, to determine in advance a gesture of the avatar, the action determination unit 236 determines an activation condition for activating the gesture and stores the determined activation condition in the action plan data 224. In a case in which there are multiple gestures, activation conditions for activating each gesture are determined and stored in the action plan data 224.

Specifically, a text representing the state of the user 10 and the state of the headset-type terminal 820 recognized by the state recognition unit 230, the current emotion value of the user 10 determined by the emotion determination unit 232, the current emotion value of the avatar, and the history data 222, and a text for asking about the avatar action (gesture) to be performed later and the activation condition are input to the sentence generation model, and the activation condition for activating the gesture is determined based on the output of the sentence generation model. Here, the activation condition is, for example, that the headset-type terminal 820 should be worn by the user 10. Furthermore, in a case in which the headset-type terminal 820 is not worn by the user 10, the text to be input to the sentence generation model may not include the state of the user 10 and the current emotion value of the user 10, or may include the fact that there is no user 10.

In a case in which the activation condition of the action plan data 224 is satisfied, the action determination unit 236 determines, as an action of the avatar, execution of the gesture that satisfies the activation condition.

Furthermore, for example, in a case in which it is determined to preset the utterance content of the avatar as an action of the avatar, the action determination unit 236 determines the activation condition for activating the utterance content and stores the determined activation condition in the action plan data 224. In a case in which there are multiple utterance contents, an activation condition for uttering each utterance content is determined and stored in the action plan data 224.

Specifically, a text representing the state of the user 10 and the state of the headset-type terminal 820 recognized by the state recognition unit 230, the current emotion value of the user 10 determined by the emotion determination unit 232, the current emotion value of the avatar, and the history data 222, and a text for asking about the action of the avatar (utterance) to be performed later and the activation condition are input to the sentence generation model, and the activation condition for activating the gesture is determined based on the output of the sentence generation model. Here, the activation condition is, for example, that the headset-type terminal 820 should be worn by the user 10. Furthermore, in a case in which the headset-type terminal 820 is not worn by the user 10, the text to be input to the sentence generation model may not include the state of the user 10 and the current emotion value of the user 10, or may include the fact that there is no user 10.

In a case in which the activation condition of the action plan data 224 is satisfied, the action determination unit 236 determines, as an action of the avatar, utterance of the utterance content that satisfies the activation condition.

Note that, in a case in which the activation condition of the action plan data 224 is satisfied, the action determination unit 236 may determine, as an action of the avatar, execution of a gesture and an utterance that satisfy the activation condition.

In a case in which an action of the user 10 with respect to the avatar is detected from a state in which there is no action of the user 10 with respect to the avatar based on the state of the user 10 recognized by the state recognition unit 230, the action determination unit 236 reads data stored in the action plan data 224 and determines an action of the avatar.

For example, in a case in which the headset-type terminal 820 is not worn by the user 10, when it is detected that the headset-type terminal 820 is worn by the user 10, the action determination unit 236 reads data stored in the action plan data 224 and determines the action of the avatar. Furthermore, in a case in which the user 10 is sleeping, when it is detected that the user 10 woke up and the headset-type terminal 820 is worn by the user 10, the action determination unit 236 reads data stored in the action plan data 224 and determines the action of the avatar.

With regard to the above embodiments, the following supplementary notes are further disclosed.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and
an action control unit that displays the avatar in an image display area of the electronic equipment,
in which the avatar actions include determining, in advance, a gesture of the avatar, and
the action determination unit determines an activation condition for activating the gesture and stores the activation condition in action plan data in a case in which it is determined to set a gesture of the avatar in advance as an action of the avatar, and
determines to cause the avatar to execute the gesture in a case in which the activation condition of the action plan data is satisfied.

### (Supplementary Note 2)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and
an action control unit that displays the avatar in an image display area of the electronic equipment,
in which the avatar actions include determining, in advance, an utterance content of the avatar, and
the action determination unit determines an activation condition for uttering the utterance content and stores the activation condition in action plan data in a case in which it is determined to set an utterance content of the avatar in advance as an action of the avatar, and
determines to cause the avatar to utter the utterance content in a case in which the activation condition of the action plan data is satisfied.

### (Supplementary Note 3)

The action control system described in supplementary note 1,
in which the action determination model is a data generation model capable of generating data according to input data, and
the action determination unit inputs data indicating at least one of the user state, the state of the electronic equipment, the emotion of the user, or the emotion of the avatar, together with data for asking about an avatar action to the data generation model, and determines an action of the avatar based on an output of the data generation model.

### (Supplementary Note 4)

The action control system described in supplementary note 1, in which the electronic equipment is a headset-type terminal.

### (Supplementary Note 5)

The action control system described in supplementary note 1, in which the electronic equipment is an eyeglass-type terminal.

### Tenth Embodiment

In the autonomous process in the embodiment, the action determination unit 236 outputs an emotion of the user 10 determined from an action of the user 10 and an emotion of the robot 100 determined by the emotion determination unit 232 in a text file. In this case, the action determination unit 236 adds a fixed sentence expressed by predetermined words for asking about an action to be taken by the robot 100, such as “What action should the robot take at this time?”, to a text file expressing the emotion of the user 10 and the emotion of the robot 100 in characters.

The action determination unit 236 inputs the text file to which the fixed sentence has been added and the image of the user 10 (hereinafter, referred to as a “user image”) captured by the 2D camera 203 to the sentence generation model. The user image includes a gesture of the user, that is, a motion of the user or an expression of the user.

As a result, an action to be taken by the robot 100 determined based on the emotion of the user 10, the emotion of the robot 100, and the information obtained from the user image is obtained as an answer from the sentence generation model. Note that the sentence generation model can receive inputs not only as characters but also as images, and the input images can also be used as reference information for determining an action to be taken by the robot 100.

The action determination unit 236 determines an action of the robot 100 according to the content of the answer obtained from the sentence generation model.

The action determination unit 236 uses at least one of the state of the user 10, the emotion of the user 10, the emotion of the robot 100, or the state of the robot 100, together with the user image, and the action determination model 221 at a predetermined timing, to determine, as an action of the robot 100, any of multiple types of robot actions, including not acting. Here, a case in which a sentence generation model having an interaction function is used as the action determination model 221 will be described as an example.

Specifically, the action determination unit 236 inputs a text representing at least one of the state of the user 10, the emotion of the user 10, the emotion of the robot 100, or the state of the robot 100, together with the user image and a text for asking about the robot action to the sentence generation model to determine an action of the robot 100 based on the output of the sentence generation model.

For example, multiple types of the robot actions include the following (1) to (11).
(1) The robot does nothing.
(2) The robot dreams.
(3) The robot speaks to the user.
(4) The robot creates a picture diary.
(5) The robot proposes an activity.
(6) The robot proposes a person whom the user should meet.
(7) The robot introduces news that the user is interested in.
(8) The robot edits pictures and videos.
(9) The robot studies with the user.
(10) The robot evokes a memory.
(11) The robot asks about the meaning of an action of the user.

The action determination unit 236 inputs a user image, a text indicating the current emotion value of the user 10 determined by the emotion determination unit 232 and the current emotion value of the robot 100, and a text for asking about any of the multiple types of robot actions including not acting to the sentence generation model at every passage of a certain period of time to determine an action of the robot 100 based on the output of the sentence generation model. Here, in a case in which there is no user 10 around the robot 100, the text to be input to the sentence generation model needs not include the state of the user 10 and the current emotion value of the user 10, or may include the fact that there is no user 10.

The sentence generation model receives an input of a text “The robot is in a very pleasant state. The user is normally in a pleasant state. The user is sleeping. Which one of the following
(1) to (11) is better as the action of the robot?
(1) The robot does nothing.
(2) The robot dreams.
(3) The robot speaks to the user.

. . . ” as another example. Based on the output “It can be said that either (1) The robot does nothing or (2) The robot dreams is the most appropriate action” of the sentence generation model, “(1) The robot does nothing” or “(2) The robot dreams” is determined as an action of the robot 100.

The sentence generation model receives an input of a text “The robot is in a slightly sad state. The user is absent. It is dark around the robot. Which one of the following (1) to (11) is better as an action of the robot? (1) The robot does nothing.
(2) The robot dreams.
(3) The robot speaks to the user.

. . . ” as another example. Based on the output “It can be said that either (2) The robot dreams or (4) The robot creates a picture diary is the most appropriate action” of the sentence generation model, “(2) The robot dreams” or “(4) The robot creates a picture diary” is determined as an action of the robot 100.

In a case in which it is determined that, as a robot action, the robot 100 should utter “(11)

The robot asks about the meaning of the motion of the user”, that is, the robot 100 should utter about the motion of the user 10 represented by the user image, the action determination unit 236 uses the sentence generation model to determine the emotion of the user 10, the emotion of the robot 100, and the utterance content of the robot 100 to ask about the motion of the user 10 represented by the user image. For example, the robot 100 asks the user 10 a question such as “What does the motion of your hand represent?”. At this time, the action control unit 250 causes a speaker included in the control target 252C to output a voice representing the determined utterance content of the robot 100. Note that, in a case in which the user 10 is absent around the robot 100, the action control unit 250 stores the determined utterance content of the robot 100 in the action plan data 224 without outputting a voice representing the determined utterance content of the robot 100.

A tenth embodiment will be described with reference to FIG. 15 described above. In the embodiment, the control unit 228B has the functions of determining an action of the avatar and generating display of the avatar to be presented to the user through the headset-type terminal 820.

As in the first embodiment, the emotion determination unit 232 of the control unit 228B determines an emotion value of the agent based on the state of the headset-type terminal 820 to be substituted for an emotion value of the avatar.

As in the first embodiment, when an agent functioning as an avatar performs an autonomous process of autonomously acting, the action determination unit 236 of the control unit 228B determines, as an action of the avatar, any of multiple types of avatar actions including not acting, using at least one of the state of the user 10, the emotion of the user 10, the emotion of the avatar, or the state of electronic equipment (for example, the headset-type terminal 820) that controls the avatar, and the action determination model 221, at a predetermined timing.

Specifically, the action determination unit 236 inputs a text representing at least one of the state of the user 10, the state of the electronic equipment, the emotion of the user 10, or the emotion of the avatar, together with a text for inquiry about the action of the avatar to the sentence generation model, and determines the action of the avatar based on the output of the sentence generation model.

In addition, the action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

The action determination unit 236 outputs the emotion of the user 10 determined from the action of the user 10 and the emotion of the avatar determined by the emotion determination unit 232 in a text file. In this case, the action determination unit 236 adds a fixed sentence expressed by predetermined words for asking about an action to be taken by the avatar, such as “What action should the avatar take at this time?”, to the text file expressing the emotion of the user 10 and the emotion of the avatar in characters.

The action determination unit 236 inputs the text file to which the fixed sentence has been added and the user image captured by the 2D camera 203 to the sentence generation model. The user image includes a gesture of the user 10, that is, a motion of the user 10 or an expression of the user 10.

As a result, an action to be taken by the avatar determined based on the emotion of the user 10, the emotion of the avatar, and the information obtained from the user image is obtained as an answer from the sentence generation model. Note that the sentence generation model can receive inputs not only as text but also as images, and the input images can also be used as reference information for determining an action to be taken by the avatar.

The action determination unit 236 determines the action of the avatar according to the content of the answer obtained from the sentence generation model.

Furthermore, the action control unit 250 operates the avatar according to the determined action of the avatar, and displays the avatar in the image display area of the headset-type terminal 820 as the control target 252C. Furthermore, in a case in which the determined action of the avatar includes the utterance content of the avatar, the action control unit 250 outputs the utterance content of the avatar by voice through a speaker as the control target 252C.

In particular, in a case in which the action determination unit 236 determines to give utterance regarding a motion of the user 10 as an action of the avatar, it is preferable to cause the action control unit 250 to operate the avatar so as to make a question regarding the motion of the user 10. For example, in a case in which the user 10 performs a motion of playing catch as a result of sensing by the sensor unit 200B, the action determination unit 236 uses an output from the sentence generation model to determine to ask a question such as “Which team do you like?” or a question about baseball such as “Were you in the baseball club?” through the avatar. In this case, the action determination unit 236 may acquire information regarding a favorite player of the user 10 with reference to the collected data 223, change the avatar into the uniform appearance of the favorite player or the mascot character of the favorite team, and then ask a question. In a case in which the user 10 does not have a favorite player or team, the action determination unit 236 may determine to change the avatar into, for example, the uniform appearance of a famous professional baseball player or a mascot character of the Japanese representative baseball team. Furthermore, in a case in which the action determination unit 236 determines to ask a question about baseball through the avatar, the background of the avatar may be switched to a video of the ground of a baseball park.

Note that the avatar does not necessarily have to look like a human, and may be an animal or an article. For example, in a case in which the user 10 performs a motion of playing the guitar, the action determination unit 236 may ask a question such as “What model of guitar do you have?” using the output from the document generation model, and in a case in which there is the answer of a specific model name from the user 10, the appearance of the avatar is changed into the guitar represented by the model name or a famous guitarist playing the guitar to ask subsequent questions. Furthermore, for example, in a case in which the user 10 performs a motion of stroking a pet cat, the action determination unit 236 may ask a question such as “What's the cat's name?” using an output from the document generation model, and change the avatar into the same kind of cat for the cat that the user 10 is stroking.

With regard to the above embodiments, the following supplementary notes are further disclosed.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with a user image obtained by capturing the user and an action determination model at a predetermined timing to determine any of multiple types of avatar actions including not acting as an action of the avatar; and
an action control unit that displays the avatar in an image display area of the electronic equipment,
in which the avatar actions include an action for a motion of the user represented in the user image, and
the action determination unit determines to ask about the motion of the user in a case in which it is determined to give utterance about the motion of the user as an action of the avatar.

### (Supplementary Note 2)

The action control system described in supplementary note 1,
in which the action determination model is a data generation model capable of generating data according to input data, and
the action determination unit inputs data indicating at least one of the user state, the state of the electronic equipment, the emotion of the user, or the emotion of the avatar, together with the user image and data for asking about an avatar action to the data generation model, and determines an action of the avatar based on an output of the data generation model.

### (Supplementary Note 3)

The action control system described in supplementary note 1, in which, in a case in which it is determined to give utterance regarding the motion of the user as an action of the avatar, the action determination unit changes the appearance of the avatar into an appearance attracting interest of the user and then causes the avatar to operate to ask a question.

### (Supplementary Note 4)

The action control system described in supplementary note 1, in which the electronic equipment is a headset-type terminal.

### (Supplementary Note 5)

The action control system described in supplementary note 1, in which the electronic equipment is an eyeglass-type terminal.

### Eleventh Embodiment

In the autonomous process in the embodiment, the action determination unit 236 outputs an action of the user 10 stored in the history data 222, an emotion of the user 10 determined from an action of the user 10, and an emotion of the robot 100 determined by the emotion determination unit 232 in a text file. In this case, the action determination unit 236 adds a fixed sentence expressed by predetermined words for asking about an action to be taken by the robot 100, such as “What action should the robot take at this time?”, to a text file expressing the action of the user 10, the emotion of the user 10, and the emotion of the robot 100 in characters.

The action determination unit 236 inputs the text file to which the fixed sentence has been added and an image of the environment surrounding the user 10 (hereinafter, referred to as a “user surrounding image”) captured by the 2D camera 203 to the sentence generation model. The user surrounding image includes, for example, at least one of a scene, a person, or a situation around the user 10, such as a building standing in a place where the user 10 is, a state of people passing around the user 10, and information regarding the photographing time.

As a result, an action to be taken by the robot 100 determined based on the action of the user 10, the emotion of the user 10, the emotion of the robot 100, and the information obtained from the user surrounding image is obtained as an answer from the sentence generation model. Note that the sentence generation model can receive inputs not only as characters but also as images, and the input images can also be used as reference information for determining an action to be taken by the robot 100. Note that the user 10 may be included in the user surrounding image.

The action determination unit 236 determines an action of the robot 100 according to the content of the answer obtained from the sentence generation model.

The action determination unit 236 uses at least one of the state of the user 10, the emotion of the user 10, the emotion of the robot 100, or the state of the robot 100, together with the user surrounding image and the action determination model 221 at a predetermined timing, to determine, as an action of the robot 100, any of multiple types of robot actions, including not acting. Here, a case in which a sentence generation model having an interaction function is used as the action determination model 221 will be described as an example.

Specifically, the action determination unit 236 inputs a text representing at least one of the state of the user 10, the emotion of the user 10, the emotion of the robot 100, or the state of the robot 100, together with the user surrounding image and a text for asking about the robot action to the sentence generation model to determine an action of the robot 100 based on the output of the sentence generation model.

For example, multiple types of the robot actions include the following (1) to (11).
(1) The robot does nothing.
(2) The robot dreams.
(3) The robot speaks to the user.
(4) The robot creates a picture diary.
(5) The robot proposes an activity.
(6) The robot proposes a person whom the user should meet.
(7) The robot introduces news that the user is interested in.
(8) The robot edits pictures and videos.
(9) The robot studies with the user.
(10) The robot evokes a memory.
(11) The robot asks about the meaning of an action of the user.

The action determination unit 236 inputs the user surrounding image, a text indicating the current emotion value of the user 10 determined by the emotion determination unit 232 and the current emotion value of the robot 100, and a text for asking about any of the multiple types of robot actions including not acting to the sentence generation model at every passage of a certain period of time to determine an action of the robot 100 based on the output of the sentence generation model. Here, in a case in which there is no user 10 around the robot 100, the text to be input to the sentence generation model need not include the state of the user 10 and the current emotion value of the user 10, or may include the fact that there is no user 10.

The sentence generation model receives an input of a text “The robot is in a very pleasant state. The user is normally in a pleasant state. The user is sleeping. Which one of the following
(1) to (11) is better as the action of the robot?
(1) The robot does nothing.
(2) The robot dreams.
(3) The robot speaks to the user.

. . . ” as another example. Based on the output “It can be said that either (1) The robot does nothing or (2) The robot dreams is the most appropriate action” of the sentence generation model, “(1) The robot does nothing” or “(2) The robot dreams” is determined as an action of the robot 100.

The sentence generation model receives an input of a text “The robot is in a slightly sad state. The user is absent. It is dark around the robot. Which one of the following (1) to (11) is better as an action of the robot? (1) The robot does nothing.
(2) The robot dreams.
(3) The robot speaks to the user.

. . . ” as another example. Based on the output “It can be said that either (2) The robot dreams or (4) The robot creates a picture diary is the most appropriate action” of the sentence generation model, “(2) The robot dreams” or “(4) The robot creates a picture diary” is determined as an action of the robot 100.

In a case in which it is determined that, as a robot action, the robot 100 should utter “(11)

The robot asks about the meaning of the motion of the user”, that is, the robot 100 should utter about the motion of the user 10 represented by the user surrounding image, the action determination unit 236 uses the document generation model to determine the utterance content of the robot 100 to ask about the motion of the user 10 represented by the emotion of the user 10, the emotion of the robot 100, and the user surrounding image. For example, the robot 100 asks the user 10 a question such as “What does the motion of your hand represent?”. At this time, the action control unit 250 causes a speaker included in the control target 252C to output a voice representing the determined utterance content of the robot 100. Note that, in a case in which the user 10 is absent around the robot 100, the action control unit 250 stores the determined utterance content of the robot 100 in the action plan data 224 without outputting a voice representing the determined utterance content of the robot 100.

An eleventh embodiment will be described with reference to FIG. 15 described above. In the embodiment, the control unit 228B has the functions of determining an action of the avatar and generating display of the avatar to be presented to the user through the headset-type terminal 820.

As in the first embodiment, the emotion determination unit 232 of the control unit 228B determines an emotion value of the agent based on the state of the headset-type terminal 820 to be substituted for an emotion value of the avatar.

As in the first embodiment, when an agent functioning as an avatar performs an autonomous process of autonomously acting, the action determination unit 236 of the control unit 228B determines, as an action of the avatar, any of multiple types of avatar actions including not acting, using at least one of the state of the user 10, the emotion of the user 10, the emotion of the avatar, or the state of electronic equipment (for example, the headset-type terminal 820) that controls the avatar, and the action determination model 221, at a predetermined timing.

Specifically, the action determination unit 236 inputs a text representing at least one of the state of the user 10, the state of the electronic equipment, the emotion of the user 10, or the emotion of the avatar, together with a text for inquiry about the action of the avatar to the sentence generation model, and determines the action of the avatar based on the output of the sentence generation model.

In addition, the action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

The action determination unit 236 outputs the action of the user 10, the emotion of the user 10 determined from the action of the user 10, and the emotion of the avatar determined by the emotion determination unit 232 in a text file. In this case, the action determination unit 236 adds a fixed sentence expressed by predetermined words for asking about an action to be taken by the avatar, for example, “What action should the avatar take at this time?”, to the text file expressing the action of the user 10, the emotion of the user 10, and the emotion of the avatar in characters.

The action determination unit 236 inputs the text file to which the fixed sentence has been added and the user surrounding image captured by the 2D camera 203 to the sentence generation model.

As a result, an action to be taken by the avatar determined based on the action of the user 10, the emotion of the user 10, the emotion of the avatar, and the information obtained from the user surrounding image is obtained as an answer from the sentence generation model. Note that the sentence generation model can receive inputs not only as characters but also as images, and the input images can also be used as reference information for determining an action to be taken by the avatar.

The action determination unit 236 determines the action of the avatar according to the content of the answer obtained from the sentence generation model.

Furthermore, the action control unit 250 operates the avatar according to the determined action of the avatar, and displays the avatar in the image display area of the headset-type terminal 820 as the control target 252C. Furthermore, in a case in which the determined action of the avatar includes the utterance content of the avatar, the action control unit 250 outputs the utterance content of the avatar by voice through a speaker as the control target 252C.

In particular, in a case in which the action determination unit 236 determines to perform an action related to a place where the user 10 represented by the user surrounding image is as an action of the avatar, the action determination unit 236 determines to utter a topic about the place where the user 10 is. For example, the action determination unit 236 determines that the avatar provides a topic about the place where the user 10 is, such as “The sunset here is beautiful”. The utterance content of the avatar determined by the action determination unit 236 may be a topic related to the risk or the weather of the place where the user 10 is. At this time, the action control unit 250 causes a speaker included in the control target 252C to output a voice representing the determined utterance content of the robot.

Furthermore, the action determination unit 236 may cause the action control unit 250 to display an old landscape of the place where the user 10 is in the image display area of the headset-type terminal 820, and may determine to cause an avatar wearing a costume of the time to tell an event of the past that has occurred in the place where the user 10 is or reproduce the event of the past. For example, in a case in which the place where the user 10 is a birth house of a famous person, the action determination unit 236 determines, as an action of the avatar, an action of recounting an anecdote that reveals the achievement or the personality of the famous person. Furthermore, for example, in a case in which the place where the user 10 is an occurrence place of a certain incident, the action determination unit 236 determines an action of recounting the outline of the incident as an action of the avatar.

Furthermore, in a case in which the place where the user 10 is a place where the user has visited together with his/her family in the past, the action determination unit 236 makes a determination to change the appearance of the avatar into the appearance of the user 10's family, and determines an action of recounting memories with his/her family in the place as an action of the avatar.

Note that the avatar does not necessarily have to look like a human, and may be an animal or an article. For example, in a case in which a vehicle is approaching the place where the user 10 is, the avatar of the vehicle may be displayed in the image display area of the headset-type terminal 820, and the avatar of the vehicle may be moved in accordance with the actual moving speed and direction of the vehicle.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with a user surrounding image obtained by capturing an environment surrounding the user and an action determination model at a predetermined timing to determine any of multiple types of avatar actions including not acting as an action of the avatar;
a memory control unit that stores event data including an emotion value determined by the emotion determination unit and data including the action of the user in history data; and
an action control unit that displays the avatar in an image display area of the electronic equipment,
in which the avatar actions include an action related to a place where the user represented by the user surrounding image is, and
the action determination unit determines to utter a topic about the place where the user is in a case in which it is determined to utter the place where the user is as an action of the avatar.

### (Supplementary Note 2)

The action control system described in supplementary note 1,
in which the action determination model is a data generation model capable of generating data according to input data, and
the action determination unit inputs data indicating at least one of the user state, the state of the electronic equipment, the emotion of the user, or the emotion of the avatar, together with the user surrounding image and data for asking about an avatar action to the data generation model, and determines an action of the avatar based on an output of the data generation model.

### (Supplementary Note 3)

The action control system described in supplementary note 1, in which, in a case in which it is determined to utter the topic about the place where the user is as an action of the avatar, the action determination unit causes the avatar to recount the history of the place where the user is.

### (Supplementary Note 4)

The action control system described in supplementary note 1, in which the electronic equipment is a headset-type terminal.

### (Supplementary Note 5)

The action control system described in supplementary note 1, in which the electronic equipment is an eyeglass-type terminal.

### Twelfth Embodiment

A twelfth embodiment will be described with reference to FIG. 15 described above. In the embodiment, the control unit 228B has the functions of determining an action of the avatar and generating display of the avatar to be presented to the user through the headset-type terminal 820.

As in the first embodiment, the emotion determination unit 232 of the control unit 228B determines an emotion value of the agent based on the state of the headset-type terminal 820, and substitutes the emotion value as an emotion value of the avatar.

As in the first embodiment, when an agent functioning as an avatar performs an autonomous process of autonomously acting, the action determination unit 236 of the control unit 228B determines, as an action of the avatar, any of multiple types of avatar actions including not acting, using at least one of the state of the user 10, the emotion of the user 10, the emotion of the avatar, or the state of electronic equipment (for example, the headset-type terminal 820) that controls the avatar, and the action determination model 221, at a predetermined timing.

Specifically, the action determination unit 236 inputs a text representing at least one of the state of the user 10, the state of the electronic equipment, the emotion of the user 10, or the emotion of the avatar, together with a text for inquiry about the action of the avatar to the sentence generation model, and determines the action of the avatar based on the output of the sentence generation model.

In addition, the action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

In particular, in a case in which the action determination unit 236 determines to execute a structure based on backchanneling as an action of the avatar, it is preferable to set backchanneling associated with an emotion value of the avatar in a conversation up to at least one previous the utterance for the time from the start of sentence generation by the sentence generation model to the utterance by the avatar, and cause the action control unit 250 to control the avatar to execute the action based on the backchanneling.

Specifically, the action determination unit 236 sets backchanneling that the avatar is likely to perform in accordance with the user's preference, the user's situation, and the user's reaction according to the following steps 1 to 5-2, and causes the avatar to execute an action based on the backchanneling. The action based on the backchanneling includes a case in which the set backchanneling is executed as it is and a case in which backchanneling different from the set backchanneling, that is, other backchanneling, is executed.

(Step 1) The emotion determination unit 232 acquires the state of the user 10, the emotion value of the user 10, the emotion value of the avatar, and the history data 222.

Specifically, processing similar to steps S100 to S103 is performed to acquire the state of the user 10, the emotion value of the user 10, the emotion value of the avatar, and the history data 222. Note that “robot” in the flowcharts shown in FIGS. 4A and 4B shall be appropriately read as “avatar”.

(Step 2) The avatar generates a sentence for the next utterance of the conversation from the conversations with the user 10.

Specifically, the action determination unit 236 starts sentence generation by using the sentence generation model. The sentence generation is based on the content of the conversations exchanged between the user 10 and the avatar. At this time, the action determination unit 236 can generate a sentence suitable for the conversation place in consideration of the emotion of the user 10 and the history data 222.

(Step 3) The avatar sets backchanneling to be executed during the time until the avatar itself makes the next utterance.

Specifically, the action determination unit 236 sets backchanneling performed by the avatar at the same time as the start of the sentence generation by the sentence generation model or for the time after the start of the sentence generation until the utterance of the avatar. The backchanneling is set in association with the emotion value of the avatar in at least one previous conversation. For example, in a case in which the emotion value of the avatar in one previous conversation is “joyful”, emitting a voice associated with the emotion value of “joyful” is regarded as backchanneling in this case. The voice associated with the emotion value for “joyful” is, for example, “Kyaa”, “Wee”, “Yatta”, and “Yay”, and the like, and is not particularly limited. Furthermore, the backchanneling includes not only uttering a voice but also changing a posture, a gesture, and an expression of the avatar.

(Step 4) The action determination unit 236 determines an action of the avatar such that the avatar executes the backchanneling set in Step 3.

Specifically, the action determination unit 236 transmits an instruction to the action control unit 250 so that the avatar executes the set backchanneling. The action control unit 250 controls the control target 252 such that the avatar performs the backchanneling.

The backchanneling is performed during the period before the next utterance by the avatar. Since the user 10 can recognize the backchanneling of the avatar before receiving the next utterance from the avatar, the idle time before the next utterance will be reduced. In other words, with respect to the waiting time until the reception of the next utterance from the avatar, the chances of feeling “Is there no reaction from the avatar still?” are reduced, which makes the user feel the waiting time as a meaningful time as if the user is communicating with the avatar.

Furthermore, since the avatar gives backchanneling to the user 10, the user 10 does not have to feel anxiety that would arise in a case in which reactions from the avatar are temporarily stopped.

As described above, in the conversation with the user 10, the avatar executes the backchanneling during the time until the next utterance, so the tediousness for the waiting time for the user 10 until the next utterance from the avatar can be reduced.

The above is an example in which the avatar executes the backchanneling set in association with the emotion value of the avatar as it is. On the other hand, as in the following embodiment, it may be configured such that the avatar is caused to execute backchanneling set in association with the emotion value of the avatar and backchanneling different from the aforementioned backchanneling (referred to as “other backchanneling”).

As an example, the action determination unit 236 includes a word list. In this word list, phrases (words and phrases) that may change the emotion value of the avatar in a conversation between the user 10 and the avatar in the reverse direction or a different direction are listed. For instance, an example thereof is “strongly abusive phrase” in a case in which the avatar has an emotion value for “joyful” and the user 10 suddenly becomes angry and uses strong abusive phrase.

The action determination unit 236 can select backchannelling in association with the phrase listed on the word list. The backchanneling selected here is backchanneling different from the backchanneling set in association with the emotion value of the avatar, that is, “other backchanneling”. For example, even in a case in which the avatar is positive in a conversation between the user 10 and the avatar and in a case in which the user 10 suddenly uses “strongly abusive phrase” as described above, if the backchanneling is that set in association with the emotion value of the avatar, there is a possibility of performing utterances to indicate acceptance (“un-un”) or assent (“sou-sou”) Furthermore, even if the utterance is not such an utterance, the avatar may nod or smile. However, in a case in which the user 10 is angry with “strongly abusive phrase”, it is unnatural for the avatar to perform such backchanneling.

Therefore, the “other backchanneling” is, for example, neutral backchanneling. The neutral backchanneling is backchanneling indicating neither acceptance, assent, denial nor opposition with respect to “strongly abusive phrase” uttered by the user 10. In other words, the backchanneling is backchanneling that can cope with the emotion of the user 10 being “anger” or “joy”, and is backchanneling with no or less awkwardness. The avatar can give neutral backchanneling to the user 10 without requiring a long time while, in a sense, bracing itself with a questioning “Hmm?” Thereafter, it is possible to set and execute backchanneling appropriate for the “strongly abusive phrase” uttered by the user 10 again. In this case, the neutral backchanneling is backchanneling that can be commonly applied to multiple phrases in the word list, and is backchanneling with high versatility.

Furthermore, “other backchanneling” may be individually set for multiple phrases in the word list. In this case, backchanneling specialized for each of multiple phrases is obtained. As a result, more accurate backchanneling can be returned as “other backchanneling” according to the utterance content of the user 10.

For “other backchanneling”, the mood of the conversation between the user 10 and the avatar is output from the emotion engine that is the emotion determination unit 232 of the avatar, and base backchanneling is set. This backchanneling is “other backchanneling”. Then, the “other backchanneling” is generated in a short time from the “strongly abusive phrase” of the user 10 for execution, so the avatar becomes wary. Thereafter, while the sentence generation by the sentence generation model is performed, appropriate backchanneling is generated and executed.

The “mood of the conversation” is obtained by overlaying a moving average of the emotion label output by the sentence generation model on the state of the emotion engine, and is the mood of the conversation felt by the avatar. The emotion vector of the sentence generation model represents not the emotion of the avatar itself but the emotion of the utterance of the avatar. That is, in a case in which the avatar is in a comfortable environment, the mood is improved even in an ordinary conversation, but in a case in which the avatar is in an uncomfortable environment, the mood may be deteriorated even in an ordinary pleasant conversation. For this operation, an emotion engine is either necessary or an emotion engine is preferred. Note that it is preferable that the emotion of the avatar is necessary or the emotion of the avatar is present when the sentence generation model is caused to generate proper backchanneling. This is to link the language space of the sentence generation model with the body sensation of the avatar.

The emotion determination unit 232 may determine the emotion of the user according to specific mapping. Specifically, the emotion determination unit 232 may determine the user's emotion based on an emotion map (see FIG. 5) that is specific mapping.

In this case, in the fifth embodiment, the determination of the emotion of the user performed in relation to the robot 100 is performed in relation to the avatar as described below.
(1) For example, in a case in which the emotion engine, which is the emotion determination unit 232 of the avatar, detects emotions at about 100 msec, the determination of the reaction operation (for example, backchanneling) of the avatar may be set at a timing at which the frequency is at least similar to the detection frequency (100 msec) of the emotion engine, or may be set at a timing quicker than the detection frequency. The detection frequency of the emotion engine may be interpreted as a sampling rate.

The emotion is detected at about 100 msec, and the reaction operation (for example, backchanneling) is performed immediately in conjunction with the detection, whereby unnatural backchanneling is eliminated, and natural and context-aware interactions can be realized. The avatar performs a reaction operation (backchanneling or the like) according to the directionality and the degree (intensity) of the mandala of the emotion map 400. Note that the detection frequency (sampling rate) of the emotion engine is not limited to 100 ms, and may be changed according to the situation (such as when playing sports), the age of the user, or the like.
(2) In comparison with the emotion map 400, the directionality of the emotion and the intensity of the degree thereof may be preset, and the movement of the acknowledgement and the intensity of the acknowledgement may be set. For example, in a case in which the avatar feels a sense of stability, security, or the like, the avatar continues to listen to the speech while nodding. In a case in which the avatar is feeling anxious, confused, or suspicious, the avatar may tilt its head or stop shaking its head.

These emotions are distributed in the 3 o'clock direction of the emotion map 400, and usually come and go between relief and anxiety. In the right half of the emotion map 400, situation recognition is superior to internal sensation, and thus gives a calm impression.
(3) In a case in which the avatar is experiencing pleasure after receiving compliments, a filler “Ah” may come in front of the line, and in a case in which the avatar is experiencing pain after receiving harsh words, a filler “Ugh!” may come in front of the line. Furthermore, a physical reaction such as a gesture of the avatar crouching while saying “Ugh!” may be included. These emotions are distributed to around 9 o'clock direction in the emotion map 400.
(4) In the left half of the emotion map 400, internal sensation (reaction) is prioritized over situation recognition. Therefore, the impression of an unintentional reaction can be given.

In a case in which the avatar has a favorable feeling in situation recognition while having an internal sensation (reaction) of conviction, the avatar may nod deeply while looking at the partner, or may utter “uh-huh”. In this manner, the avatar may generate a balanced favorable feeling for the partner, that is, an action such as accepting or tolerance for the partner. These emotions are distributed to around 12 o'clock direction in the emotion map 400.

Conversely, even in the situation recognition while the avatar has the internal sensation (reaction) of discomfort, the avatar may shake its head sideways when feeling antipathy, and may turn the LED of the eyes red and look at the partner when feeling hatred. These emotions are distributed around 6 o'clock in the emotion map 400.
(5) Since the inside of the emotion map 400 represents the inside of the mind and the outside of the emotion map 400 represents an action, the emotion is more visible (appears in the action) toward the outside of the emotion map 400.
(6) In a case in which the avatar listens to a person's speech while remembering a sense of relief distributed around 3 o'clock direction on the emotion map 400, the avatar slightly shakes its head vertically and says “Hun Hun”. However, in the case of the direction of love around 12 o'clock, the avatar may perform strong nodding such as shaking its head deeply vertically.

The emotion determination unit 232 inputs the information analyzed by the sensor module unit 210 and the recognized state of the user 10 to a pre-trained neural network, acquires an emotion value indicating each emotion indicated on the emotion map 400, and determines the emotion of the user 10. This neural network is pre-trained based on multiple pieces of learning data that is a combination of the information analyzed by the sensor module unit 210, the recognized state of the user 10, and the emotion value indicating each emotion indicated on the emotion map 400. Furthermore, in this neural network, as on an emotion map 900 illustrated in FIG. 6, it is trained that emotions arranged close to each other have close values. FIG. 6 illustrates an example in which multiple emotions such as “relief”, “calm”, and “reassuring” have similar emotion values.

Furthermore, the emotion determination unit 232 may determine the emotion of the avatar according to the specific mapping. Specifically, the emotion determination unit 232 inputs the information analyzed by the sensor module unit 210, the state of the user 10 recognized by the user state recognition unit 230, and the state of the avatar to the pre-trained neural network, acquires an emotion value indicating each emotion indicated in the emotion map 400, and determines the emotion of the avatar. This neural network is pre-trained based on multiple pieces of training data that are a combination of the information analyzed by the sensor module unit 210, the recognized state of the user 10 and state of the avatar, and the emotion value indicating each emotion indicated on the emotion map 400. For example, the neural network is trained based on training data indicating that the emotion value “3” for “joyful” is obtained in a case in which the avatar is recognized as being stroked by the user 10 from the output of the touch sensor (not illustrated), and training data indicating that the emotion value “3” for “anger” is obtained in a case in which the avatar is recognized as being hit by the user 10 from the output of the acceleration sensor (not illustrated). Furthermore, in this neural network, as on an emotion map 900 illustrated in FIG. 6, it is trained that emotions arranged close to each other have close values.

The action determination unit 236 adds a fixed sentence for asking about the action content of the robot corresponding to an action of the user to the text representing the action of the user, the emotion of the user, and the emotion of the robot, and inputs the text to the sentence generation model having the interaction function, thereby generating the action content of the robot.

For example, the action determination unit 236 acquires a text indicating the state of the avatar from the emotion of the avatar determined by the emotion determination unit 232 using the emotion table as shown in Table 1. Here, in the emotion table, an index number is assigned to each emotion value for each type of emotion, and a text indicating the state of the avatar is stored for each index number.

In a case in which the emotion of the avatar determined by the emotion determination unit 232 corresponds to the index number “2”, a text “very pleasant state” is obtained. Note that, in a case in which the emotion of the avatar corresponds to multiple index numbers, multiple texts indicating the state of the avatar are obtained.

Furthermore, an emotion table as shown in Table 2 is prepared for emotions of the user 10. Here, in a case in which the action of the user is to speak “How are you feeling?”, the emotion of the avatar is the index number “2”, and the emotion of the user 10 is the index number “3”, the sentence generation model receives an input “The robot is in a very pleasant state. The user is normally in a pleasant state. The user asked “How are you feeling?” How do I have to reply as an avatar”, and the action content of the robot is acquired. The action determination unit 236 determines an action of the robot from the action content.

With regard to the above embodiments, the following supplementary notes are further disclosed.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that determines an action of the avatar corresponding to the user state, the emotion of the user, or the emotion of the avatar based on a sentence generation model which has an interaction function of allowing the user to interact with the avatar; and
an action control unit that displays the avatar in an image display area of the electronic equipment,
in which the action determination unit sets backchanneling associated with an emotion value of the avatar in a conversation up to at least one previous utterance for the time from the start of sentence generation by the sentence generation model to the utterance by the avatar, and causes the avatar to perform an action based on the backchanneling.

### (Supplementary Note 2)

The action control system described in supplementary note 1, in which the action determination unit controls display of the avatar by the electronic equipment such that the avatar executes the backchanneling as the action.

### (Supplementary Note 3)

The action control system described in supplementary note 1, in which, in a case in which it is determined to perform the backchanneling as an action of the avatar and in a case in which a phrase included in an utterance content of the user is not included in a word list, the action determination unit causes the avatar to perform the backchanneling as the action, and
in a case in which a phrase included in the utterance content of the user is included in the word list, the action determination unit sets other backchanneling different from the aforementioned backchanneling, and causes the avatar to perform the other backchanneling as the action.

### (Supplementary Note 4)

The action control system described in supplementary note 3, in which the other backchanneling is backchanneling corresponding to a case in which a pattern of the emotion value of the avatar is neutral.

### (Supplementary Note 5)

The action control system described in supplementary note 3, in which the other backchanneling is backchanneling preset corresponding to a phrase in the word list.

### (Supplementary Note 6)

The action control system described in supplementary note 1, in which the electronic equipment is a headset-type terminal.

### (Supplementary Note 7)

The action control system described in supplementary note 1, in which the electronic equipment is an eyeglass-type terminal.

### Thirteenth Embodiment

A thirteenth embodiment will be described with reference to FIG. 15 described above. In the embodiment, the control unit 228B has the functions of determining an action of the avatar and generating display of the avatar to be presented to the user through the headset-type terminal 820.

As in the first embodiment, the emotion determination unit 232 of the control unit 228B determines an emotion value of the agent based on the state of the headset-type terminal 820, and substitutes the emotion value as an emotion value of the avatar.

As in the first embodiment, when an agent functioning as an avatar performs an autonomous process of autonomously acting, the action determination unit 236 of the control unit 228B determines, as an action of the avatar, any of multiple types of avatar actions including not acting, using at least one of the state of the user 10, the emotion of the user 10, the emotion of the avatar, or the state of electronic equipment (for example, the headset-type terminal 820) that controls the avatar, and the action determination model 221, at a predetermined timing.

Specifically, the action determination unit 236 inputs data indicating at least one of a state of the user 10, a state of electronic equipment, an emotion of the user 10, or an emotion of an avatar, together with data for asking about an avatar action to the data generation model, and determines an action of the avatar based on an output of the data generation model.

In addition, the action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

In particular, in a case in which the action determination unit 236 determines to give a happiness point to the user 10 as an action of the avatar, it is preferable to cause the action control unit 250 to control the avatar to give a happiness point to the user 10.

Specifically, the robot 100 has a function of “happiness point”, and the action determination unit 236 executes processing of giving a happiness point in accordance with the user's preference, the user's situation, and the user's reaction when, for example, a sense of pleasure of a child who is the user 10 is detected according to the following steps 1 to 4. That is, the robot 100 can present happiness points to the child who is the user 10.
(Step 1) The robot 100 acquires the state of the user 10, the emotion value of the user 10, the emotion value of the robot 100, and the history data 222. Specifically, processing similar to steps S100 to S103 is performed to acquire the state of the user 10, the emotion value of the user 10, the emotion value of the robot 100, and the history data 222.
(Step 2) The user state recognition unit 230 detects the state of the user 10, and the emotion determination unit 232 detects whether or not the user 10 has a sense of pleasure from the emotion value of the user 10. Specifically, the user state recognition unit 230 recognizes the state of the user 10 based on the information analyzed by the sensor module unit 210, and the emotion determination unit 232 determines an emotion value indicating the emotion of the user 10 based on the information analyzed by the sensor module unit 210 and the state of the user 10 recognized by the user state recognition unit 230.
(Step 3) The action determination unit 236 determines to give a happiness point when it is detected that the user 10 has a sense of pleasure (a sense of pleasure of the user 10) based on the state of the user 10 recognized by the user state recognition unit 230 and the emotion value indicating the emotion of the user 10. Specifically, the action determination unit 236 controls the control target 252, issues a happiness point, adds the happiness point to the point balance of the user 10, and further determines to inform the user 10 of the fact that the happiness point has been added and the point balance, as an action of the avatar.

The action control unit 250 informs the user 10 of the fact that the happiness point has been added and the point balance according to the determined action of the avatar. At this time, by considering the emotion of the avatar, it is possible to make the user 10 feel that the avatar has an emotion.
(Step 4) In a case in which the point balance reaches a predetermined amount (for example, 1000 points), the action control unit 250 notifies the user 10 through the avatar of the fact that 1000 points can be converted into 1000 points of electronic money such as PayPay (registered trademark). At this time, the action determination unit 236 may operate the avatar to prompt conversion of the point balance into electronic money. For example, the point balance, the mark indicating electronic money, and an arrow from the point balance toward the mark may be displayed in a highlighted manner. According to a request from the user 10, the control unit 228B can convert the happiness points into points such as PayPay (registered trademark).

As a result, for example, electronic money corresponding to an amount of allowance can be returned to the child who is the user 10. The avatar is present to enable maximization of happiness of the child who is the user 10.

As described above, the robot 100 can execute processing of giving a happiness point when, for example, a sense of happiness of a child who is the user 10 is detected in accordance with the user's preference, the user's situation, and the user's reaction. Note that a sense of happiness can be detected once or multiple times a day. Note that the number of times of detection per predetermined period may be limited. In addition, a time limit may be set such that detection is not performed at night.

With regard to the above embodiments, the following supplementary notes are further disclosed.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with an action determination model at a predetermined timing to determine any of multiple types of avatar actions including not acting as an action of the avatar;
a memory control unit that stores event data including an emotion value determined by the emotion determination unit and data including the action of the user in history data; and
an action control unit that displays the avatar in an image display area of the electronic equipment,
in which the avatar actions include giving a happiness point to the user, and
the action determination unit determines to inform the user of the fact that the happiness point has been added and a point balance in a case in which giving a happiness point to the user is determined as an action of the avatar.

### (Supplementary Note 2)

The action control system described in supplementary note 1,
in which the action determination model is a data generation model capable of generating data according to input data, and
the action determination unit inputs data indicating at least one of the user state, the state of the electronic equipment, the emotion of the user, or the emotion of the avatar, together with data for asking about an avatar action to the data generation model, and determines an action of the avatar based on an output of the data generation model.

### (Supplementary Note 3)

The action control system described in supplementary note 1, in which, in a case in which the action determination unit determines, as an action of the avatar, to inform the user of the fact that the point balance can be converted into electronic money, the action determination unit operates the avatar to inform the user of the fact that the point balance can be converted into electronic money.

### (Supplementary Note 4)

The action control system described in supplementary note 3, in which the action determination unit operates the avatar to prompt conversion of the point balance into electronic money, as an action of the avatar.

### (Supplementary Note 5)

The action control system described in supplementary note 1, in which the electronic equipment is a headset-type terminal.

### (Supplementary Note 6)

The action control system described in supplementary note 1, in which the electronic equipment is an eyeglass-type terminal.

### Fourteenth Embodiment

A fourteenth embodiment will be described with reference to FIG. 15 described above. In the embodiment, the control unit 228B has the functions of determining an action of the avatar and generating display of the avatar to be presented to the user through the headset-type terminal 820.

As in the first embodiment, the emotion determination unit 232 of the control unit 228B determines an emotion value of the agent based on the state of the headset-type terminal 820, and substitutes the emotion value as an emotion value of the avatar.

As in the first embodiment, when an agent functioning as an avatar performs an autonomous process of autonomously acting, the action determination unit 236 of the control unit 228B determines, as an action of the avatar, any of multiple types of avatar actions including not acting, using at least one of the state of the user 10, the emotion of the user 10, the emotion of the avatar, or the state of electronic equipment (for example, the headset-type terminal 820) that controls the avatar, and the action determination model 221, at a predetermined timing.

Specifically, the action determination unit 236 inputs a text representing at least one of the state of the user 10, the state of the electronic equipment, the emotion of the user 10, or the emotion of the avatar, together with a text for inquiry about the action of the avatar to the sentence generation model, and determines the action of the avatar based on the output of the sentence generation model.

In addition, the action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

As described above, in a case in which the action of the user 10 is “asking”, the action of “answering” is determined as the action of the robot 100 (in the embodiment, the avatar). However, it may take some time to generate the content of the answer from the avatar (hereinafter, it is also referred to as an “answer content”) from the time point when a question is received from the user 10.

Therefore, in a case in which the action determination unit 236 according to the present embodiment determines to receive a question from the user 10, as an action of the avatar, the action determination unit may be configured to determine the action of the avatar so as to take an action for earning time to generate the answer content for the question during the time to the generation of the answer content. Here, examples of the action for earning time include an action of backchanneling to a question of the user 10 and an action of repeating the question of the user 10. Furthermore, examples of the content of the backchanneling include “That's right”, “Really?”, “I see” and the like. Here, “earn time” mentioned here means intentionally wasting time to achieve the objective (in this case, generating the answer content), and can be rephrased with expressions such as “create a grace period”, “seek a postponement”, “fill time”, or “extend”.

Here, the action determination unit 236 may provide a condition that a predicted time from when the question is received until when the answer content is generated is a predetermined time or longer as a condition for executing the determination of the action of the avatar so as to take an action of earning time. In this case, the predicted time may be configured to be derived according to the complexity of the content of the question, derived according to the type of the content of the question, or simply derived so as to be longer as the length of the phrase of the question is longer.

Furthermore, in a case in which it is determined to receive a question from the user 10 as an action of the avatar, the action determination unit 236 may operate the avatar so that at least one of the content of the utterance with respect to the user 10, the tone of voice when performing the utterance, the motion of the avatar, or the expression of the avatar changes, so as to gain time to generate the answer content.

Here, the tone of voice includes emotions, accents, and the like included in spoken words, in addition to the “wording”, which word to choose.

By taking such a form of taking the action of earning time, it is possible to suppress the occurrence of a situation where you can't fill the time (when you have time to spare or the conversation breaks off and an awkward pause arises), and as a result, it is possible to make the interaction function of interacting with the user 10 and the avatar more effective.

With regard to the above embodiments, the following supplementary notes are further disclosed.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and
an action control unit that displays the avatar in an image display area of the electronic equipment,
in which the avatar actions include receiving a question from the user, and
the action determination unit determines an action of the avatar so as to take an action for earning time to generate an answer content for the question during the time to the generation of the answer content in a case in which it is determined to receive a question from the user as an action of the avatar.

### (Supplementary Note 2)

The action control system described in supplementary note 1,
in which the action determination model is a data generation model capable of generating data according to input data, and
the action determination unit inputs data indicating at least one of the user state, the state of the electronic equipment, the emotion of the user, or the emotion of the avatar, together with data for asking about an avatar action to the data generation model, and determines an action of the avatar based on an output of the data generation model.

### (Supplementary Note 3)

The action control system described in supplementary note 1, in which, in a case in which it is determined to receive a question from the user as an action of the avatar, the action determination unit operates the avatar so that at least one of a content of an utterance with respect to the user, tone of voice when performing the utterance, a motion of the avatar, or an expression of the avatar changes, so as to earn time to generate the answer content.

### (Supplementary Note 4)

The action control system described in supplementary note 1, in which the electronic equipment is a headset-type terminal.

### (Supplementary Note 5)

The action control system described in supplementary note 1, in which the electronic equipment is an eyeglass-type terminal.

### Fifteenth Embodiment

A fifteenth embodiment will be described with reference to FIG. 15 described above. In the embodiment, the control unit 228B has the functions of determining an action of the avatar and generating display of the avatar to be presented to the user through the headset-type terminal 820.

As in the first embodiment, the emotion determination unit 232 of the control unit 228B determines an emotion value of the agent based on the state of the headset-type terminal 820, and substitutes the emotion value as an emotion value of the avatar.

As in the first embodiment, when an agent functioning as an avatar performs an autonomous process of autonomously acting, the action determination unit 236 of the control unit 228B determines, as an action of the avatar, any of multiple types of avatar actions including not acting, using at least one of the state of the user 10, the emotion of the user 10, the emotion of the avatar, or the state of electronic equipment (for example, the headset-type terminal 820) that controls the avatar, and the action determination model 221, at a predetermined timing.

Specifically, the action determination unit 236 inputs a text representing at least one of the state of the user 10, the state of the electronic equipment, the emotion of the user 10, or the emotion of the avatar, together with a text for inquiry about the action of the avatar to the sentence generation model, and determines the action of the avatar based on the output of the sentence generation model.

In addition, the action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

By the way, as described above, in a case in which the action of the user 10 is “asking”, an action of “answering” is determined as the action of the robot 100 (in the present embodiment, the avatar). However, it may take some time to generate the content of the answer from the avatar (hereinafter, it is also referred to as an “answer content”) from the time point when a question is received from the user 10. In addition, an error may occur due to a line connection failure or the like, and no answer content may be generated.

Therefore, in a case in which it is determined to receive a question from the user 10, as an action of the avatar, and in a case in which a question is received from the user 10 and no answer content to the question can be generated within a predetermined period of time, the action determination unit 236 according to the present embodiment may be configured to determine an action of the avatar to utter words of explanation. Here, as the words of explanation, words indicating that the avatar had an answer to the question but has forgotten answering may be applied. Examples of the words of explanation in the above mode include words such as “I forgot”. Note that the term “explanation” mentioned here means that there is an unavoidable reason for the failure or the like and means giving explanation for self-justification, and can be rephrased with expressions such as “defense”, “excuse”, “clarification”, or the like.

Here, the action determination unit 236 may apply a condition that a predicted time from when a question is received until when the answer content is generated exceeds a predetermined period of time, as a condition for uttering the words of explanation. In this case, the predicted time may be configured to be derived according to the complexity of the content of the question, derived according to the type of the content of the question, or simply derived so as to be longer as the length of the phrase of the question is longer.

Furthermore, in a case in which the answer content cannot be generated due to the occurrence of the above-described error, the action determination unit 236 may be configured to determine the action of the avatar so as to utter the words of explanation using the occurrence of the error as a trigger.

Furthermore, in a case in which it is determined to utter the words of explanation, as an action of the avatar, the action determination unit 236 may operate the avatar so that at least one of the content of the utterance for the user 10, the tone of voice when the utterance is made, the gesture of the avatar, or the expression of the avatar changes so as to reinforce the explanation.

Here, the tone of voice includes emotions, accents, and the like included in spoken words, in addition to the “wording”, which word to choose.

By taking such a form of taking the action of explanation, it is possible to suppress the occurrence of a situation where you can't fill the time (when you have time to spare or the conversation breaks off and an awkward pause arises), and as a result, it is possible to prevent the sense of discomfort from being given to the user 10.

With regard to the above embodiment, the following supplementary notes are further added.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that uses at least one of the user state, the state of the electronic equipment, the emotion of the user, or the emotion of the avatar, together with an action determination model at a predetermined timing to determine any of multiple types of avatar actions including not acting as an action of the avatar; and
an action control unit that displays the avatar in an image display area of the electronic equipment,
in which the avatar actions include receiving a question from the user, and
in a case in which it is determined to receive a question from the user, as an action of the avatar, and in a case in which a question is received from the user and no answer content to the question can be generated within a predetermined period of time, the action determination unit determines an action of the avatar to utter a word of explanation.

### (Supplementary Note 2)

The action control system described in supplementary note 1,
in which the action determination model is a data generation model capable of generating data according to input data, and
the action determination unit inputs data indicating at least one of the user state, the state of the electronic equipment, the emotion of the user, or the emotion of the avatar, together with data for asking about an avatar action to the data generation model, and determines an action of the avatar based on an output of the data generation model.

### (Supplementary Note 3)

The action control system described in supplementary note 1,
in which, in a case in which it is determined to utter the word of explanation, as an action of the avatar, the action determination unit operates the avatar so that at least one of a content of the utterance for the user, tone of voice when the utterance is made, a gesture of the avatar, or expression of the avatar changes so as to reinforce the explanation.

### (Supplementary Note 4)

The action control system described in supplementary note 1, in which the electronic equipment is a headset-type terminal.

### (Supplementary Note 5)

The action control system described in supplementary note 1, in which the electronic equipment is an eyeglass-type terminal.

### Sixteenth Embodiment

A sixteenth embodiment will be described with reference to FIG. 15 described above. In the embodiment, the control unit 228B has the functions of determining an action of the avatar and generating display of the avatar to be presented to the user through the headset-type terminal 820.

As in the first embodiment, the emotion determination unit 232 of the control unit 228B determines an emotion value of the agent based on the state of the headset-type terminal 820, and substitutes the emotion value as an emotion value of the avatar.

As in the first embodiment, when the agent functioning as the avatar performs a response process of responding to an action of the user 10, the action determination unit 236 of the control unit 228B determines an action of the avatar corresponding to the action of the user 10 based on at least one of a user state, a state of the headset-type terminal 820, an emotion of the user, or an emotion of the avatar. At this time, in a case in which a threshold value preset for the emotion of the user is exceeded, the action determination unit 236 determines an action of the avatar present for soothing the emotion of the user.

Specifically, in a case in which a threshold value of an emotion level allowed by the user him/herself is preset and the emotion level exceeds an allowable range (threshold value) (for example, in a case in which the user enters a state of losing self-control due to anger), the action determination unit 236 makes an utterance for soothing the emotion of the user as an action of the avatar preset by the user himself/herself. For example, in a case in which an emotion value for “anger” exceeds a threshold value, utterance for soothing the emotion “anger” of the user is made. Further, in a case in which an emotion value for “sorrow” exceeds a threshold value, utterance for soothing the emotion “sorrow” of the user is made.

Furthermore, since determination as to whether an emotion level exceeds the allowable range differs depending on whether the user's self-recognition is of a type in which the emotion expression is rich or a type in which the user is calm, the action determination unit 236 may correct the emotion level threshold value from the standard value, or may cause the user to set the emotion level threshold value in advance. As a result, it is possible to support control over emotions of the user.

As in the first embodiment, when an agent functioning as an avatar performs an autonomous process of autonomously acting, the action determination unit 236 of the control unit 228B determines, as an action of the avatar, any of multiple types of avatar actions including not acting, using at least one of the state of the user 10, the emotion of the user 10, the emotion of the avatar, or the state of electronic equipment (for example, the headset-type terminal 820) that controls the avatar, and the action determination model 221, at a predetermined timing.

Specifically, the action determination unit 236 inputs a text representing at least one of the state of the user 10, the state of the electronic equipment, the emotion of the user 10, or the emotion of the avatar, together with a text for inquiry about the action of the avatar to the sentence generation model, and determines the action of the avatar based on the output of the sentence generation model.

In addition, the action control unit 250 displays the avatar in the image display area of the headset-type terminal 820 as the control target 252C according to the determined action of the avatar. Furthermore, in a case in which the determined action of the avatar includes the utterance content of the avatar, the utterance content of the avatar is output from the speaker as the control target 252C by voice.

In particular, in a case in which the action control unit 250 determines an action of the avatar preset for soothing an emotion of the user, as an action of the avatar, it is preferable for the avatar to make an utterance in a voice that matches the emotion of the user. For example, in a case in which the emotion of the user is “anger”, the avatar is caused to make an utterance by switching the voice of the avatar to a voice that makes the user feel calm. In a case in which the emotion of the user is “sorrow”, the avatar is caused to make an utterance by switching the voice of the avatar to a voice that encourages the user.

In particular, in a case in which the action control unit 250 determines an action of the avatar preset for soothing an emotion of the user, as an action of the avatar, it is preferable to operate the avatar with an appearance that matches the emotion of the user. For example, in a case in which the emotion of the user is “anger”, the avatar is operated by switching the outfit of the avatar to a doctor-like outfit. In a case in which the emotion of the user is “sorrow”, the avatar is operated by switching the outfit of the avatar to a cheer-leader outfit.

With regard to the above embodiments, the following supplementary notes are further disclosed.

### (Supplementary Note 1)

An action control system including:
a state recognition unit that recognizes a user state including an action of a user and a state of electronic equipment;
an emotion determination unit that determines an emotion of the user or an emotion of an avatar representing an agent for interacting with the user;
an action determination unit that determines an action of the avatar based on at least one of the user state, the state of the electronic equipment, the emotion of the user, or the emotion of the avatar; and
an action control unit that displays the avatar in an image display area of the electronic equipment,
in which the action determination unit determines an action of the avatar preset for soothing the emotion of the user in a case in which a threshold value preset for the emotion of the user is exceeded.

### (Supplementary Note 2)

The action control system described in supplementary note 1,
in which the action determination unit inputs data indicating at least one of the user state, the state of the electronic equipment, the emotion of the user, or the emotion of the avatar, together with data for asking about an avatar action to a data generation model capable of generating data according to input data, and determines an action of the avatar based on an output of the data generation model.

### (Supplementary Note 3)

The action control system described in supplementary note 1, in which, in a case in which an action of the avatar preset for soothing an emotion of the user is determined as an action of the avatar, the action control unit causes the avatar to make an utterance in a voice that matches the emotion of the user.

### (Supplementary Note 4)

The action control system described in supplementary note 1, in which, in a case in which an action of the avatar preset for soothing an emotion of the user is determined as an action of the avatar, the action control unit operates the avatar with an appearance that matches the emotion of the user.

### (Supplementary Note 5)

The action control system described in supplementary note 1, in which the electronic equipment is a headset-type terminal.

### (Supplementary Note 6)

The action control system described in supplementary note 1, in which the electronic equipment is an eyeglass-type terminal.

1. A head-mounted display apparatus comprising:
an infrared emitter configured to project a structured light pattern;
an infrared image sensor configured to capture reflections of the structured light pattern and generate depth map data representing distances to surfaces in a field of view;
a visible-light image sensor configured to capture RGB image frames;
a temperature sensor configured to measure a skin temperature of a wearer;
an inertial measurement unit including an accelerometer and a gyroscope configured to detect head motion of the wearer;
a microdisplay configured to project image light onto an optical waveguide, the optical waveguide configured to direct the image light toward an eye of the wearer; and
processing circuitry configured to:
extract, from the RGB image frames, facial landmark coordinates representing positions of facial features of a person in the field of view,
compute, based on the facial landmark coordinates, a facial expression classification,
compute, based on the depth map data, a distance value between the wearer and the person,
generate, based on the facial expression classification, the distance value, and the skin temperature, a rendered image frame including a graphical character representation, and
drive the microdisplay to display the rendered image frame.

2. The head-mounted display apparatus of claim 1, wherein the processing circuitry is further configured to:
receive, via a microphone, audio signals including utterances of the person; and
extract voice emotion features from the audio signals, wherein the facial expression classification is further based on the voice emotion features.

3. The head-mounted display apparatus of claim 1, wherein the infrared emitter comprises a vertical-cavity surface-emitting laser (VCSEL) array.

4. The head-mounted display apparatus of claim 1, wherein the optical waveguide comprises a diffractive optical element configured to redirect the image light via total internal reflection.

5. The head-mounted display apparatus of claim 1, wherein the processing circuitry is further configured to:
compute an emotion value based on the facial expression classification and the skin temperature;
determine, based on the emotion value, a surface temperature display mode for the graphical character representation; and
render the graphical character representation with a visual indicator corresponding to the surface temperature display mode.

6. The head-mounted display apparatus of claim 5, wherein the visual indicator comprises at least one of a color gradient or an animated heat effect applied to a portion of the graphical character representation.

7. The head-mounted display apparatus of claim 5, wherein the processing circuitry is further configured to adjust a motion speed of the graphical character representation based on the surface temperature display mode.

8. The head-mounted display apparatus of claim 1, wherein the processing circuitry is further configured to:
detect, from the RGB image frames, a motion of the person; and
generate, in response to detecting the motion, an utterance content for the graphical character representation to inquire about a meaning of the detected motion.

9. The head-mounted display apparatus of claim 1, wherein the processing circuitry is further configured to:
capture, via the visible-light image sensor, a surrounding image representing an environment around the wearer;
determine, based on the surrounding image, location information indicating a place where the wearer is located; and
generate an utterance topic for the graphical character representation related to the determined location.

10. The head-mounted display apparatus of claim 9, wherein the processing circuitry is further configured to:
retrieve historical event data associated with the determined location; and
generate, for the graphical character representation, a narration about the historical event.

11. The head-mounted display apparatus of claim 1, wherein the processing circuitry is further configured to:
compute an emotion value based on at least one of the facial expression classification or the skin temperature; and
in response to the emotion value exceeding a predetermined threshold, generate an avatar action comprising a soothing response.

12. The head-mounted display apparatus of claim 1, wherein the processing circuitry is further configured to:
detect a heart rate of the wearer via a heart rate sensor integrated in the head-mounted display apparatus; and
compute the facial expression classification further based on the detected heart rate.

13. The head-mounted display apparatus of claim 1, wherein the processing circuitry is further configured to:
detect, based on the inertial measurement unit, that the wearer is engaged in physical activity; and
adjust the facial expression classification to indicate a positive emotion value.

14. The head-mounted display apparatus of claim 1, wherein the graphical character representation comprises a three-dimensional avatar selectable by the wearer from a plurality of avatar styles.

15. The head-mounted display apparatus of claim 14, wherein the processing circuitry is further configured to generate the three-dimensional avatar using an image generative model trained on multiple art styles.

16. The head-mounted display apparatus of claim 1, wherein the processing circuitry is further configured to:
store event data including the emotion value associated with the skin temperature and at least one of the RGB image frames; and
retrieve the event data to determine preferences of the wearer.

17. The head-mounted display apparatus of claim 1, wherein the processing circuitry is further configured to transform the graphical character representation into an animal or object avatar embodying a determined action content.

18. A head-mounted display apparatus comprising:
a three-dimensional depth sensor including:
a vertical-cavity surface-emitting laser array configured to emit a structured infrared light pattern, and
an infrared camera configured to capture reflections of the structured infrared light pattern to generate three-dimensional depth data;
a visible-light camera configured to capture RGB image frames of an environment;
a temperature sensor configured to measure a skin temperature of a wearer;
a heart rate sensor configured to detect a heart rate of the wearer;
an inertial measurement unit including an accelerometer and a gyroscope;
a microphone configured to capture audio signals;
a waveguide display including a microdisplay and a diffractive optical waveguide configured to project images toward an eye of the wearer;
a speaker configured to output audio; and
processing circuitry configured to:
extract facial landmark coordinates from the RGB image frames representing facial features of a person,
compute a facial expression classification based on the facial landmark coordinates,
extract voice emotion features from the audio signals,
compute an emotion value based on the facial expression classification, the voice emotion features, the skin temperature, and the heart rate,
compute, based on the three-dimensional depth data, a distance between the wearer and the person,
generate, based on the emotion value and the distance, a rendered frame including a three-dimensional avatar representation,
determine, based on the emotion value, a surface temperature display mode and render the avatar with a corresponding visual indicator, and
drive the waveguide display to display the rendered frame.

19. The head-mounted display apparatus of claim 18, wherein the processing circuitry is further configured to:
capture, via the visible-light camera, a surrounding image representing an environment around the wearer;
determine, based on the surrounding image, a location where the wearer is present;
generate an utterance topic for the three-dimensional avatar related to the determined location; and
output, via the speaker, audio corresponding to the utterance topic.

20. A method performed by a head-mounted display apparatus, the method comprising:
projecting, by an infrared emitter, a structured light pattern;
capturing, by an infrared image sensor, reflections of the structured light pattern to generate depth map data representing distances to surfaces in a field of view;
capturing, by a visible-light image sensor, RGB image frames;
measuring, by a temperature sensor, a skin temperature of a wearer;
detecting, by an inertial measurement unit, head motion of the wearer;
extracting, by processing circuitry, facial landmark coordinates from the RGB image frames representing positions of facial features of a person in the field of view;
computing, by the processing circuitry, a facial expression classification based on the facial landmark coordinates;
computing, by the processing circuitry and based on the depth map data, a distance value between the wearer and the person;
generating, by the processing circuitry, a rendered image frame including a graphical character representation based on the facial expression classification, the distance value, and the skin temperature; and
displaying, via a microdisplay projecting image light onto an optical waveguide, the rendered image frame toward an eye of the wearer.
